(19) United States
(12) Patent Application Publication
(10) Pub. No.: US 2024/0303522 A1
(43) Pub. Date: Sep. 12, 2024

(54) GENERATION AND MEASUREMENT OF ENTANGLED SYSTEMS OF PHOTONIC GKP QUBITS

(71) Applicant: Psiquantum, Corp., Palo Alto, CA (US)

(72) Inventors: Andrew Doherty, Palo Alto, CA (US); Mercedes Gimeno-Segovia, San Jose, CA (US); Daniel Litinski, Palo Alto, CA (US); Naomi Nickerson, San Francisco, CA (US); Mihir Pant, Mountain View, CA (US); Terence Rudolph, San Francisco, CA (US); Christopher Sparrow, Palo Alto, CA (US)

(73) Assignee: Psiquantum, Corp., Palo Alto, CA (US)

(21) Appl. No.: 18/273,753

(22) PCT Filed: Jan. 25, 2022
(86) PCT No.: PCT/US2022/013753

§ 371 Date: Jul. 21, 2023

Related U.S. Application Data
(60) Provisional application No. 63/141,449, filed on Jan. 25, 2021.

(51) Int. Cl. G06N 10/40; G06N 10/20; G06N 10/70

(52) U.S. Cl. CPC G06N 10/40; G06N 10/20; G06N 10/70

(57) ABSTRACT

Circuits are provided that create entanglement among qubits having Gottesman-Kitaev-Preskill (GKP) encoding using photonic systems and structures. For example, networks of beam splitters and homodyne measurement circuits can be used to perform projective entangling measurements on GKP qubits from different quantum systems. In some embodiments. GKP qubits can be used to implement quantum computations using fusion-based quantum computing or other fault-tolerant quantum computing approaches.

### CROSS-REFERENCES TO RELATED APPLICATIONS

This application claims the benefit of U.S. Provisional Application No. 63/141,449, filed Jan. 25, 2021, the disclosure of which is incorporated by reference herein.

### BACKGROUND

Quantum computing is distinguished from “classical” computing by its reliance on structures referred to as “qubits.” At the most general level, a qubit is a quantum system that can exist in one of two orthogonal states (denoted as |0 [symbol] and |1 [symbol] in the conventional bra/ket notation) or in a superposition of the two states (e.g.,

$$\frac{1}{\sqrt{2}} ( \vert 0 〉 + \vert 1 〉 ) .$$

By operating on a system (or ensemble) of qubits, a quantum computer can quickly perform certain categories of computations that would require impractical amounts of time in a classical computer.

Practical realization of a quantum computer, however, remains a daunting task. One challenge is the reliable creation and entangling of qubits.

### SUMMARY

Certain embodiments disclosed herein relate to circuits and techniques that can be used to create entanglement among qubits having Gottesman-Kitaev-Preskill (GKP) encoding (referred to herein as “GKP qubits”). GKP qubits can be created and manipulated using photonic circuits. In some embodiments, photonic circuits comprising networks of beam splitters and homodyne measurement circuits can be used to perform projective entangling measurements on GKP qubits from different quantum systems, which can enable the creation of entangled quantum systems having an arbitrary number of qubits. In some embodiments, GKP qubits can be used to implement quantum computations using fusion-based quantum computing or other fault-tolerant quantum computing approaches.

Some embodiments relate to a qubit-measurement circuit that can include: a number (n≥3) of input paths (which can be, e.g., optical waveguides) to receive a plurality of GKP qubits; two or more homodyne measurement circuits, each homodyne measurement circuit outputting a respective measurement value; a network of beam splitters, the network including at least one intermediate beam splitter and one final beam splitter, each beam splitter in the network having two inputs and two outputs; and an output signal path to output the respective homodyne measurement values output by the homodyne measurement circuits. One output of each of intermediate beam splitter in the network can be coupled to a different one of the homodyne measurement circuits, and the other output of each intermediate beam splitter in the network can be coupled to another beam splitter in the network. Each of the two outputs of the final beam splitter is coupled to a different one of the homodyne measurement circuits. In some embodiments, the homodyne measurement values represent outcomes of one or more entangling projective measurements on the plurality of GKP qubits. Such entangling projective measurements can be, for example, n-GHZ measurements.

In some embodiments, phase shift circuits can be coupled to some or all of the input paths. The phase shift circuits can include at least one variable phase shift circuit configured to receive a control signal and apply a particular phase shift responsive to the control signal. In some embodiments, respective phase shifts applied by the one or more phase shift circuits can be selected such that the homodyne measurement values represent n-GHZ measurements in different bases.

In some embodiments, each of the GKP qubits received on the input paths can be in a respective one of a plurality of quantum systems, each quantum system including two or more entangled qubits, and operation of the circuit can result in the plurality of quantum systems becoming mutually entangled.

In various embodiments, the number n of input paths can be chosen as desired. For instance, the number n of input paths can be 2^{m} for an integer m≥2. In such embodiments, the intermediate beam splitters can include a first group of n/2 beam splitters with inputs coupled to the input paths and a second group of n/4 beam splitters with inputs coupled to different beam splitters of the first group. Each beam splitter in the network of beam splitters can be a 50/50 beam splitter.

In other embodiments, the number n of input paths can be 3. In such embodiments, the network of beam splitters can include one intermediate beam splitter and one final beam splitter. Two of the three input paths can be coupled to the inputs of the intermediate beam splitter, and the third of the three input paths can be coupled to one of the inputs of the final beam splitter. The intermediate beam splitter can be a 50/50 beam splitter, and the final beam splitter can be a ⅓ beam splitter.

Some embodiments relate to a qubit measurement circuit that can include: a first input path (e.g., an optical waveguide) to receive a first GKP qubit; a second input path (e.g., an optical waveguide) to receive a second GKP qubit; a beam splitter having a first input coupled to the first input path, a second input coupled to the second input path, a first output, and a second output; a first homodyne measurement circuit coupled to the first output of the beam splitter, the first homodyne measurement circuit outputting a first measurement value; and a second homodyne measurement circuit coupled to the second output of the beam splitter, the second homodyne measurement circuit outputting a second measurement value. In some embodiments, the first measurement value and the second measurement value represent outcomes of one or more entangling projective measurements on the first GKP qubit and the second GKP qubit. Such entangling projective measurements can be, for example, Bell measurements.

In some embodiments, phase shift circuits can be coupled to one or both of the first and second input paths. At least one of the phase shift circuits can be a variable phase shift circuit configured to receive a control signal and apply a particular phase shift responsive to the control signal. In some embodiments, the phase shift(s) applied by the phase shift circuit(s) can be selected such that the first measurement value and the second measurement value represent a joint XX measurement and a joint ZZ measurement on the first and second GKP qubits.

In some embodiments, the first GKP qubit can be in a first quantum system that includes two or more entangled qubits and the second GKP qubit can be in a second quantum system that includes wo or more entangled qubits. In such embodiments, operation of the circuit results can result in the first and second quantum systems becoming mutually entangled.

Some embodiments relate to a method that can include receiving, at a plurality of fusion sites, a first plurality of quantum systems, wherein each quantum system of the first plurality of quantum systems includes a plurality of GKP qubits in an entangled state, and wherein respective quantum systems of the first plurality of quantum systems are independent quantum systems that are not entangled with one another. For each of the plurality of fusion sites, a homodyne measurement operation can be selected to be performed by a reconfigurable fusion circuit on respective GKP qubits from two or more of the quantum systems of the first plurality of quantum systems, thereby generating measurement outcome data. For instance, the homodyne measurement operation for each reconfigurable fusion circuit can be selected from a group of homodyne measurement operations that includes: (1) a first measurement operation in which a single-qubit homodyne measurement is performed on each of the GKP qubits and the measurement outcome data includes a result of each single-qubit homodyne measurement; and (2) a second measurement operation in which a multi-qubit homodyne projective entangling measurement is performed jointly on the respective GKP qubits and the measurement outcome data includes a result of the multi-qubit homodyne projective entangling measurement. A reconfigurable fusion circuit can be operated for each fusion site to perform the selected homodyne measurement operation and produce measurement outcome data. In some embodiments, a plurality of syndrome values can be determined based on the measurement outcome data.

Some or all of the multi-qubit homodyne projective entangling measurements can be fusion operations, which can entail a destructive joint measurement on the qubits received at a particular fusion site. For instance, the second measurement operation can be a Bell fusion between two GKP qubits or an n-GHZ fusion measurement performed on a number (n) of GKP qubits, where n is greater than or equal to 4 (such as a 4-GHZ fusion measurement performed on four GKP qubits, an 8-GHZ fusion measurement performed on eight GKP qubits, or the like).

In some embodiments, an optical fiber can be used to store one or more GKP qubits from the first plurality of quantum systems, wherein the stored GKP qubits are GKP qubits other than the GKP qubits that were subject to the homodyne measurement operations. At a later time, the plurality of fusion sites can receive a second plurality of quantum systems, wherein each quantum system of the second plurality of quantum system includes a second plurality of GKP qubits in an entangled state, and wherein respective quantum systems of the second plurality of quantum systems are independent quantum systems that are not entangled with one another or with any of the first plurality of quantum systems. For each of the plurality of fusion sites, one of the homodyne measurement operations can be selected to be performed by the reconfigurable fusion circuit at that fusion site on a set of GKP qubits that includes at least one of the stored GKP qubits and at least one GKP qubit from at least one of the quantum systems of the second plurality of quantum systems.

Some embodiments relate to a system that can include: a plurality of fusion sites configured to receive a plurality of quantum systems, wherein each quantum system of the plurality of quantum system includes a plurality of GKP qubits in an entangled state, and wherein respective quantum systems of the plurality of quantum systems are independent quantum systems that are not entangled with one another. Each fusion site can include a reconfigurable fusion circuit (which can be, e.g., a photonic circuit) configured to selectably perform one of a plurality of homodyne measurement operations on respective GKP qubits from two or more of the quantum systems, thereby generating measurement outcome data. The plurality of homodyne measurement operations can include: (1) a first measurement operation in which a single-qubit homodyne measurement is performed on each of the GKP qubits and the measurement outcome data includes a result of each single-qubit homodyne measurement; and (2) a second measurement operation in which a multi-qubit homodyne projective entangling measurement is performed jointly on the respective GKP qubits and the measurement outcome data includes a result of the homodyne projective entangling measurement. The system can also include a fusion controller circuit coupled to the plurality of fusion sites and configured to select, for each of the fusion sites, a particular homodyne measurement operation to perform. In some embodiments, the system can also include a decoder communicatively coupled to the plurality of fusion sites and configured to receive the measurement outcome data and to determine a plurality of syndrome values based on the measurement outcome data. In some embodiments, the system can also include a qubit entangling system that is configured to generate the plurality of quantum systems. The qubit entangling system can include a photon source system that produces photonic GKP qubits and a resource state generator that is configured to receive photonic GKP qubits from the photon source system and convert the photonic GKP qubits to an entangled photonic state.

The qubit entangling system can include a plurality of output waveguides that are optically coupled to the plurality of fusion sites and configured to provide the entangled photonic state to inputs of the reconfigurable fusion circuit.

Some or all of the multi-qubit homodyne projective entangling measurements can be fusion operations, which can entail a destructive joint measurement on the qubits received at a particular fusion site. For instance, some or all of the homodyne projective entangling measurements can include a two-particle projective measurement onto a Bell basis or a multi-particle projective measurement that projects onto a GHZ basis. Thus, the second measurement operation can be, for example, a Bell fusion between two GKP qubits, or an n-GHZ fusion measurement performed on a number (n) of GKP qubits, where n is greater than or equal to 4 (such as a 4-GHZ fusion measurement performed on four GKP qubits, an 8-GHZ fusion measurement performed on eight GKP qubits, or the like).

The following detailed description, together with the accompanying drawings, will provide a better understanding of the nature and advantages of the claimed invention.

### BRIEF DESCRIPTION OF THE DRAWINGS

FIG. 1 shows two representations of a portion of a pair of waveguides corresponding to a dual-rail-encoded photonic qubit.

FIG. 2A shows a schematic diagram for coupling of two modes.

FIG. 2B shows, in schematic form, a physical implementation of mode coupling in a photonic system that can be used in some embodiments.

FIGS. 3A and 3B show, in schematic form, examples of physical implementations of a Mach-Zehnder Interferometer (MZI) configuration that can be used in some embodiments.

FIG. 4A shows another schematic diagram for coupling of two modes.

FIG. 4B shows, in schematic form, a physical implementation of the mode coupling of FIG. 4A in a photonic system that can be used in some embodiments.

FIG. 5 shows a four-mode coupling scheme that implements a “spreader,” or “mode-information erasure,” transformation on four modes in accordance with some embodiments.

FIG. 6 illustrates an example optical device that can implement the four-mode mode-spreading transform shown schematically in FIG. 5 in accordance with some embodiments.

FIG. 7 shows a circuit diagram for a dual-rail-encoded Bell state generator that can be used in some embodiments.

FIG. 8A shows a circuit diagram for a dual-rail-encoded type I fusion gate that can be used in some embodiments.

FIG. 8B shows example results of type I fusion operations using the gate of FIG. 8A.

FIG. 9A shows a circuit diagram for a dual-rail-encoded type II fusion gate that can be used in some embodiments.

FIG. 9B shows an example result of a type II fusion operation using the gate of FIG. 9A.

FIG. 10 shows a graph representation of a resource state that can be used in some embodiments.

FIG. 11A shows an example of a fusion graph that can be used in some embodiments.

FIGS. 11B-11D show examples of how fusion graphs (shown in FIG. 11D) can be generated from surface-code spacetime diagrams (shown in FIGS. 11B and 11C) for various logical operations on logical qubits. FIG. 11E shows a legend for the fusion-graph notation used in FIG. 11D.

FIG. 12A shows a perspective view of a fusion graph. FIGS. 12B and 12C show representative layers of the fusion graph of FIG. 12A.

FIG. 13 shows a quantum computing system in accordance with some embodiments.

FIG. 14A-14D show block diagrams of various elements of a quantum computing system in accordance with some embodiments.

FIG. 15 shows a simplified schematic diagram of an optical circuit for generating a Gottesman-Kitaev-Preskill (GKP) qubit that can be used in some embodiments.

FIG. 16 shows a simplified schematic diagram of an optical circuit for homodyne measurement of a GKP qubit that can be used in some embodiments.

FIG. 17 shows a simplified schematic diagram of an optical circuit for entangling two GKP qubits that can be used in some embodiments.

FIG. 18 shows a simplified schematic diagram of an optical circuit that can produce a 3-qubit entangled state of GKP qubits according to some embodiments.

FIG. 19 shows a simplified schematic diagram of an optical circuit for performing Bell measurements on GKP qubits according to some embodiments.

FIG. 20 shows a simplified schematic diagram of an optical circuit that can perform a 4-qubit GHZ fusion measurement according to some embodiments.

FIG. 21 shows a simplified schematic diagram of an optical circuit that can perform an 8-qubit GHZ fusion measurement according to some embodiments.

FIG. 22 shows a simplified schematic diagram of a circuit for performing GHZ fusion measurements on three GKP qubits according to some embodiments.

FIGS. 23A-23D illustrate a 6-ring fusion network that can be implemented using GKP qubits according to some embodiments.

FIG. 24 shows a simplified schematic diagram of a reconfigurable fusion circuit for GKP qubits according to some embodiments.

FIG. 25 shows an example of a syndrome graph that can be generated for the 6-ring fusion network of FIGS. 23A-23D.

FIGS. 26A-26D illustrate an inverted 4-star fusion network that can be implemented using GKP qubits according to some embodiments.

FIG. 27 shows a simplified schematic diagram of a reconfigurable fusion circuit for GKP qubits according to some embodiments.

FIG. 28 is a simplified block diagram illustrating an architecture for a quantum computing system using photonic GKP qubits according to some embodiments.

FIG. 29 shows a flow diagram of a process for performing a quantum computation according to some embodiments.

### DETAILED DESCRIPTION

Disclosed herein are examples (also referred to as “embodiments”) of systems and methods for performing operations on ensembles of qubits based on various physical quantum systems, including photonic systems in which qubits are implemented using Gottesman-Kitaev-Preskill (GKP) encoding. Such embodiments can be used, for example, in quantum computing as well as in other contexts (e.g., quantum communication) that exploit quantum entanglement. To facilitate understanding of the disclosure, an overview of relevant concepts and terminology is provided in Section 1, and an overview of fusion based quantum computing (FBQC) is provided in Section 2. With this context established, Section 3 describes examples of implementations of FBQC using GKP-encoded photonic qubits (also referred to as “GKP qubits”). Section 4 describes an example embodiment of a computing system that can implement FBQC using GKP qubits. Although embodiments are described with specific detail to facilitate understanding, those skilled in the art with access to this disclosure will appreciate that the claimed invention can be practiced without these details.

Further, embodiments are described herein as creating and operating on systems of qubits, where the quantum state space of a qubit can be modeled as a 2-dimensional vector space. Those skilled in the art with access to this disclosure will understand that techniques described herein can be applied to systems of “qudits,” where a qudit can be any quantum system having a quantum state space that can be modeled as a (complex) n-dimensional vector space (for any integer n), which can be used to encode n bits of information. For the sake of clarity of description, the term “qubit” is used herein, although in some embodiments the system can also employ quantum information carriers that encode information in a manner that is not necessarily associated with a binary bit, such as a qudit.

### 1. Overview of Quantum Computing

Quantum computing relies on the dynamics of quantum objects, e.g., photons, electrons, atoms, ions, molecules, nanostructures, and the like, which follow the rules of quantum theory. In quantum theory, the quantum state of a quantum object is described by a set of physical properties, the complete set of which is referred to as a mode. In some embodiments, a mode is defined by specifying the value (or distribution of values) of one or more properties of the quantum object. For example, in the case where the quantum object is a photon, modes can be defined by the frequency of the photon, the position in space of the photon (e.g., which waveguide or superposition of waveguides the photon is propagating within), the associated direction of propagation (e.g., the k-vector for a photon in free space), the polarization state of the photon (e.g., the direction (horizontal or vertical) of the photon's electric and/or magnetic fields), a time window in which the photon is propagating, the orbital angular momentum state of the photon, and the like.

For the case of photons propagating in a waveguide, it is convenient to express the state of the photon as one of a set of discrete spatio-temporal modes. For example, the spatial mode kᵢ of the photon is determined according to which one of a finite set of discrete waveguides the photon is propagating in, and the temporal mode tⱼ is determined by which one of a set of discrete time periods (referred to herein as “bins”) the photon is present in. In some photonic implementations, the degree of temporal discretization can be provided by a pulsed laser which is responsible for generating the photons. In this overview, spatial modes will be used primarily to avoid complication of the description. However, one of ordinary skill will appreciate that the systems and methods can apply to any type of mode, e.g., temporal modes, polarization modes, and any other mode or set of modes that serves to specify the quantum state. Further, in this overview, embodiments will be described that employ photonic waveguides to define the spatial modes of the photon. However, persons of ordinary skill in the art with access to this disclosure will appreciate that other types of mode, e.g., temporal modes, energy states, and the like, can be used without departing from the scope of the present disclosure. Examples in sections 3 and 4 below use qubits implemented using GKP encoding. In addition, persons of ordinary skill in the art will be able to implement examples using other types of quantum systems, including but not limited to other types of photonic systems.

For quantum systems of multiple indistinguishable particles, rather than describing the quantum state of each particle in the system, it is useful to describe the quantum state of the entire many-body system using the formalism of Fock states (sometimes referred to as the occupation number representation). In the Fock state description, the many-body quantum state is specified by how many particles there are in each mode of the system. For example, a multi-mode, two particle Fock state |1001 [symbol] _{1,2,3,4} specifies a two-particle quantum state with one particle in mode 1, zero particles in mode 2, zero particles in mode 3, and one particle in mode 4. Again, as introduced above, a mode can be any property of the quantum object. For the case of a photon, any two modes of the electromagnetic field can be used, e.g., one may design the system to use modes that are related to a degree of freedom that can be manipulated passively with linear optics. For example, polarization, spatial degree of freedom, or angular momentum could be used. The four-mode system represented by the two particle Fock state |1001 [symbol] _{1,2,3,4} can be physically implemented as four distinct waveguides with two of the four waveguides having one photon travelling within them. Other examples of a state of such a many-body quantum system include the four-particle Fock state |1111 [symbol] _{1,2,3,4} that represents each mode occupied by one particle and the four-particle Fock state |2200 [symbol] _{1,2,3,4} that represents modes 1 and 2 respectively occupied by two particles and modes 3 and 4 occupied by zero particles. For modes having zero particles present, the term “vacuum mode” is used. For example, for the four-particle Fock state |2200 [symbol] _{1,2,3,4} modes 3 and 4 are referred to herein as “vacuum modes.” Fock states having a single occupied mode can be represented in shorthand using a subscript to identify the occupied mode. For example, |0010 [symbol] _{1,2,3,4} is equivalent to |1₃ [symbol] .

### 1.1.Qubits

As used herein, a “qubit” (or quantum bit) is a quantum system with an associated quantum state that can be used to encode information. A quantum state can be used to encode one bit of information if the quantum state space can be modeled as a (complex) two-dimensional vector space, with one dimension in the vector space being mapped to logical value 0 and the other to logical value 1. In contrast to classical bits, a qubit can have a state that is a superposition of logical values 0 and 1. More generally, a “qudit” can be any quantum system having a quantum state space that can be modeled as a (complex) n-dimensional vector space (for any integer n), which can be used to encode n bits of information. For the sake of clarity of description, the term “qubit” is used herein, although in some embodiments the system can also employ quantum information carriers that encode information in a manner that is not necessarily associated with a binary bit, such as a qudit. Qubits (or qudits) can be implemented in a variety of quantum systems. Examples of qubits include: polarization states of photons; presence of photons in waveguides; or energy states of molecules, atoms, ions, nuclei, or photons. Other examples include other engineered quantum systems such as flux qubits, phase qubits, or charge qubits (e.g., formed from a superconducting Josephson junction); topological qubits (e.g., Majorana fermions); or spin qubits formed from vacancy centers (e.g., nitrogen vacancies in diamond).

A qubit can be “dual-rail encoded” such that the logical value of the qubit is encoded by occupation of one of two modes of the quantum system. For example, the logical 0 and 1 values can be encoded as follows:

$${{\vert 0 〉}_{L} = \vert 10 〉}_{1 , 2} \qquad ( 1 )$$

$${{\vert 1 〉}_{L} = \vert 01 〉}_{1 , 2} \qquad ( 2 )$$

where the subscript “L” indicates that the ket represents a logical state (e.g., a qubit value) and, as before, the notation |ij [symbol] _{1,2} on the right-hand side of the equations above indicates that there are i particles in a first mode and j particles in a second mode, respectively (e.g., where i and j are integers). In this notation, a two-qubit system having a logical state |0 [symbol] |1 [symbol] _{L} (representing a state of two qubits, the first qubit being in a ‘0’ logical state and the second qubit being in a ‘1’ logical state) may be represented using occupancy across four modes by |1001 [symbol] _{1,2,3,4} (e.g., in a photonic system, one photon in a first waveguide, zero photons in a second waveguide, zero photons in a third waveguide, and one photon in a fourth waveguide). In some instances throughout this disclosure, the various subscripts are omitted to avoid unnecessary mathematical clutter.

### 1.2.Entangled States

Many of the advantages of quantum computing relative to “classical” computing (e.g., conventional digital computers using binary logic) stem from the ability to create entangled states of multi-qubit systems. In mathematical terms, a state |ψ [symbol] of n quantum objects is a separable state if |ψ [symbol] =|ψ₁ [symbol] ⊗ . . . ⊗|ψₙ [symbol] , and an entangled state is a state that is not separable. One example is a Bell state, which, loosely speaking, is a type of maximally entangled state for a two-qubit system, and qubits in a Bell state may be referred to as a Bell pair. For example, for qubits encoded by single photons in pairs of modes (a dual-rail encoding), examples of Bell states include:

$$\vert {Φ}^{+} 〉 = \frac{{{{{\vert 0 〉}_{L} \vert 0 〉}_{L} + \vert 1 〉}_{L} \vert 1 〉}_{L}}{\sqrt{2}} = \frac{\vert 10 〉 \vert 10 〉 + \vert 01 〉 \vert 01 〉}{\sqrt{2}} \qquad ( 3 )$$

$$\vert {Φ}^{-} 〉 = \frac{{{{{\vert 0 〉}_{L} \vert 0 〉}_{L} - \vert 1 〉}_{L} \vert 1 〉}_{L}}{\sqrt{2}} = \frac{\vert 10 〉 \vert 10 〉 - \vert 01 〉 \vert 01 〉}{\sqrt{2}} \qquad ( 4 )$$

$$\vert {Ψ}^{+} 〉 = \frac{{{{{\vert 0 〉}_{L} \vert 1 〉}_{L} + \vert 1 〉}_{L} \vert 0 〉}_{L}}{\sqrt{2}} = \frac{\vert 10 〉 \vert 01 〉 + \vert 01 〉 \vert 10 〉}{\sqrt{2}} \qquad ( 5 )$$

$$\vert {Ψ}^{-} 〉 = \frac{{{{{\vert 0 〉}_{L} \vert 1 〉}_{L} - \vert 1 〉}_{L} \vert 0 〉}_{L}}{\sqrt{2}} = \frac{\vert 10 〉 \vert 01 〉 - \vert 01 〉 \vert 10 〉}{\sqrt{2}} \qquad ( 6 )$$

More generally, an n-qubit Greenberger-Horne-Zeilinger (GHZ) state (or “n-GHZ state”) is an entangled quantum state of n qubits. For a given orthonormal logical basis, an n-GHZ state is a quantum superposition of all qubits being in a first basis state superposed with all qubits being in a second basis state:

$$\vert G H Z 〉 = \frac{\vert 0 〉 {}^{{⊗}_{M}} + \vert 1 〉 {}^{{⊗}_{M}}}{\sqrt{2}} \qquad ( 7 )$$

where the kets above refer to the logical basis. For example, for qubits encoded by single photons in pairs of modes (a dual-rail encoding), a 3-GHZ state can be written:

$$\vert G H Z 〉 = \frac{{{{{{{\vert 0 〉}_{L} \vert 0 〉}_{L} \vert 0 〉}_{L} - \vert 1 〉}_{L} \vert 1 〉}_{L} \vert 1 〉}_{L}}{\sqrt{2}} = \frac{\vert 10 〉 \vert 10 〉 \vert 10 〉 + \vert 01 〉 \vert 01 〉 \vert 01 〉}{\sqrt{2}} \qquad ( 8 )$$

where the kets above refer to photon occupation number in six respective modes (with mode subscripts omitted).

### 1.3. Physical Implementations

Qubits (and operations on qubits) can be implemented using a variety of physical systems. In some examples described herein, qubits are provided in an integrated photonic system employing waveguides, beam splitters, photonic switches, and single photon detectors, and the modes that can be occupied by photons are spatiotemporal modes that correspond to presence of a photon in a waveguide. Modes can be coupled using mode couplers, e.g., optical beam splitters, to implement transformation operations, and measurement operations can be implemented by coupling single-photon detectors to specific waveguides. One of ordinary skill in the art with access to this disclosure will appreciate that modes defined by any appropriate set of degrees of freedom, e.g., polarization modes, temporal modes, and the like, can be used without departing from the scope of the present disclosure. For instance, for modes that only differ in polarization (e.g., horizontal (H) and vertical (V)), a mode coupler can be any optical element that coherently rotates polarization, e.g., a birefringent material such as a waveplate. For other systems such as ion trap systems or neutral atom systems, a mode coupler can be any physical mechanism that can couple two modes, e.g., a pulsed electromagnetic field that is tuned to couple two internal states of the atom/ion.

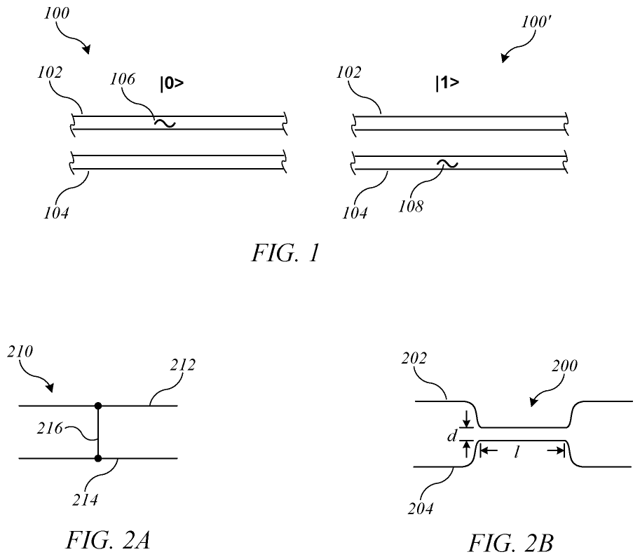

In some embodiments of a photonic quantum computing system using dual-rail encoding, a qubit can be implemented using a pair of waveguides. FIG. 1 shows two representations (100, 100′) of a portion of a pair of waveguides 102, 104 that can be used to provide a dual-rail-encoded photonic qubit. At 100, a photon 106 is in waveguide 102 and no photon is in waveguide 104 (also referred to as a vacuum mode); in some embodiments, this corresponds to the |0 [symbol] _{L} state of a photonic qubit. At 100′, a photon 108 is in waveguide 104, and no photon is in waveguide 102; in some embodiments this corresponds to the |1 [symbol] _{L} state of the photonic qubit. To prepare a photonic qubit in a known logical state, a photon source (not shown) can be coupled to one end of one of the waveguides. The photon source can be operated to emit a single photon into the waveguide to which it is coupled, thereby preparing a photonic qubit in a known state. Photons travel through the waveguides, and by periodically operating the photon source, a quantum system having qubits whose logical states map to different temporal modes of the photonic system can be created in the same pair of waveguides. In addition, by providing multiple pairs of waveguides, a quantum system having qubits whose logical states correspond to different spatiotemporal modes can be created. It should be understood that the waveguides in such a system need not have any particular spatial relationship to each other. For instance, they can be but need not be arranged in parallel.

Occupied modes can be created by using a photon source to generate a photon that then propagates in the desired waveguide. A photon source can be, for instance, a resonator-based source that emits photon pairs, also referred to as a heralded single photon source. In one example of such a source, the source is driven by a pump, e.g., a light pulse, that is coupled into a system of optical resonators that, through a nonlinear optical process (e.g., spontaneous four wave mixing (SFWM), spontaneous parametric down-conversion (SPDC), second harmonic generation, or the like), can generate a pair of photons. Many different types of photon sources can be employed. Examples of photon pair sources can include a microring-based spontaneous four wave mixing (SPFW) heralded photon source (HPS). However, the precise type of photon source used is not critical and any type of nonlinear source, employing any process, such as SPFW, SPDC, or any other process can be used. Other classes of sources that do not necessarily require a nonlinear material can also be employed, such as those that employ atomic and/or artificial atomic systems, e.g., quantum dot sources, color centers in crystals, and the like. In some cases, sources may or may not be coupled to photonic cavities, e.g., as can be the case for artificial atomic systems such as quantum dots coupled to cavities. Other types of photon sources also exist for SPWM and SPDC, such as optomechanical systems and the like.

In such cases, operation of the photon source may be non-deterministic (also sometimes referred to as “stochastic”) such that a given pump pulse may or may not produce a photon pair. In some embodiments, coherent spatial and/or temporal multiplexing of several non-deterministic sources (referred to herein as “active” multiplexing) can be used to allow the probability of having one mode become occupied during a given cycle to approach 1. One of ordinary skill will appreciate that many different active multiplexing architectures that incorporate spatial and/or temporal multiplexing are possible. For instance, active multiplexing schemes that employ log-tree, generalized Mach-Zehnder interferometers, multimode interferometers, chained sources, chained sources with dump-the-pump schemes, asymmetric multi-crystal single photon sources, or any other type of active multiplexing architecture can be used. In some embodiments, the photon source can employ an active multiplexing scheme with quantum feedback control and the like.

Measurement operations can be implemented by coupling a waveguide to a single-photon detector that generates a classical signal (e.g., a digital logic signal) indicating that a photon has been detected by the detector. Any type of photodetector that has sensitivity to single photons can be used. In some embodiments, detection of a photon (e.g., at the output end of a waveguide) indicates an occupied mode while absence of a detected photon can indicate an unoccupied mode.

Some embodiments described below relate to physical implementations of unitary transform operations that couple modes of a quantum system, which can be understood as transforming the quantum state of the system. For instance, if the initial state of the quantum system (prior to mode coupling) is one in which one mode is occupied with probability 1 and another mode is unoccupied with probability 1 (e.g., a state |10 [symbol] in the Fock notation introduced above), mode coupling can result in a state in which both modes have a nonzero probability of being occupied, e.g., a state a₁|10 [symbol] +a₂|01 [symbol] , where |a₁|²+|a₂|²=1. In some embodiments, operations of this kind can be implemented by using beam splitters to couple modes together and variable phase shifters to apply phase shifts to one or more modes. The amplitudes a₁ and a₂ depend on the reflectivity (or transmissivity) of the beam splitters and on any phase shifts that are introduced.

FIG. 2A shows a schematic diagram 210 (also referred to as a circuit diagram or circuit notation) for coupling of two modes. The modes are drawn as horizontal lines 212, 214, and the mode coupler 216 is indicated by a vertical line that is terminated with nodes (solid dots) to identify the modes being coupled. In the more specific language of linear quantum optics, the mode coupler 216 shown in FIG. 2A represents a 50/50 beam splitter that implements a transfer matrix:

$$T = \frac{1}{\sqrt{2}} ( \begin{matrix}1 & i \\ i & 1\end{matrix} ) , \qquad ( 9 )$$

where T defines the linear map for the photon creation operators on two modes. (In certain contexts, transfer matrix T can be understood as implementing a first-order imaginary Hadamard transform.) By convention the first column of the transfer matrix corresponds to creation operators on the top mode (referred to herein as mode 1, labeled as horizontal line 212), and the second column corresponds to creation operators on the second mode (referred to herein as mode 2, labeled as horizontal line 214), and so on if the system includes more than two modes. More explicitly, the mapping can be written as:

$${( \begin{matrix}{a}_{1}^{†} \\ {a}_{2}^{†}\end{matrix} )}_{input} ↦ \frac{1}{\sqrt{2}} ( \begin{matrix}1 & - i \\ - i & 1\end{matrix} ) {( \begin{matrix}{a}_{1}^{†} \\ {a}_{2}^{†}\end{matrix} )}_{output} , \qquad ( 10 )$$

where subscripts on the creation operators indicate the mode that is operated on, the subscripts input and output identify the form of the creation operators before and after the beam splitter, respectively and where:

$${a}_{i} \vert {n}_{i} , {n}_{j} 〉 = \sqrt{{n}_{i}} \vert {n}_{i} - 1 , {n}_{j} 〉 {a}_{j} \vert {n}_{i} , {n}_{j} 〉 = \sqrt{{n}_{j}} \vert {n}_{i} , {n}_{j} - 1 〉 {a}_{j}^{†} \vert {n}_{i} , {n}_{j} 〉 = \sqrt{{n}_{j} + 1} \vert {n}_{i} , {n}_{j} + 1 〉 \qquad ( 11 )$$

For example, the application of the mode coupler shown in FIG. 2A leads to the following mappings:

$${{a}_{1}^{†}}_{input} ↦ \frac{1}{\sqrt{2}} ( {{a}_{1}^{†}}_{output} - {{ia}_{2}^{†}}_{output} ) {{a}_{2}^{†}}_{input} ↦ \frac{1}{\sqrt{2}} ( - {{ia}_{1}^{†}}_{output} + {{a}_{2}^{†}}_{output} ) \qquad ( 12 )$$

Thus, the action of the mode coupler described by Eq. (9) is to take the input states |10 [symbol] , |01 [symbol] , and |11 [symbol] to

$$\vert 10 〉 ↦ \frac{\vert 10 〉 - i \vert 01 〉}{\sqrt{2}} \vert 01 〉 ↦ \frac{- i \vert 10 〉 + \vert 01 〉}{\sqrt{2}} \vert 11 〉 ↦ \frac{- i}{2} ( \vert 20 〉 + \vert 02 〉 ) \qquad ( 13 )$$

FIG. 2B shows a physical implementation of a mode coupling that implements the transfer matrix T of Eq. (9) for two photonic modes in accordance with some embodiments. In this example, the mode coupling is implemented using a waveguide beam splitter 200, also sometimes referred to as a directional coupler or mode coupler. Waveguide beam splitter 200 can be realized by bringing two waveguides 202, 204 into close enough proximity that the evanescent field of one waveguide can couple into the other. By adjusting the separation d between waveguides 202, 204 and/or the length/of the coupling region, different couplings between modes can be obtained. In this manner, a waveguide beam splitter 200 can be configured to have a desired transmissivity. For example, the beam splitter can be engineered to have a transmissivity equal to 0.5 (i.e., a 50/50 beam splitter for implementing the specific form of the transfer matrix T′introduced above). If other transfer matrices are desired, the reflectivity (or the transmissivity) can be engineered to be greater than 0.6, greater than 0.7, greater than 0.8, or greater than 0.9 without departing from the scope of the present disclosure.

In addition to mode coupling, some unitary transforms may involve phase shifts applied to one or more modes. In some photonic implementations, variable phase-shifters can be implemented in integrated circuits, providing control over the relative phases of the state of a photon spread over multiple modes. Examples of transfer matrices that define such a phase shifts are given by (for applying a +i and −i phase shift to the second mode, respectively):

$$s = ( \begin{matrix}1 & 0 \\ 0 & i\end{matrix} ) {s}^{†} = ( \begin{matrix}1 & 0 \\ 0 & - i\end{matrix} ) \qquad ( 14 )$$

For silica-on-silicon materials some embodiments implement variable phase-shifters using thermo-optical switches. The thermo-optical switches use resistive elements fabricated on the surface of the chip, that via the thermo-optical effect can provide a change of the refractive index n by raising the temperature of the waveguide by an amount of the order of 10⁻⁵ K. One of skill in the art with access to the present disclosure will understand that any effect that changes the refractive index of a portion of the waveguide can be used to generate a variable, electrically tunable, phase shift. For example, some embodiments use beam splitters based on any material that supports an electro-optic effect, so-called χ² and χ³ materials such as lithium niobite, BBO, KTP, and the like and even doped semiconductors such as silicon, germanium, and the like.

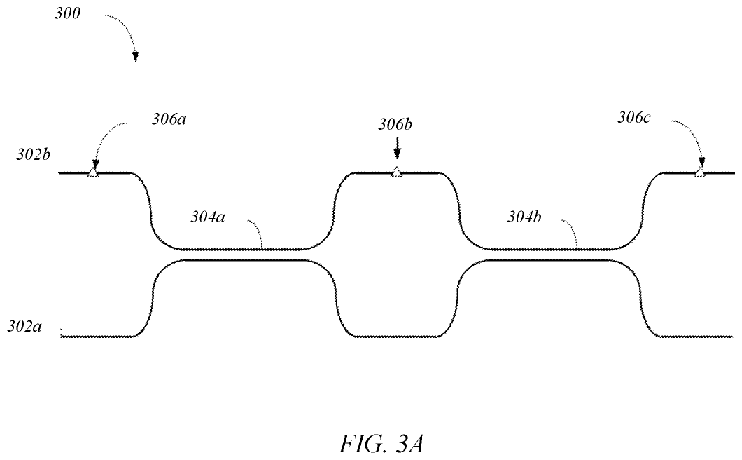

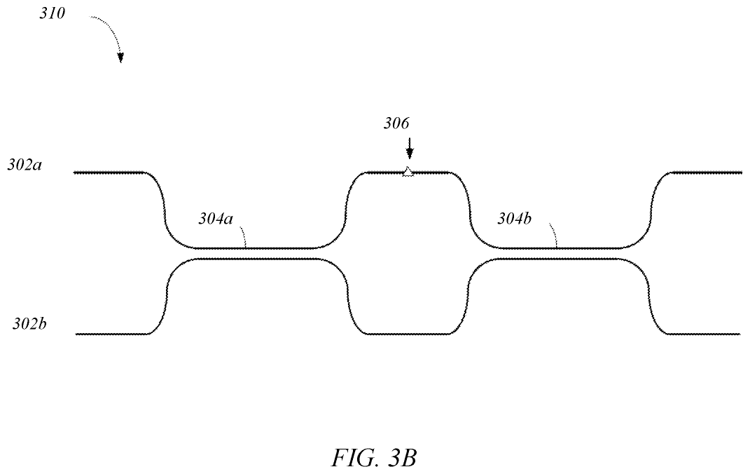

Beam-splitters with variable transmissivity and arbitrary phase relationships between output modes can also be achieved by combining directional couplers and variable phase-shifters in a Mach-Zehnder Interferometer (MZI) configuration 300, e.g., as shown in FIG. 3A. Complete control over the relative phase and amplitude of the two modes 302a, 302b in dual rail encoding can be achieved by varying the phases imparted by phase shifters 306a, 306b, and 306c and the length and proximity of coupling regions 304a and 304b. FIG. 3B shows a slightly simpler example of a MZI 310 that allows for a variable transmissivity between modes 302a, 302b by varying the phase imparted by the phase shifter 306. FIGS. 3A and 3B are examples of how one could implement a mode coupler in a physical device, but any type of mode coupler/beam splitter can be used without departing from the scope of the present disclosure.

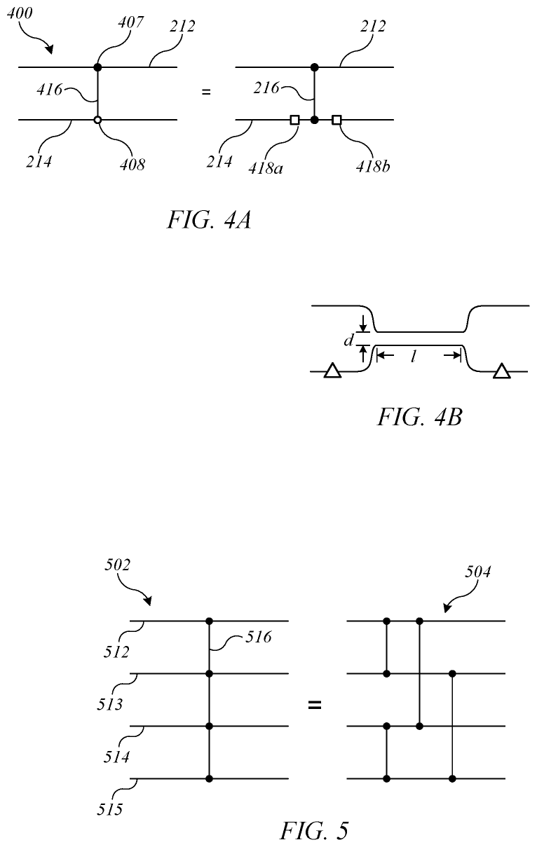

In some embodiments, beam splitters and phase shifters can be employed in combination to implement a variety of transfer matrices. For example, FIG. 4A shows, in a schematic form similar to that of FIG. 2A, a mode coupler 400 implementing the following transfer matrix:

$${T}_{r} = \frac{1}{\sqrt{2}} ( \begin{matrix}1 & 1 \\ 1 & - 1\end{matrix} ) . \qquad ( 15 )$$

Thus, mode coupler 400 applies the following mappings:

$$\vert 10 〉 ↦ \frac{\vert 10 〉 + \vert 01 〉}{\sqrt{2}} \vert 01 〉 ↦ \frac{\vert 10 〉 - \vert 01 〉}{\sqrt{2}} \vert 11 〉 ↦ \frac{1}{2} ( \vert 20 〉 + \vert 02 〉 ) . \qquad ( 16 )$$

The transfer matrix Tᵣ of Eq. (15) is related to the transfer matrix T of Eq. (9) by a phase shift on the second mode. This is schematically illustrated in FIG. 4A by the closed node 407 where mode coupler 416 couples to the first mode (line 212) and open node 408 where mode coupler 416 couples to the second mode (line 214). More specifically, Tᵣ=sTs, and, as shown at the right-hand side of FIG. 4A, mode coupler 416 can be implemented using mode coupler 216 (as described above), with a preceding and following phase shift (denoted by open squares 418a, 418b). Thus, the transfer matrix Tᵣ can be implemented by the physical beam splitter shown in FIG. 4B, where the open triangles represent +i phase shifters.

Similarly, networks of mode couplers and phase shifters can be used to implement couplings among more than two modes. For example, FIG. 5 shows a four-mode coupling scheme that implements a “spreader,” or “mode-information erasure,” transformation on four modes, i.e., it takes a photon in any one of the input modes and delocalizes the photon amongst each of the four output modes such that the photon has equal probability of being detected in any one of the four output modes. (The well-known Hadamard transformation is one example of a spreader transformation.) As in FIG. 2A, the horizontal lines 512-515 correspond to modes, and the mode coupling is indicated by a vertical line 516 with nodes (dots) to identify the modes being coupled. In this case, four modes are coupled. Circuit notation 502 is an equivalent representation to circuit diagram 504, which is a network of first-order mode couplings. More generally, where a higher-order mode coupling can be implemented as a network of first-order mode couplings, a circuit notation similar to notation 502 (with an appropriate number of modes) may be used.

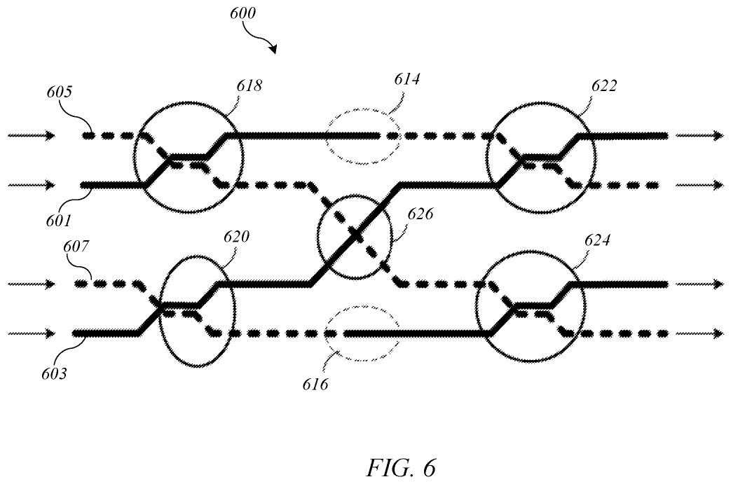

FIG. 6 illustrates an example optical device 600 that can implement the four-mode mode-spreading transform shown schematically in FIG. 5 in accordance with some embodiments. Optical device 600 includes a first set of optical waveguides 601, 603 formed in a first layer of material (represented by solid lines in FIG. 6) and a second set of optical waveguides 605, 607 formed in a second layer of material that is distinct and separate from the first layer of material (represented by dashed lines in FIG. 6). The second layer of material and the first layer of material are located at different heights on a substrate. One of ordinary skill will appreciate that an interferometer such as that shown in FIG. 6 could be implemented in a single layer if appropriate low loss waveguide crossing were employed.

At least one optical waveguide 601, 603 of the first set of optical waveguides is coupled with an optical waveguide 605, 607 of the second set of optical waveguides with any type of suitable optical coupler, e.g., the directional couplers described herein (e.g., the optical couplers shown in FIGS. 2B, 3A, 3B). For example, the optical device shown in FIG. 6 includes four optical couplers 618, 620, 622, and 624. Each optical coupler can have a coupling region in which two waveguides propagate in parallel. Although the two waveguides are illustrated in FIG. 6 as being offset from each other in the coupling region, the two waveguides may be positioned directly above and below each other in the coupling region without offset. In some embodiments, one or more of the optical couplers 618, 620, 622, and 624 are configured to have a coupling efficiency of approximately 50% between the two waveguides (e.g., a coupling efficiency between 49% and 51%, a coupling efficiency between 49.9% and 50.1%, a coupling efficiency between 49.99% and 50.01%, and a coupling efficiency of 50%, etc.). For example, the length of the two waveguides, the refractive indices of the two waveguides, the widths and heights of the two waveguides, the refractive index of the material located between two waveguides, and the distance between the two waveguides are selected to provide the coupling efficiency of 50% between the two waveguides. This allows the optical coupler to operate like a 50/50 beam splitter.

In addition, the optical device shown in FIG. 6 can include two inter-layer optical couplers 614 and 616. Optical coupler 614 allows transfer of light propagating in a waveguide on the first layer of material to a waveguide on the second layer of material, and optical coupler 616 allows transfer of light propagating in a waveguide on the second layer of material to a waveguide on the first layer of material. The optical couplers 614 and 616 allow optical waveguides located in at least two different layers to be used in a multi-channel optical coupler, which, in turn, enables a compact multi-channel optical coupler.

Furthermore, the optical device shown in FIG. 6 includes a non-coupling waveguide crossing region 626. In some implementations, the two waveguides (603 and 605 in this example) cross each other without having a parallel coupling region present at the crossing in the non-coupling waveguide crossing region 626 (e.g., the waveguides can be two straight waveguides that cross each other at a nearly 90-degree angle).

Those skilled in the art will understand that the foregoing examples are illustrative and that photonic circuits using beam splitters and/or phase shifters can be used to implement many different transfer matrices, including transfer matrices for real and imaginary Hadamard transforms of any order, discrete Fourier transforms, and the like. One class of photonic circuits, referred to herein as “spreader” or “mode-information erasure (MIE)” circuits, has the property that if the input is a single photon localized in one input mode, the circuit delocalizes the photon amongst each of a number of output modes such that the photon has equal probability of being detected in any one of the output modes. Examples of spreader or MIE circuits include circuits implementing Hadamard transfer matrices. (It is to be understood that spreader or MIE circuits may receive an input that is not a single photon localized in one input mode, and the behavior of the circuit in such cases depends on the particular transfer matrix implemented.) In other instances, photonic circuits can implement other transfer matrices, including transfer matrices that, for a single photon in one input mode, provide unequal probability of detecting the photon in different output modes.

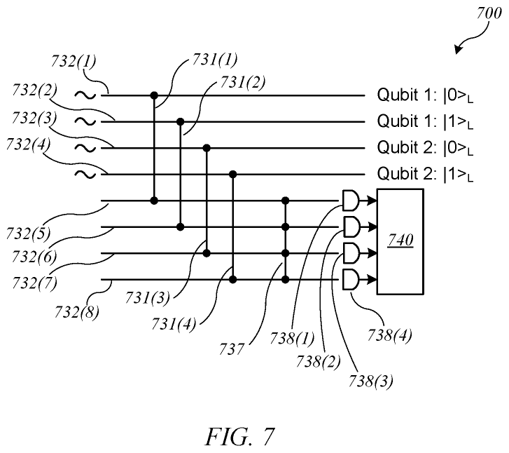

In some embodiments, entangled states of multiple photonic qubits can be created by coupling modes of two (or more) qubits and performing measurements on other modes. By way of example, FIG. 7 shows a circuit diagram for a Bell state generator 700 that can be used in some dual-rail-encoded photonic embodiments. In this example, modes 732(1)-732(4) are initially each occupied by a photon (indicated by a wavy line); modes 732(5)-732(8) are initially vacuum modes. (Those skilled in the art will appreciate that other combinations of occupied and unoccupied modes can be used.)

A first-order mode coupling (e.g., implementing transfer matrix T of Eq. (9)) is performed on pairs of occupied and unoccupied modes as shown by mode couplers 731(1)-731(4). Thereafter, a mode-information erasure coupling (e.g., implementing a four-mode mode spreading transform as shown in FIG. 5) is performed on four of the modes (modes 732(5)-732(8)), as shown by mode coupler 737. Modes 732(5)-732(8) act as “heralding” modes that are measured and used to determine whether a Bell state was successfully generated on the other four modes 732(1)-732(4). For instance, detectors 738(1)-738(4) can be coupled to the modes 732(5)-732(8) after second-order mode coupler 737. Each detector 738(1)-738(4) can output a classical data signal (e.g., a voltage level on a conductor) indicating whether it detected a photon (or the number of photons detected). These outputs can be coupled to classical decision logic circuit 740, which determines whether a Bell state is present on the other four modes 732(1)-732(4). For example, decision logic circuit 740 can be configured such that a Bell state is confirmed (also referred to as “success” of the Bell state generator) if and only if a single photon was detected by each of exactly two of detectors 738(1)-738(4). Modes 732(1)-732(4) can be mapped to the logical states of two qubits (Qubit 1 and Qubit 2), as indicated in FIG. 7. Specifically, in this example, the logical state of Qubit 1 is based on occupancy of modes 732(1) and 732(2), and the logical state of Qubit 2 is based on occupancy of modes 732(3) and 732(4). It should be noted that the operation of Bell state generator 700 can be non-deterministic; that is, inputting four photons as shown does not guarantee that a Bell state will be created on modes 732(1)-732(4). In one implementation, the probability of success is 4/32.

In some embodiments, it is desirable to form quantum systems of multiple entangled qubits. One technique for forming multi-qubit quantum systems is through the use of an entangling measurement, which is a projective measurement that can be employed to create entanglement between systems of qubits. As used herein, “fusion” (or “a fusion operation” or “fusion measurement” or “fusing”) refers to a projective entangling measurement performed on two or more qubits. A “fusion gate” is a structure that receives two (or in some instances more than two) input qubits, each of which is typically part of a different entangled quantum system. In implementations with two qubits, a fusion gate performs a projective measurement operation on the input qubits that produces either one (“type I fusion”) or zero (“type II fusion”) output qubits in a manner such that the initial two separately-entangled quantum systems are fused into a single entangled quantum system. Fusion gates are specific examples of a general class of projective entangling measurements and are particularly suited for photonic architectures. By way of introduction to fusion measurements, examples of type I and type II fusion gates will now be described. Additional examples of fusion gates for photonic GKP qubits, including fusion gates with more than two input qubits, are described below.

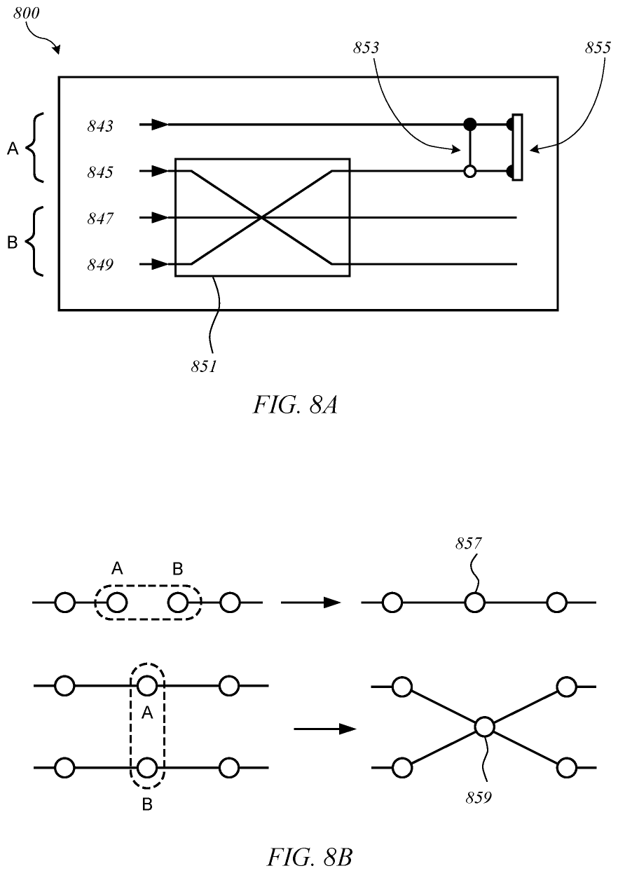

FIG. 8A shows a circuit diagram illustrating a type I fusion gate 800 in accordance with some embodiments. The diagram shown in FIG. 8A is schematic with each horizontal line representing a mode of a quantum system, e.g., a photon. In a dual-rail encoding, each pair of modes represents a qubit. In a photonic implementation of the gate the modes in diagrams such as that shown in FIG. 8A can be physically realized using single photons in photonic waveguides. Most generally, a type I fusion gate like that shown in FIG. 8A takes qubit A (physically realized, e.g., by photon modes 843 and 845) and qubit B (physically realized, e.g., by photon modes 847 and 849) as input and outputs a single “fused” qubit that inherits the entanglement with other qubits that were previously entangled with either (or both) of input qubit A or input qubit B.

For example, FIG. 8B shows the result of type-I fusing of two qubits A and B that are each, respectively, a qubit located at the end (i.e., a leaf) of some longer entangled quantum system (only a portion of which is shown). The qubit 857 that remains after the fusion operation inherits the entangling bonds from the original qubits A and B thereby creating a larger linear entangled quantum system. FIG. 8B also shows the result of type-I fusing of two qubits A and B that are each, respectively, an internal qubit that belongs to some longer entangled cluster of qubits (only a portion of which is shown). As before, the qubit 859 that remains after fusion inherits the entangling bonds from the original qubits A and B thereby creating a fused quantum system. In this case, the qubit that remains after the fusion operation is entangled with the fused quantum system by way of four other nearest neighbor qubits as shown.

Returning to the schematic illustration of type I fusion gate 800 shown in FIG. 8A, qubit A is dual-rail encoded by modes 843 and 845, and qubit B is dual-rail encoded by modes 847 and 849. For example, in the case of path-encoded photonic qubits, the logical zero state of qubit A (denoted |0 [symbol] _{A}) occurs when mode 843 is a photonic waveguide that includes a single photon and mode 845 is a photonic waveguide that includes zero photons (and likewise for qubit B). Thus, type I fusion gate 800 can take as input two dual-rail-encoded photon qubits thereby resulting in a total of four input modes (e.g., modes 843, 845, 847, and 849). To accomplish the fusion operation, a mode coupler (e.g., 50/50 beam splitter) 853 is applied between a mode of each of the input qubits, e.g., between mode 843 and mode 849 before performing a detection operation on both modes using photon detectors 855 (which includes two distinct photon detectors coupled to modes 843 and 849 respectively). In addition, to ensure that the output modes are adjacently positioned, a mode swap operation 851 can be applied that swaps the position of the second mode of qubit A (mode 845) with the position the second mode of qubit B (mode 849). In some embodiments, mode swapping can be accomplished through a physical waveguide crossing as described above or by one or more photonic switches or by any other type of physical mode swap.

FIG. 8A shows only an example arrangement for a type I fusion gate and one of ordinary skill will appreciate that the position of the mode coupler and the presence of the mode swap region 851 can be altered without departing from the scope of the present disclosure. For example, beam splitter 853 can be applied between modes 845 and 847. Mode swaps are optional and are not necessary if qubits having non-adjacent modes can be dealt with, e.g., by tracking which modes belong to which qubits by storing this information in a classical memory.

Type I fusion gate 800 is a nondeterministic gate, i.e., the fusion operation succeeds with a certain probability less than 1, and in other cases the quantum system that results is not a larger quantum system that comprises the original quantum systems fused together into the larger quantum system. More specifically, gate 800 “succeeds,” with probability 50%, when only one photon is detected by detectors 855, and “fails” if zero or two photons are detected by detectors 855. When the gate succeeds, the two quantum systems that qubits A and B were a part of become fused into a single larger quantum system with a fused qubit remaining as the qubit that links the two previously unlinked quantum systems (see, e.g., FIG. 8B). However, when the fusion gate fails, it has the effect of removing both qubits from the original quantum systems without generating a larger quantum system.

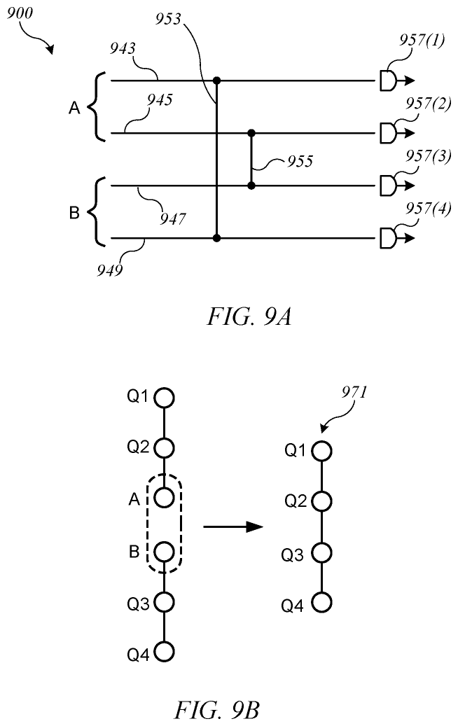

FIG. 9A shows a circuit diagram illustrating a type II fusion gate 900 in accordance with some embodiments. Like other diagrams herein, the diagram shown in FIG. 9A is schematic with each horizontal line representing a mode of a quantum system, e.g., a photon. In a dual-rail encoding, each pair of modes represents a qubit. In a photonic implementation of the gate the modes in diagrams such as that shown in FIG. 9A can be physically realized using single photons in photonic waveguides. Most generally, a type II fusion gate such as gate 900 takes qubit A (physically realized, e.g., by photon modes 943 and 945) and qubit B (physically realized, e.g., by photon modes 947 and 949) as input and outputs a quantum system that inherits the entanglement with other qubits that were previously entangled with either (or both) of input qubit A or input qubit B. (For type II fusion, if the input quantum system had N qubits, the output quantum system has N−2 qubits. This is different from type I fusion where an input quantum system of N qubits leads to an output quantum system having N−1 qubits.)

For example, FIG. 9B shows the result of type-II fusing of two qubits A and B that are each, respectively, a qubit located at the end (i.e., a leaf) of some longer entangled cluster state (only a portion of which is shown). The resulting quantum system 971 inherits the entangling bonds from qubits A and B thereby creating a larger linear quantum system.

Returning to the schematic illustration of type II fusion gate 900 shown in FIG. 9A, qubit A is dual-rail encoded by modes 943 and 945, and qubit B is dual-rail encoded by modes 947 and 949. For example, in the case of path encoded photonic qubits, the logical zero state of qubit A (denoted |0 [symbol] _{A}) occurs when mode 943 is a photonic waveguide that includes a single photon and mode 945 is a photonic waveguide that includes zero photons (and likewise for qubit B). Thus, type II fusion gate 900 takes as input two dual-rail-encoded photon qubits thereby resulting in a total of four input modes (e.g., modes 943, 945, 947, and 949). To accomplish the fusion operation, a first mode coupler (e.g., 50/50 beam splitter) 953 is applied between a mode of each of the input qubits, e.g., between mode 943 and mode 949, and a second mode coupler (e.g., 50/50 beam splitter) 955 is applied between the other modes of each of the input qubits, e.g., between modes 945 and 947. A detection operation is performed on all four modes using photon detectors 957(1)-957(4). In some embodiments, mode swap operations (not shown in FIG. 9A) can be performed to place modes in adjacent positions prior to mode coupling. In some embodiments, mode swapping can be accomplished through a physical waveguide crossing as described above or by one or more photonic switches or by any other type of physical mode swap. Mode swaps are optional and are not necessary if qubits having non-adjacent modes can be dealt with, e.g., by tracking which modes belong to which qubits by storing this information in a classical memory.

FIG. 9A shows only an example arrangement for the type II fusion gate and one of ordinary skill will appreciate that the positions of the mode couplers and the presence or absence of mode swap regions can be altered without departing from the scope of the present disclosure.

The type II fusion gate shown in FIG. 9A is a nondeterministic gate, i.e., the fusion operation succeeds with a certain probability less than 1, and in other cases the quantum system that results is not a larger quantum system that comprises the original quantum systems fused together. More specifically, the gate “succeeds” in the case where one photon is detected by one of detectors 957(1) and 957(4) and one photon is detected by one of detectors 957(2) and 957(3); in all other cases, the gate “fails.” When the gate succeeds, the two quantum systems that qubits A and B were a part of become fused into a single larger quantum system; unlike type-I fusion, no fused qubit remains (compare FIG. 8B and FIG. 9B). When the fusion gate fails, it has the effect of removing both qubits from the original quantum systems without generating a larger quantum system.

The foregoing description provides an example of how photonic circuits can be used to implement physical qubits and operations on physical qubits using mode coupling between waveguides. In these examples, a pair of modes can be used to represent each physical qubit. Some of the examples described below can be implemented using similar photonic circuit elements. In other embodiments, other qubit encodings are used. An example is GKP encoding as described below. GKP encoding can be implemented, e.g., using photons and photonic circuits.

In some embodiments, an entangled system of multiple physical qubits can be mapped to one or more “logical qubits,” and operations associated with a quantum computation can be defined as logical operations on logical qubits, which in turn can be mapped to physical operations on physical qubits. In general, the term “qubit,” when used herein without specifying physical or logical qubit, should be understood as referring to a physical qubit.

### 2. Overview of Fusion-Based Quantum Computing (FBQC)

“Quantum computation,” as used herein, refers generally to performing a sequence of operations (a “computation”) on an ensemble of qubits. Quantum computation is often considered in the framework of “circuit-based quantum computation” (CBQC), in which the operations are specified as a sequence of logical “gates” performed on qubits. Gates can be either single-qubit unitary operations (rotations), two-qubit entangling operations such as the CNOT gate, or other multi-qubit gates such as the Toffoli gate.

One challenge for CBQC, and for quantum computation generally, is that physical systems implementing qubits and operations on qubits are often non-deterministic and noisy. For example, the photonic Bell state generator and fusion circuits described above can create entanglement between photonic qubits, but they do so non-deterministically, with a probability of success that is considerably less than 1. In addition, the physical systems may be “noisy”; for instance, a waveguide propagating a photon may be somewhat less than perfectly efficient, resulting in occasional loss of photons. For reasons such as these, fault tolerant quantum computing is a desirable goal.

“Measurement-based quantum computation” (MBQC) is an approach to implementing quantum computing that allows for fault-tolerance. In MBQC, computation proceeds by first preparing a particular entangled state of many physical qubits, commonly referred to as a “cluster state,” then carrying out a series of single-qubit measurements to enact (or execute) the quantum computation. For instance, rather than implementing a sequence of gates operating on one or two physical qubits, a subset of the physical qubits in the cluster state can be mapped to a “logical” qubit, and a gate operation on logical qubits can be mapped to a particular set of measurements on physical qubits associated with one or more logical qubits. Entanglement between the physical qubits results in expected correlations among measurements on different physical qubits, which enables error correction. The cluster state can be prepared in a manner that is not specific to a particular computation (other than, perhaps, the size of the cluster state), and the choice of single-qubit measurements is determined by the particular computation. In the MBQC approach, fault tolerance can be achieved by careful design of the cluster state and by using the topology of the cluster state to encode logical qubits in a manner that protects against any logical errors that may be caused by errors on any of the physical qubits that make up the cluster state. The value of the logical qubits can be determined (read out or decoded), based on the results (also referred to herein as measurement outcomes) of the single-particle measurements that are made on the cluster state's physical qubits as the computation proceeds.

For example, a cluster state suitable for MBQC can be defined by preparing a collection of physical qubits in a particular state (sometimes referred to as the |+ [symbol] state) and applying a controlled-phase gate (sometimes referred to as a “CZ gate”) between pairs of physical qubits to generate the cluster state. Graphically, a cluster state formed in this manner can be represented by a graph with vertices representing the physical qubits and edges that represent entanglement (e.g., the application of CZ gates) between pairs of qubits. The graph can be a three-dimensional graph having a regular structure formed from repeating unit cells and is sometimes referred to as a “lattice.” One example of a lattice is the Raussendorf lattice, which is described in detail in R. Raussendorf et al., “Fault-Tolerant One-Way Quantum Computer,” Annals of Physics 321(9):2242-2270 (2006). In such representations, two-dimensional boundaries of the lattice can be identified. Qubits belonging to those boundaries are referred to as “boundary qubits” while all other qubits are referred to as “bulk qubits.” Other cluster state structures can also be used; examples are described in International Patent Application Publication No. WO 2019/173651 and International Patent Application Publication No. WO 2019/178009. Logical operations are performed by making single-qubit measurements on qubits of the cluster state, with each measurement being made in a particular logical basis that is selected according to the particular quantum computation to be performed. The collection of measurement results across the cluster state can be interpreted as the result of a quantum computation on a set of logical qubits through the use of a decoder. Numerous examples of decoder algorithms are available, including the Union-Find decoder as described in International Patent Application Publication No. WO2019/002934A1.

In some implementations, decoding (or interpretation) of measurement results can proceed in stages. For example, in a first stage of decoding, a set of syndrome values can be generated from the collection of measurement outcomes by combining the measurement values associated with qubits that couple to a particular edge in the graph representation, and a syndrome graph can be constructed based on the syndrome values and the lattice topology. Examples of generating syndrome values and syndrome graphs are described in International Patent Application Publication NO. WO 2021/155289. In a second stage of decoding, various algorithms can be applied to the syndrome graph to extract the result of the quantum computation (e.g., the logical states of the logical qubits).

However, the generation and maintenance of long-range entanglement across the cluster state and subsequent storage of large cluster states can be a challenge. For example, for any physical implementation of the MBQC approach, a cluster state containing many thousands, or more, of mutually entangled (physical) qubits must be prepared and then stored for some period of time before the single-qubit measurements are performed. This can be difficult to achieve in practice.

“Fusion-based quantum computing” (FBQC) is a technique related to MBQC in that a computation on a set of logical qubits can be defined as a set of measurements on a (generally much larger) number of physical qubits, with correlations among measurement results on the physical qubits enabling error correction. FBQC, however, avoids the need to first create, then subsequently manipulate, a large cluster state. In a photonic implementation of FBQC, entangled states consisting of a few physical qubits (referred to as “resource states”) are periodically generated and transported (via waveguides) to circuits that can perform measurement operations (e.g., single-qubit measurements and/or projective entangling measurements such as the type II fusion operations described above). The measurements destroy the measured qubits; however, the quantum information is preserved as it is transferred (teleported) to other qubits of other resource states. Thus, quantum information is not stored in a static array of physical qubits but is instead periodically teleported to freshly generated physical qubits.

In FBQC, somewhat similarly to MBQC, a computation can be mapped to an undirected graph, referred to as a fusion graph, that can have a lattice-like structure. The fusion graph can define operations to be performed on the physical qubits of the resource states, including fusion operations on selected qubits of different resource states (e.g., in the “bulk” region of a lattice) and individual qubit measurements (e.g., at boundaries of the lattice). Examples of FBQC techniques are described in above-referenced International Patent Application Publication NO. WO 2021/155289. This section provides a conceptual description of FBQC, to provide context for specific implementations described below.

### 2.1.Resource States

As noted, FBQC can use a “resource state” as a basic physical element to implement quantum computations. As used herein, a “resource state” refers to an entangled system of a number (n) of physical qubits in a non-separable entangled state (which is an entangled state that cannot be decomposed into smaller separate entangled states). In various embodiments, the number n can be a small number (e.g., between 2 and 30), although larger numbers are not precluded.

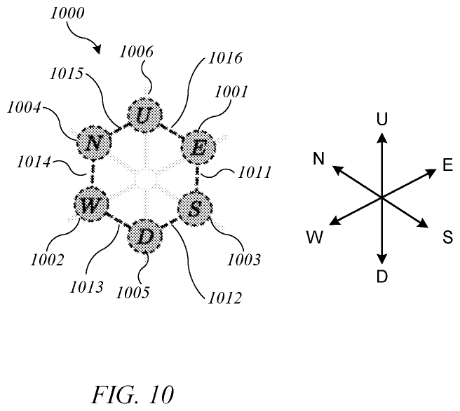

FIG. 10 shows a graph representation of a resource state 1000 that can be used according to some embodiments. In the graph representation of FIG. 10, each physical qubit 1001-1006 of resource state 1000 is represented as a dot, and entanglement between physical qubits is represented by lines 1011-1016 connecting pairs of dots. Resource state 1000 is sometimes referred to as a “6-ring” resource state. In examples used herein, the entanglement geometry defines a three-dimensional space. For convenience, the cardinal directions in the entanglement space are referred to as North-South (N-S), East-West (E-W), and Up-Down (U-D). Resource state 1000 has one qubit associated with each cardinal direction (N, S, U, D, E, W) in the entanglement space. It should be understood that the directional labels refer to entanglement space and need not correspond to physical dimensions or directions in physical space. Further, in some instances qubits may be separated in time rather than in spatial dimensions. For example, each physical qubit can be implemented using photons propagating in waveguides, and a particular section of waveguide may propagate photons associated with different qubits at different times.

Resource state 1000 is illustrative and not limiting. In some embodiments, the entanglement geometry of a resource state can be chosen based on a particular computation to be executed, and different resource states that are used in the same computation can have different entanglement geometries. Further, while resource state 1000 includes six qubits, the number of qubits in each resource state can also be varied. Accordingly, a resource state may be larger or smaller than the example shown.

### 2.2.Logical Operations

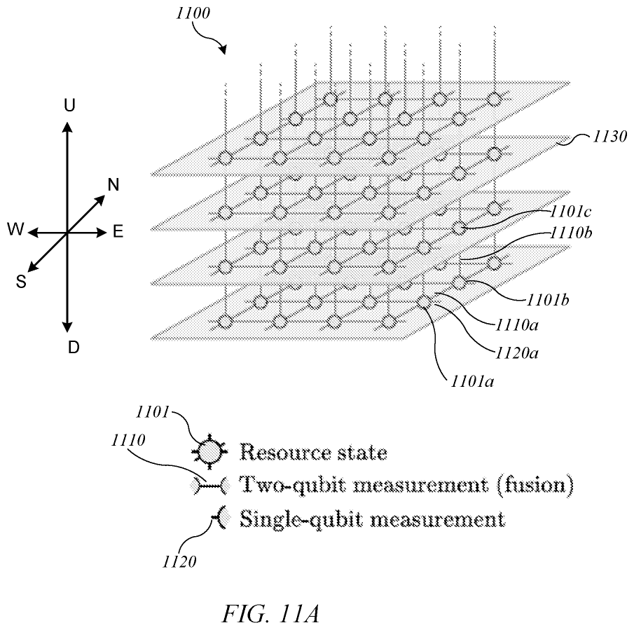

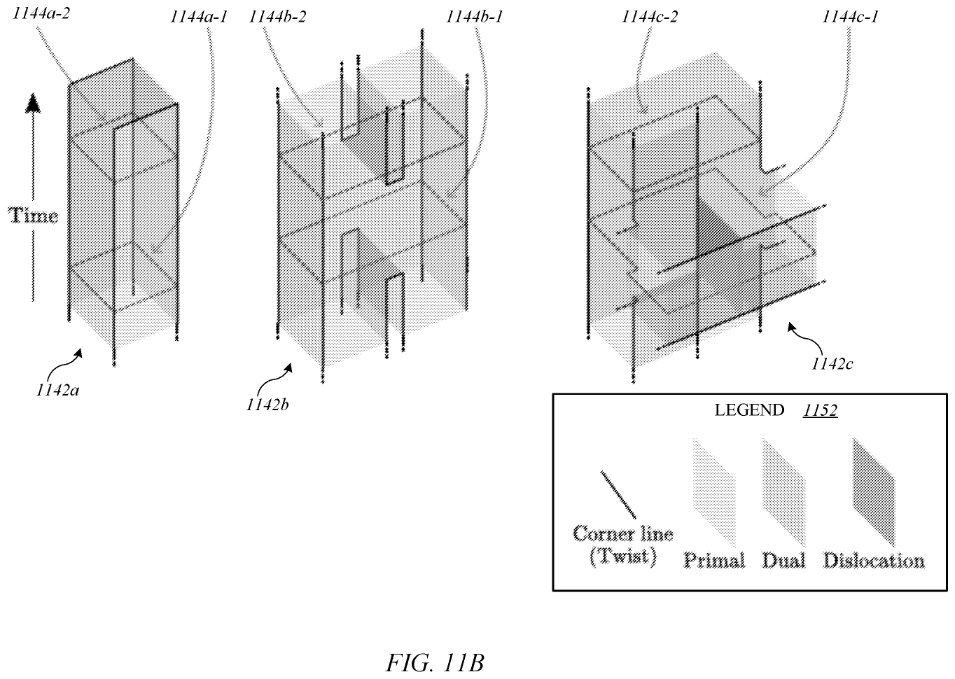

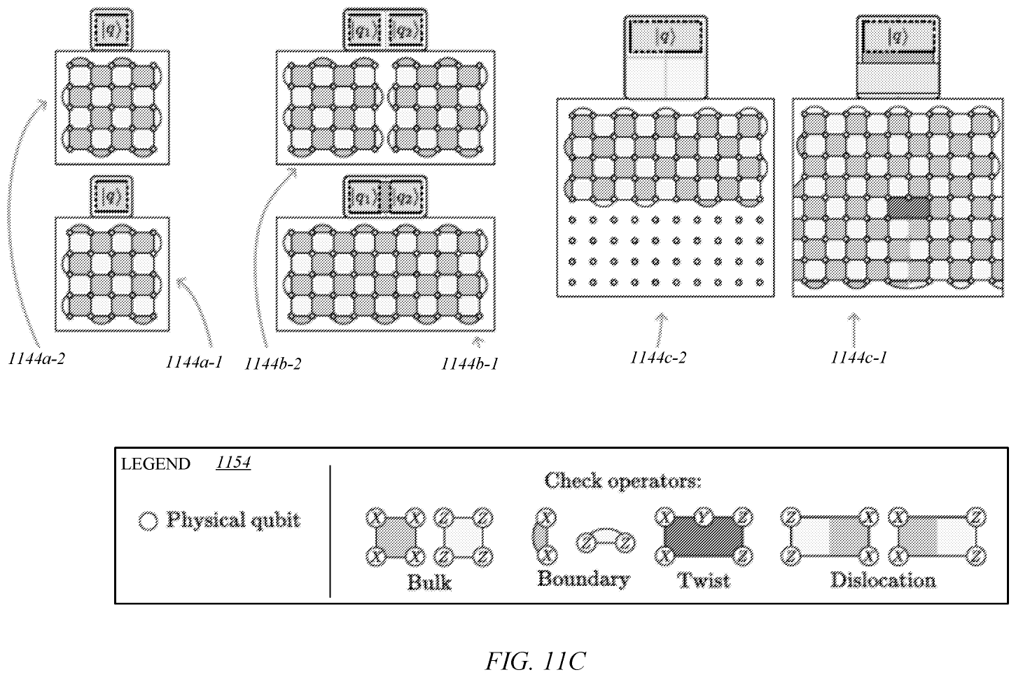

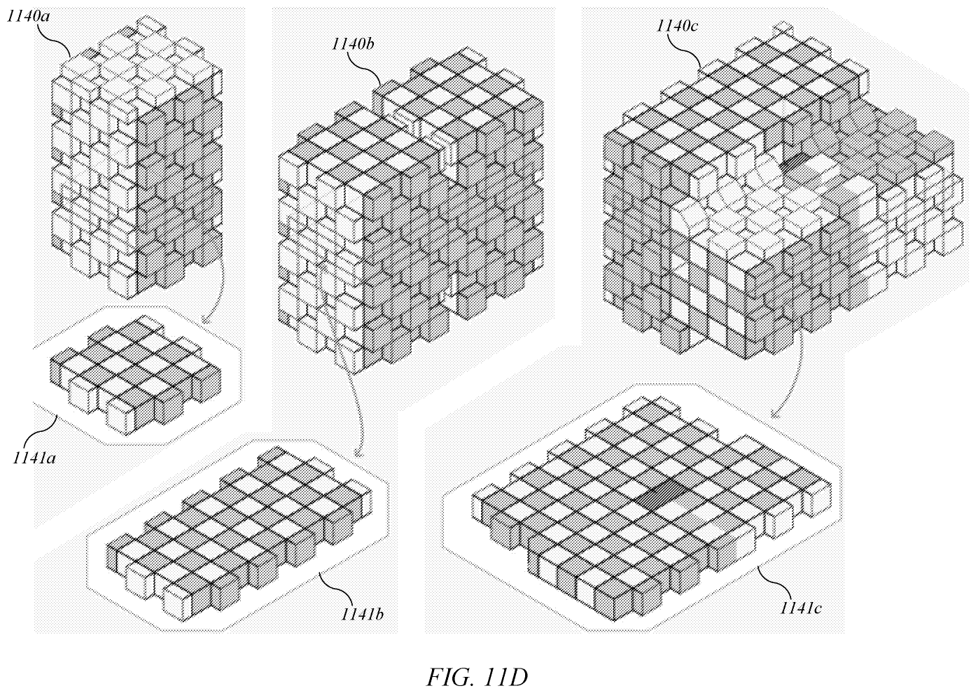

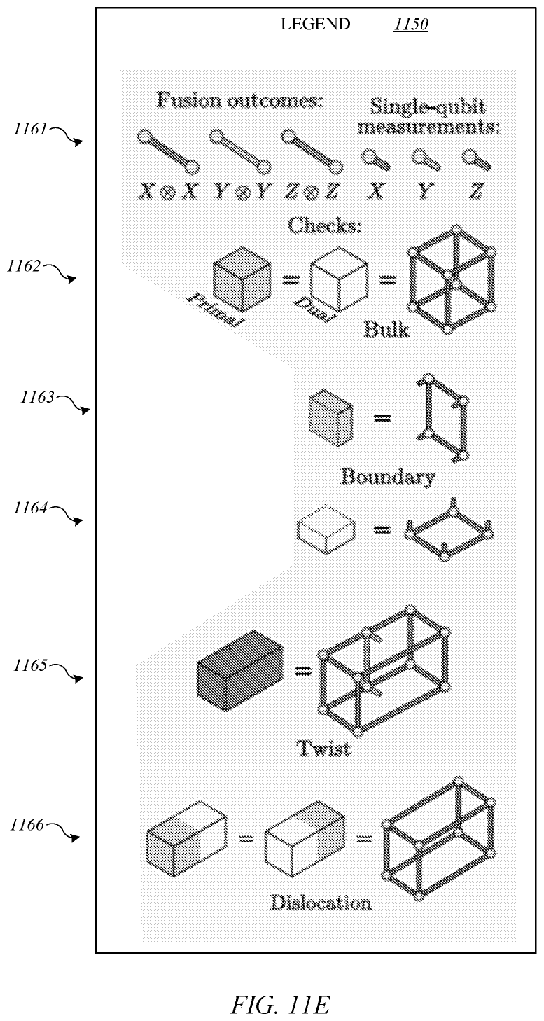

Operations to be performed on qubits of resource states in connection with FBQC can be represented conceptually using a fusion graph. FIG. 11A shows an example of a fusion graph 1100 according to some embodiments. The same three-dimensional entanglement space defined in FIG. 10 is used, with the same N-S, E-W, U-D naming convention (which need not correspond to any physical dimension or direction). However, unlike in FIG. 10, each vertex 1101 represents a resource state (e.g., 6-ring resource state 1000) rather than an individual qubit. Each vertex 1101 represents a physically distinct instance of the resource state. Each edge 1110 connecting two vertices 1101 corresponds to a fusion operation between qubits of different resource states. Each fusion operation can be, e.g., a type II fusion operation as described above that produces a two-qubit measurement. The particular qubits involved can be identified from the direction of the edges in the entanglement space. Thus, for example, edge 1110a corresponds to a fusion operation between the N qubit of a resource state represented by vertex 1101a and the S qubit of a (different) resource state represented by vertex 1101b, while edge 1110b corresponds to a fusion operation between the U qubit of the resource state represented by vertex 1101b and the D qubit of a (third) resource state represented by vertex 1101c. Each half-edge 1120 (a “half-edge” is connected to only one vertex 1101) represents a single-qubit measurement on the corresponding qubit of the resource state represented by that vertex 1101. Thus, for example, half-edge 1120a corresponds to a single-qubit measurement on the E qubit of the resource state represented by vertex 1101a.

In some embodiments, a fusion graph such as fusion graph 1100 can be viewed as a series of “layers” 1130, where each layer corresponds to a coordinate on the U-D axis. Implementing FBQC in a physical system can include successively generating resource states for each layer (e.g., in the direction from D to U) and performing the fusion and single-qubit measurement operations within each layer as specified by the edges and half-edges of the graph for that layer. As resource states for successive layers are generated, fusion operations can be performed between the U qubits of one layer and the D qubits of resource states in corresponding position of the next layer. In the description that follows, fusion operations may be referred to as “spacelike” or “timelike.” This terminology is evocative of particular implementations in which different qubits or resource states are generated at different times: spacelike fusion can be performed between qubits generated at the same time using different instances of hardware, while timelike fusion can be performed between qubits generated at different times using the same instance of hardware (or different instances of hardware). For photonic qubits, timelike fusion can be implemented by delaying an earlier-produced qubit (e.g., using additional lengths of waveguide material to create a longer propagation path for the photon), thereby allowing mode coupling with a later-produced qubit. By leveraging timelike fusion, the same hardware can be used to generate multiple instances of the resource states within a layer and/or to generate multiple layers of resource states.

In some encoding schemes for sequences of operations on logical qubits, a logical qubit that is “at rest” (i.e., not interacting with other logical qubits or otherwise being operated on) can be mapped onto a fusion graph having a regular lattice pattern as shown in FIG. 11A. For the 6-ring resource state of FIG. 10, each resource state in the bulk of the lattice has each of its six qubits fused with a qubit of a neighboring resource state. (Two qubits that are input to a type II fusion circuit are sometimes colloquially described as being “fused with” each other.) For instance, E qubit 1001 of a first instance of resource state 1000 and W qubit 1002 of a second instance of resource state 1000 can be input into a fusion circuit (e.g., the type II fusion circuit of FIG. 9A), resulting in a two-qubit measurement. At the boundaries of the lattice, qubits that are not subject to fusion operations can be subject to single-qubit measurements.

Logical operations on logical qubits can be specified by modifying the regular lattice pattern of a fusion graph at selected positions, e.g., by replacing single-qubit measurements with fusion operations or vice versa. The choice of modifications depends on the particular computation to be performed. Some examples will now be described.

In some embodiments, fusion graphs such fusion graph 1100 can be used to specify logical operations to be performed on a set of logical qubits. For example, a fusion graph defining a logical operation implemented in FBQC can be generated from a surface-code spacetime or time-slice diagram of the kind used to define computations in fault-tolerant CBQC. FIGS. 11B-11D show examples of how fusion graphs can be generated from surface-code spacetime or time-slice diagrams for three different logical operations: (a) measurement of an idling logical qubit (i.e., a logical qubit that is not interacting with any other logical qubit); (b) two-qubit X⊗X measurements (“lattice surgery”); and (c) Y measurement with a twist. FIG. 11E shows a legend 1150 for the fusion-graph notation used in FIG. 11D.

FIG. 11B shows examples of surface-code spacetime diagrams 1142a-1142c, which can be constructed using techniques known in the art. As shown in legend 1152, surface-code spacetime diagrams can represent logical operations (e.g., twists, dislocations) on surfaces (e.g., primal and dual boundaries) that define logical qubits. Spacetime diagram 1142a corresponds to a logical qubit at rest. Spacetime diagram 1142b corresponds to a two-qubit X⊗X measurement. Spacetime diagram 1142c corresponds to a Y measurement with a twist. When performing fault-tolerant quantum computations with surface codes and CBQC, an entire quantum computation can proceed through a sequence of time slices (or time steps). At each time slice, a set of “check operator” measurements, is performed, where the check operator measurements are measurements of operators on physical qubits; the pattern of check operator measurements implements certain logical operations on logical qubits and enables the detection and correction of errors. The check operator measurements at a given time slice can be represented in a time-slice diagram. By way of example, for each logical operation in FIG. 11B, time-slice diagrams for two representative time slices are shown in FIG. 11C. Specifically, time slices 1144a-1 and 1144a-2 are selected from spacetime diagram 1142a; time slices 1144b-1 and 1144b-2 are selected from spacetime diagram 1142b; and time slices 1144c-1 and 1144c-2 are selected from spacetime diagram 1142c. In all time slice diagrams of FIG. 11C, a square code distance of 5 is used, and a logical qubit is mapped to a square patch of 5×5 physical qubits to which check operators are applied. (It should be understood that different code distances can be applied.) As shown in legend 1154, the check operators in each time slice include four-qubit operators X^{⊗4} and Z^{⊗4} in the bulk and two-qubit operators X^{⊗2} and Z^{⊗2} at the boundaries, where X, Y, and Z are the Pauli operators on physical qubits. Twist and dislocation operators are also defined as illustrated. As shown in time-slice diagrams 1144a-1, 1144a-2, 1144b-1, 1144b-2, 1144c-1, and 1144c-2, a time slice can be drawn in a simplified manner that omits notation of the physical-qubit operators; the correct operators can be inferred from the pattern of light and dark shading according to the legend.

A quantum computation can be expressed as a sequence of time slices such as the time slices of FIG. 11C. However, it is often more convenient to represent a sequence of 2D time slices in a 3D diagram, such as spacetime diagrams 1142a-1142c of FIG. 11B. The solid black lines in a spacetime diagram trace the trajectory of patch corners through spacetime. Shading-coded (or color-coded) surfaces track primal and dual boundaries through space time; the meaning of the various shading patterns is indicated in legend 1152. A 2D spacelike cross section through a spacetime diagram 1142 corresponds to a time-slice diagram 1144. The bulk has a regular pattern of primal and dual measurements (as seen in the various time slice diagrams of FIG. 11C), and measurements in the bulk can be inferred from the boundaries. Also shown in FIG. 11B are corner lines indicating the twist operation (applied in time slice 1144c-1) and associated dislocation of the boundary. Spacetime diagrams need not directly show the number of time slices (or the code distance) to which they correspond. Typically, though not necessarily, each change to the spatial configuration lasts for a number of time slices equal to the code distance.

For purposes of illustration, spacetime diagram 1142a shows a logical qubit that idles for a while until it is measured in the Z basis, as indicated by the corner lines and dual boundary capping off spacetime diagram 1142a. Spacetime diagram 1142b corresponds to a logical two-qubit measurement X⊗X via “lattice surgery.” Spacetime diagram 1142c corresponds to a logical qubit encoded in a rectangular patch contributing to a logical multi-qubit Pauli measurement with its Y operator. The details of these logical operations (including how the spacetime diagrams correspond to particular logical operations) are not relevant to understanding the present disclosure; those skilled in the art will be familiar with such details and techniques for constructing spacetime diagrams and time-slice diagrams.

In some embodiments for FBQC, a spacetime diagram can be translated to a fusion graph in a straightforward manner. For instance, FIG. 11D shows fusion graphs 1140a-1140c corresponding to spacetime diagrams 1142a-1142c. Fusion graphs 1140a-1140c can be generally similar to fusion graph 1100 in that both describe a cubic lattice of resource states. However, fusion graphs 1140 add additional information about the measurement operations to be performed, by assigning color or shading to certain cubic or cuboid volumes within the lattice. FIG. 11E shows a legend 1150 indicating how the shading (or color) of a cubic or cuboid volume in fusion graphs 1140a-1140c maps to a corresponding set of measurements on qubits of different resource states. Top row 1161 defines line styles representing specific two-qubit (fusion) and single-qubit measurements. Subsequent rows 1162-1166 indicate how each cubic or cuboid volume maps to a combination of fusion and single-qubit measurements. In some embodiments, each two-qubit fusion measurement (e.g., a type II fusion measurement) produces both X⊗X and Z⊗Z measurement outcomes; thus the primal and dual checks of a CBQC spacetime diagram can both correspond to the same measurement operations (and the same hardware) and combinations of outcomes, as shown in second row 1162 of legend 1150. The difference between primal and dual checks can be in how the measurement outcome data is used in decoding. Boundary checks, shown in rows 1163 and 1164 of legend 1150, correspond to half-cubes that involve a combination of fusion outcomes and two single-qubit measurements. Twists, shown in row 1165 of legend 1150, involve Y⊗Y fusion measurements (and skipping over certain lattice locations). In some implementations, the Y⊗Y fusion measurements do not require additional hardware, as they can be determined by multiplying the X⊗X and Z⊗Z fusion measurement outcomes. Dislocations, shown in row 1166 of legend 1150, skip over certain lattice locations and involve X⊗X and Z⊗Z fusion measurements.

The translation from spacetime diagram to fusion graph can be straightforward, as can be seen by comparing FIGS. 11C and 11D. The bulk of the fusion graph is filled with primal and dual bulk cubes in a 3D checkerboard pattern, and the primal and dual boundaries are decorated with primal or dual half-cubes. If twists or lattice dislocations are present, they are added using the cuboids shown in legend 1150. Slices of the fusion graph can mimic the pattern of the corresponding CBQC time slices, although the interpretation is different, as can be seen by comparing legend 1150 (FIG. 11E) and legend 1154 (in FIG. 11C). The number of cubes in the fusion graph depends on the code distance, and time slices of square patches having code distance d involve d² resource states.

Additional description related to generation of fusion graphs such as fusion graphs 1140 can be found in above-referenced WO 2021/155289 and in H. Bombin et al., “Interleaving: Modular architectures for fault-tolerant photonic quantum computing,” arXiv:2013.08612v1 [quant-ph], 15 Mar. 2021, available at https://arxiv.org/abs/2103.08612.

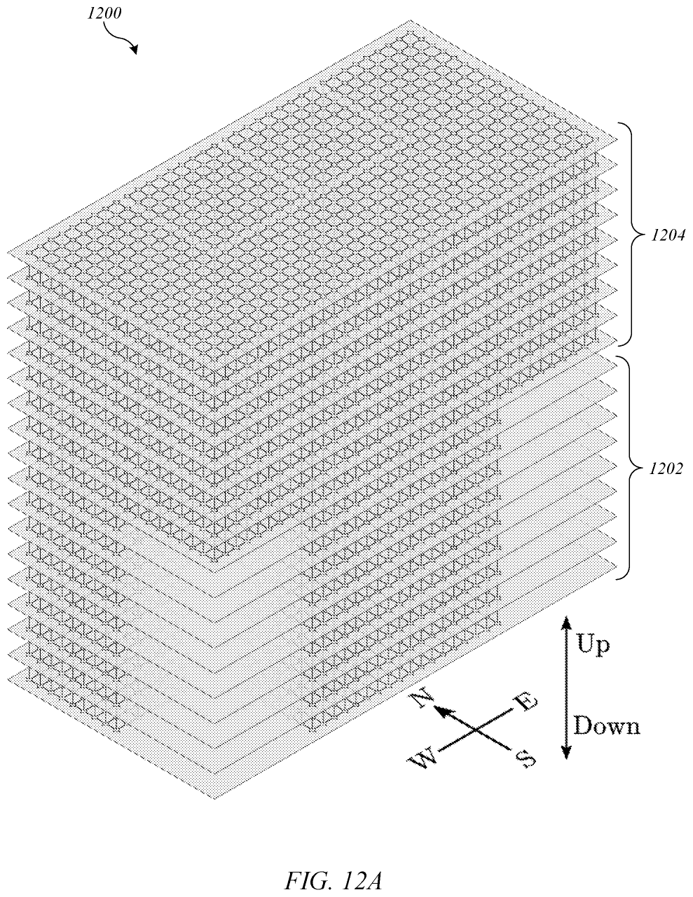

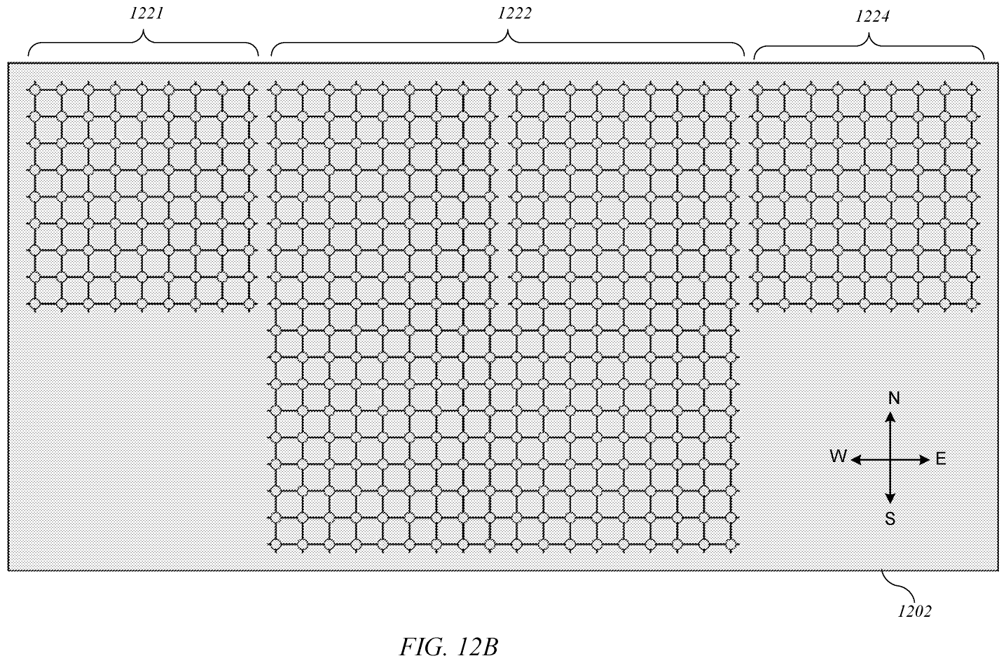

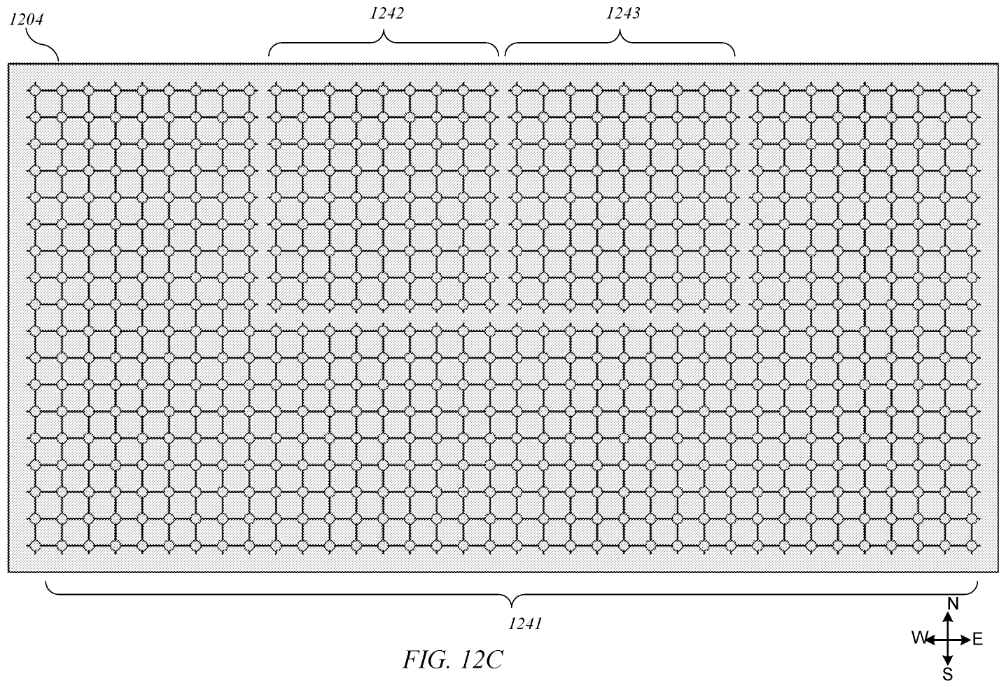

In some embodiments, fusion graphs can be “compiled” into “instructions” to perform a particular combination of fusion operations on a set of resource states. By way of example, FIGS. 12A-12C show views of a fusion graph implementing logical operations on four logical qubits (q₁, q₂, q₃, q₄) according to some embodiments. FIG. 12A shows a perspective view of fusion graph 1200, which includes a first set of nine layers 1202 and a second set of nine layers 1204. FIG. 12B shows a representative one of layers 1202, and FIG. 12C shows a representative one of layers 1204. (For simplicity of illustration, the shading pattern of FIG. 11B is not shown in FIGS. 12A-12C; the appropriate pattern of primal and dual bulk cubes and boundary half-cubes can be inferred.) In this example, the computation includes performing a first Pauli product measurement Z₂Z₃ between logical qubits q₂ and q₃, then performing a second Pauli product measurement Z₁Z₄ between logical qubits q₁ and q₄. In this example, a “code distance” (or “code size”) of 9 is assigned. The code distance is a selectable parameter relating to the size of the bulk lattice used to provide a desired error correction code, and the choice of code distance can depend on the particular hardware implementation (e.g., expected photon losses and the success rate of the particular entanglement generating circuits used) and a desired degree of fault tolerance. In this example, the number of layers associated with each logical operation corresponds to the code distance, and (as best seen in FIGS. 12B and 12C) the number of physical qubits between lattice modifications within a layer also corresponds to the code distance. The choice of code distance is not relevant to understanding the present disclosure, and embodiments described herein can support a range of code distances. Further, while this example uses cubic codes (same code distance in all three dimensions), cubic codes are not required, and the code distances along different dimensions (e.g., U-D, S-N, E-W) can be different from each other.

FIG. 12B shows a representative one of layers 1202, corresponding to the Z₂Z₃ measurement. It should be understood that all layers 1202 can have the same lattice pattern. Lattice section 1221 represents logical qubit q₁ “at rest” (i.e., not interacting with any other qubit), and lattice section 1224 represents logical qubit q₄ at rest. In this example, each logical qubit has a code distance of 9 and is represented as a 9×9 lattice in each layer. U-shaped lattice section 1222 represents the Z₂Z₃ measurement on logical qubits q₂ and q₃. As suggested by FIG. 12B, logical operations on logical qubits can entail additional resource states and fusion operations, with the number of additional resource states and fusion operations depending at least in part on the code distance.

FIG. 12C shows a representative one of layers 1204, corresponding to the Z₁Z₄ measurement. It should be understood that all layers 1204 can have the same lattice pattern. Lattice sections 1242 and 1243 represent logical qubits q₂ and q₃ at rest. U-shaped lattice section 1241 represents the Z₁Z₄ measurement on logical qubits q₁ and q₄.

FIGS. 11A-11E and 12A-12C illustrate the principle of using a prescribed combination of single-qubit measurements (on physical qubits) and fusions between (physical) qubits of different resource states to implement logical operations on logical qubits. It should be understood that fusion graphs can be agnostic to the particular implementation of physical qubits, and a computation defined by a given fusion graph can be realized in a variety of hardware systems. Some embodiments described below provide reconfigurable hardware modules for that can implement the underlying operations on physical qubits of resource states that may be specified in a fusion graph and provide measurement data that can be decoded to determine the result of the logical operations.

### 2.3.FBQC Systems

In various embodiments, FBQC can be implemented in a quantum computing system that incorporates photonic circuits or other hardware capable of generating and manipulating physical qubits (sometimes referred to as “quantum hardware”) under control of one or more classical computing systems. For instance, the quantum hardware can include circuits that generate physical qubits (e.g., photons) in prepared states and perform entangling operations to produce entangled quantum systems such as resource states. The quantum hardware can also include photonic circuits that implement entangling projective measurements (e.g., type II fusion measurements as described above) and single-qubit measurements for qubits of the resource states, along with routing circuitry that selectably directs photonic qubits to particular measurement circuits. Depending on implementation, the classical computing system can: direct the quantum hardware to generate and manipulate physical qubits; configure the quantum hardware to implement a specific logical operation or sequence of operations (sometimes referred to as a “quantum algorithm”) by performing operation-specific measurement operations on the physical qubits; receive measurement results from the quantum hardware; and/or decode or otherwise use the measurement results to determine a result of a logical operation. In some embodiments, the classical control logic can control the quantum hardware to implement operations as specified in a fusion graph of the kind described above. Specific examples of quantum computing systems capable of implementing FBQC will now be described.

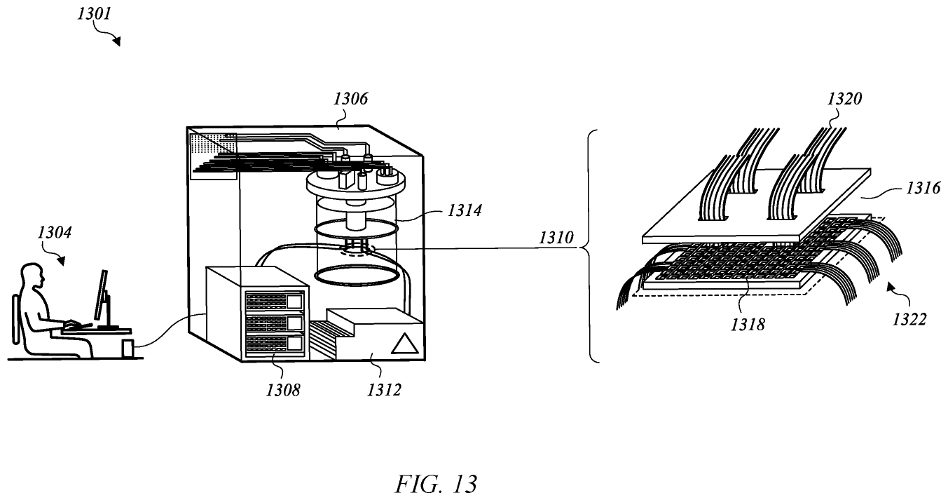

FIG. 13 shows a quantum computing environment in accordance with some embodiments. The quantum computing environment 1301 includes a user interface device 1304 that is communicatively coupled to a quantum computing (QC) system 1306, described in more detail below. The user interface device 1304 can be any type of user interface device, e.g., a terminal including a display, keyboard, mouse, touchscreen, or any other interface components. In addition, the user interface device can itself be a computer such as a personal computer (PC), laptop, tablet computer, or the like. In some embodiments, the user interface device 1304 provides an interface with which a user can interact with the QC system 1306 directly or via a local area network, wide area network, or via the internet. For example, the user interface device 1304 may run software, such as a text editor, an interactive development environment (IDE), command prompt, graphical user interface, or the like so that a user can program, or otherwise interact with, the QC subsystem to run one or more quantum algorithms. In other embodiments, the QC system 1306 may be pre-programmed and the user interface device 1304 may simply be an interface where a user can initiate a quantum computation, monitor the progress, and receive results from the QC system 1306. QC system 1306 can include a classical computing system 1308 coupled to one or more quantum computing units 1310. In some examples, the classical computing system 1308 and the quantum computing unit(s) 1310 can be coupled to other electronic components 1312, e.g., pulsed pump lasers, microwave oscillators, power supplies, networking hardware, etc. In some embodiments that require cryogenic operation, the quantum computing unit(s) 1301 or portions thereof can be housed within a cryostat, e.g., cryostat 1314. In some embodiments, a quantum computing unit 1310 can include one or more constituent chips, e.g., an integration (direct or heterogeneous) of electronic chip 1316 and integrated photonics chip 1318. Signals can be routed on- and off-chip in any number of ways, e.g., via optical interconnects 1320 and via other electronic interconnects 1322. In some embodiments, the quantum computing units 1301 may implement a fusion-based quantum computing process as described herein.

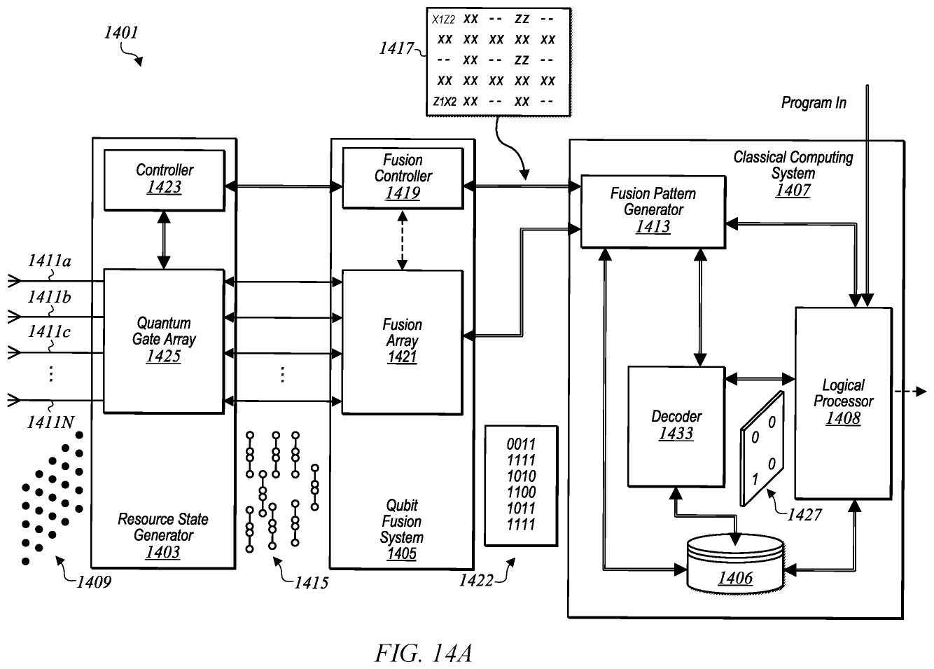

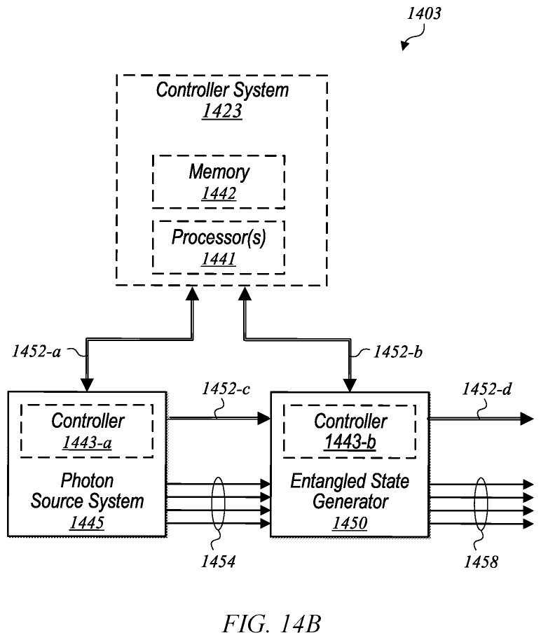

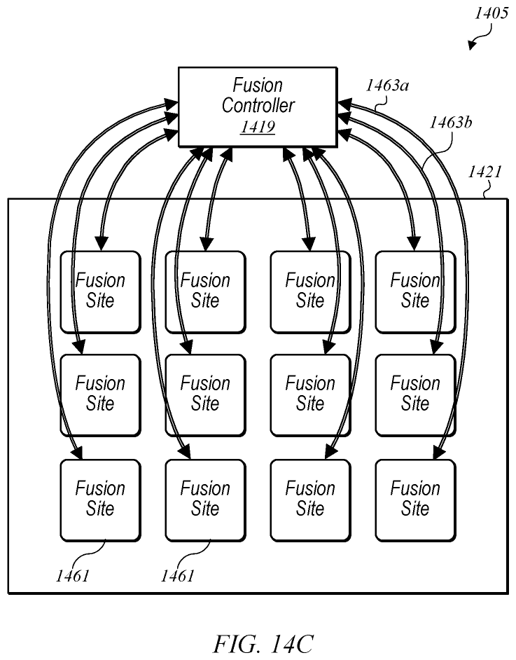

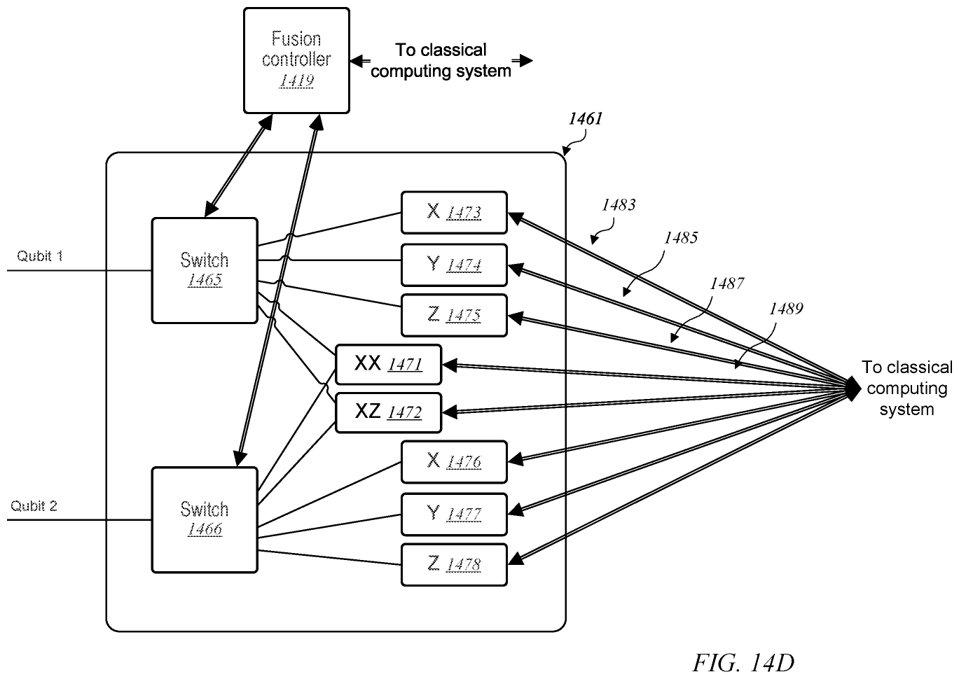

FIG. 14A-14D show block diagrams of various elements of a QC system 1401 in accordance with some embodiments. Such a system can be an implementation of the quantum computing system 13061 of FIG. 13. In FIGS. 14A-14D, solid lines represent quantum information channels and double-solid lines represent classical information channels. Referring to FIG. 14A, the QC system 1401 includes a resource state generator 1403, a qubit fusion system 1405, and a classical computing system 1407. In some embodiments, the resource state generator 1403 can take as input a collection of N physical qubits (also referred to herein as “quantum sub-systems”), e.g., physical qubits 1409 (also represented schematically as quantum inputs 1411a, 1411b, 1411c, . . . , 1411N) and can generate quantum entanglement between two or more of the physical qubits 1409 to generate resource states 1415 (also referred to herein as “quantum systems” which are themselves made up of entangled states of quantum sub-systems). For example, in the case of photonic qubits, the resource state generator 1403 can be a linear optical system such as an integrated photonic circuit that includes waveguides, beam splitters, photon detectors, delay lines, and the like. In some examples, the resource states 1415 can be relatively small entangled states of qubits (e.g., qubit entangled states having between 2 and 30 qubits). In some embodiments, the resource states can be chosen such that the fusion operations applied to certain qubits of these states results in syndrome graph data that includes the required correlations for quantum error correction. Advantageously, the system shown in FIG. 14 provides for fault tolerant quantum computation using relatively small resource states, without requiring that the resource states become mutually entangled with each other to form the typical lattice cluster state required for MBQC.

In some embodiments, the input qubits 1409 can be quantum sub-systems and/or particles, and a qubit can be formed using any qubit architecture. For example, the quantum sub-systems can be Gottesman-Kitaev-Preskill (GKP) encoded photonic qubits as described below. Other quantum sub-systems can be used to form qubits, and such sub-systems can include particles such as atoms, ions, nuclei, and/or photons. In other examples, the quantum sub-systems can be other engineered quantum sub-systems such as flux qubits, phase qubits, or charge qubits (e.g., formed from a superconducting Josephson junction), topological qubits (e.g., Majorana fermions), spin qubits formed from vacancy centers (e.g., nitrogen vacancies in diamond), or qubits otherwise encoded in multi-particle quantum systems. Furthermore, for the sake of clarity of description, the term “qubit” is used herein although the system can also employ quantum information carriers that encode information in a manner that is not necessarily associated with a binary bit. For example, qudits (i.e., quantum systems that can encode information in more than two quantum systems) can be used in accordance with some embodiments.

In accordance with some embodiments, the QC system 1401 can be a fusion-based quantum computer that can run one or more quantum algorithms or software programs. For example, a software program (e.g., a set of machine-readable instructions) that represents the quantum algorithm to be run on the QC system 1401 can be passed to a classical computing system 1407 (e.g., corresponding to system 1308 in FIG. 13 above). The classical computing system 1407 can be any type of computing device such as a PC, one or more blade servers, a high-performance computing system such as a supercomputer, server farm, or the like. Such a system can include one or more processors (not shown) coupled to one or more computer memories, e.g., memory 1406. Such a computing system will be referred to herein as a “classical computer.” In some examples, the logical processor 1408 (which can be implemented using one or more microprocessors and/or other classical digital logic circuits) can take the software program as input and compute the corresponding set of logical gates (or measurement operations) to be applied to run the software program on the particular hardware available within the QC system 1401. For instance, the software program may include coded defining a fusion graph, from which logical processor 1408 can extract a set of measurement operations to be performed on particular qubits of particular resource states. In some embodiments, the software program can be received by another module, or by more than one module, e.g., by the fusion pattern generator 1413. In some embodiments, the fusion pattern generator 1413 can generate a set of machine-level fusion instructions, e.g., a set of fusion operations and/or single qubit measurements to be applied across the physical qubits that make up the QC system 1401. As such, the logical processor 1408 and fusion pattern generator 1413 are able to receive the input software program (which may originate as high-level code that can be more easily written by a user to program the quantum computer) and to generate a set of machine readable instructions to be applied to the low level quantum hardware.

In some embodiments, the fusion pattern generator 1413 (alone or in combination with the logical processor 1408) can operate as a compiler for software programs to be run on the quantum computer. Fusion pattern generator 1413 can be implemented as pure hardware, pure software, or any combination of one or more hardware or software components or modules. In various embodiments, fusion pattern generator 1413 can operate at runtime or in advance; in either case, machine-level instructions generated by fusion pattern generator 1413 can be stored (e.g., in memory 1406). In some examples, the compiled machine-level instructions take the form of one or more data frames (e.g., fusion pattern data from 1417) that instruct the qubit fusion system 1405 to make, at a given clock cycle of the quantum computer, one or more fusions between certain qubits from the separate (i.e., unentangled) resource states 1415. In some embodiments, several fusion pattern data frames 1417 can be stored in memory 1406 as classical data.

Fusion pattern data frame 1417 is one example of a set of fusion measurements that should be applied between certain pairs of qubits from different entangled resource states 1415 during a certain clock cycle as a program is executed. In this example, fusion pattern data frame 1417 can indicate the type of measurement (e.g., two single-qubit measurements or a two-qubit joint measurement) that is to be applied for a particular fusion site within the fusion array 1421 of the qubit fusion system 1405. For instance, the fusion pattern data frames 1417 can indicate that a measurement is to be performed in a particular basis. In the case of single-qubit measurements, a basis can be specified for each measurement (e.g., X1Z2 can mean measuring qubit 1 in the Pauli X basis and qubit 2 in the Pauli Z basis). For a two-qubit joint measurement, a basis can be specified, e.g., as an XX fusion, XY fusion, etc. As used herein, the terms “XX fusion,” “YY fusion,” “XY fusion,” etc. refer to a fusion operation that applies a particular a two-particle projective measurement, e.g., a Bell projection that, depending on the Bell basis chosen (specified as XX, YY, XY, ZZ, etc.), can project the two qubits onto a particular Bell state. Such projective measurements may produce two measurement outcomes (also referred to herein as joint measurement outcome data) that correspond to the eigenvalues of the corresponding pair of observables that are measured in the chosen basis. For example, XX fusion is a Bell projection that measures the XX and ZZ observables (each of which could have a +1 or −1 eigenvalue—or 0 or 1 depending on the convention used), and XZ Fusion is a Bell projection that measures the XZ and ZX observables, and so on. In some embodiments, Bell projections can be implemented using the type II fusion circuit 900 described above with reference to FIGS. 9A-9B. To select the measurement basis (XX, XY, etc.), a phase rotation can be applied to one or both of the qubits prior to the qubits entering fusion circuit 900. Fusion circuit 900 can be used for dual-rail-encoded qubits. One of ordinary skill will appreciate that in a linear optical system, type II fusion may be a non-deterministic process. In systems using other qubit architectures (e.g., GKP qubit architectures as described below), other projective measurement circuits can be used, and Bell measurements can be deterministic.

Referring again to FIG. 14A, fusion network controller circuit 1419 of the qubit fusion system 1405 can receive the fusion pattern data frames 1417 and, based on the specified fusion pattern, can generate configuration signals, e.g., analog and/or digital electronic signals, that drive the hardware within the fusion array 1421. For example, for the case of photonic qubits, the fusion array 1421 can include photon detectors coupled to one or more waveguides, beam splitters, interferometers, switches, polarizers, polarization rotators, or the like. More generally, the fusion array can include any detector that can detect the quantum states of one or more of the qubits in the resource states 1415. One of ordinary skill will appreciate that many types of detectors may be used depending on the particular qubit architecture being employed.

In some embodiments, the result of applying the fusion pattern data frames 1417 to the fusion array 1421 is the generation of classical data (measurement outcomes from the detectors in fusion array 1421) that is read out, optionally pre-processed, and sent to fusion pattern generator 1413 and/or decoder 1433, either directly (not shown) or via any other module. More specifically, the fusion array 1421 can include a collection of measuring devices that implement single-qubit measurements and joint measurements (also referred to as “entangling projective measurements”) on qubits from two (or more) different resource states and generate a collection of measurement outcomes associated with the joint measurement. These measurement outcomes (also referred to herein as joint measurement outcome data) can be stored in a measurement outcome data frame, e.g., data frame 1422 and passed back to the classical computing system 1407 for further processing. In some embodiments, passing the measurement outcome data frame 1422 directly to the fusion pattern generator 1413 can enable a rapid adaptive feed-forward process that allows the system to alter the fusion pattern data frames 1417 in a future clock cycle (e.g., altering the choice of basis or choice of single particle measurement) based on the measurement outcome data collected in a previous clock cycle.

In some embodiments, any of the control modules in the QC system 1401, e.g., controller 1423, fusion network controller 1419, fusion pattern generator 1413, decoder 1423, and logical processor 1408 can include any number of classical computing components such as processors (CPUs, GPUs, TPUs) memory (any form of RAM, ROM), hard coded logic components (classical logic gates such as AND, OR, XOR, etc.) and/or programmable logic components such as field programmable gate arrays (FPGAs and the like). These modules can also include any number of application specific integrated circuits (ASICs), microcontrollers (MCUs), systems on a chip (SOCs), and other similar microelectronics. While FIG. 14A shows specific modules that exchange data, signals, and messaged to perform functions as described above, one of ordinary skill will appreciate that the particular arrangement of modules shown here is but one example and many different examples are possible without departing from the scope of the present disclosure. For example, the compilation, feed-forward functionality, etc., described above can be shared among modules.

In some embodiments, the entangled resource states 1415 can be any type of entangled resource state, that, when the fusion operations are performed, produces measurement outcome data frames that include the necessary correlations for performing fault tolerant quantum computation. While FIG. 14A shows an example of a collection of identical resource states, a system can be employed that generates different types of resource states and can even dynamically change the type of resource state being generated based on the demands of the quantum algorithm being run. As described herein, the logical qubit measurement outcomes 1427 can be fault-tolerantly recovered, e.g., via decoder 1433, from the measurement outcomes 1422 of the physical qubits. Logical processor 1408 can then process the logical outcomes as part of the running of the program. As shown, the logical processor can feed forward information to the fusion pattern generator 1413 to affect downstream gates and/or measurements to ensure that the computation proceeds fault-tolerantly.

FIG. 14B illustrates an example architecture of a resource state generator 1403 in accordance with some embodiments. A resource state generator 1403 can be used to generate qubits (e.g., photons) in an entangled state (e.g., any of the resource states used in examples herein). Resource state generator 1403 can be used as a component of a quantum computing system (e.g., quantum computing system 1401) or in any other system where generation of entangled multi-qubit quantum systems is desired. In an illustrative photonic architecture, resource state generator 1403 can include a photon source system 1445 that is optically connected to an entangled state generator 1450 by one or more waveguides 1454. Both the photon source system 1445 and the entangled state generator 1450 may be coupled to a classical controller system 1423 such that the classical controller system 1423 can communicate with and/or control (e.g., via the classical information channels 1452a-b) the photon source system 1445 and/or the entangled state generator 1450. Photon source system 1445 may include a collection of single-photon sources that can provide output photonic states (e.g., single photons or other photonic states such as Bell states, GHZ states, and the like) to entangled state generator 1450 by way of interconnecting waveguides 1454. Entangled state generator 1450 may receive the photonic states and convert them to one or more entangled photonic states (or larger entangled photonic states in the case that photon source system 1445 itself outputs an entangled photonic state) and then output these entangled photonic states into output waveguides 1458. In various embodiments, photon source system 1445 and entangled state generator 1450 can include quantum photonic circuits such as optical circuits, electrical circuits, or any other types of circuits.

In some embodiments, output waveguides 1458 can be coupled to a downstream circuit that may use the entangled states for performing a quantum computation. For example, the entangled states generated by the entangled state generator 1450 may be used as resource states for qubit fusion system 1405 as shown in FIG. 14A. In some embodiments, classical controller system 1423 can be implemented in the same computer hardware that implements classical computing system 1407 of FIG. 14A

In some embodiments, resource state generator 1403 may include classical communication paths (e.g., communication paths 1452-a through 1452-d) for interconnecting and providing classical information between components. It should be noted that classical channels 1452-a through 1452-d need not all be the same. For example, classical channel 1452-a through 1452-c may comprise a bi-directional communication bus carrying one or more reference signals, e.g., one or more clock signals, one or more control signals, or any other signal that carries classical information, e.g., heralding signals, photon detector readout signals, or the like.

In some embodiments, controller system 1423 communicates with and/or controls the photon source system 1445 and/or the entangled state generator 1450. For example, in some embodiments, controller system 1423 can be used to configure one or more circuits, e.g., using a system clock that may be provided to photon sources 1445 and entangled state generator 1450. In some embodiments, controller system 1423 includes memory 1442, one or more processor(s) 1441, a power supply, an input/output (I/O) subsystem, and a communication bus or other communication fabric interconnecting these components. The processor(s) 1441 may execute software modules, programs, and/or instructions stored in memory 1442 and thereby perform processing operations. In some embodiments where resource state generator 1403 is part of a quantum computing system (e.g., quantum computing system 1401 of FIG. 14A), some or all of the computer hardware implementing controller 1423 can be the same hardware that implements classical computing system 1407.

In some embodiments, memory 1442 stores one or more programs (e.g., sets of instructions) and/or data structures. For example, in some embodiments, entangled state generator 1450 can attempt to produce an entangled state over successive stages and/or over independent instances, any one of which may or may not be successful in producing an entangled state. In some embodiments, memory 1442 stores one or more programs for determining whether a particular or instance stage was successful and configuring photon source system 1445 and/or entangled state generator 1450 accordingly (e.g., by configuring entangled state generator 1450 to switch the photons to an output if the stage was successful, or pass the photons to the next stage of the entangled state generator 1450 if the stage was not yet successful). To that end, in some embodiments, memory 1442 can store detection patterns from which the controller system 1423 may determine whether a stage was successful. In addition, memory 1442 can store settings that are provided to the various configurable components (e.g., optical switches) that are configured by, e.g., setting one or more phase shifts for the component.

In some embodiments, some or all of the above-described functions may be implemented with hardware circuits on or within photon source system 1445 and/or entangled state generator 1450. For example, in some embodiments, photon source system 1445 includes one or more controllers 1443-a (e.g., logic controllers) (e.g., which may comprise field programmable gate arrays (FPGAs), application specific integrated circuits (ASICS), a “system on a chip” that includes classical processors and memory, or the like). In some embodiments, controller 1443-a determines whether photon source system 1445 was successful (e.g., for a given attempt on a given clock cycle) and outputs a reference signal indicating whether photon source system 1445 was successful. For example, in some embodiments, controller 1443-a outputs a logical high value to classical channel 1452-a and/or classical channel 1452-c when photon source system 1445 is successful and outputs a logical low value to classical channel 1452-a and/or classical channel 1452-c when photon source system 1445 is not successful. In some embodiments, the output of controller 1443-a may be used to configure hardware in controller 1443-b.

Similarly, in some embodiments, entangled state generator 1450 includes one or more controllers 1443-b (e.g., logical controllers) (e.g., which may comprise field programmable gate arrays (FPGAs), application specific integrated circuits (ASICS), or the like) that determine whether a respective stage of entangled state generator 1450 has succeeded, perform the switching logic described above, and output a reference signal to classical channels 1452-b and/or 1452-d to inform other components as to whether the entangled state generator 1450 has succeeded.

In some embodiments, a system clock signal can be provided to photon source system 1445 and entangled state generator 1450 via an external source (not shown) or by classical computing system 403 via classical channels 1452-a and/or 1452-b. Examples of clock generators that may be used are described in U.S. Pat. No. 10,379,420, but other clock generators may also be used without departing from the scope of the present disclosure. In some embodiments, the system clock signal provided to photon source system 1445 triggers photon source system 1445 to attempt to output one photon per waveguide. In some embodiments, the system clock signal provided to entangled state generator 1450 triggers, or gates, sets of detectors in entangled state generator 1450 to attempt to detect photons. For example, in some embodiments, triggering a set of detectors in entangled state generator 1450 to attempt to detect photons includes gating the set of detectors.

It should be noted that, in some embodiments, photon source system 1445 and entangled state generator 1450 may have internal clocks. For example, photon source system 1445 may have an internal clock generated and/or used by controller 1443-a and entangled state generator 1450 has an internal clock generated and/or used by controller 1443-b. In some embodiments, the internal clock of photon source system 1445 and/or entangled state generator 1450 is synchronized to an external clock (e.g., the system clock provided by classical computer system 403) (e.g., through a phase-locked loop). In some embodiments, any of the internal clocks may themselves be used as the system clock, e.g., an internal clock of the photon source may be distributed to other components in the system and used as the master/system clock.

In some embodiments, photon source system 1445 includes a plurality of probabilistic photon sources that may be spatially and/or temporally multiplexed, i.e., a so-called multiplexed single photon source. In one example of such a source, the source is driven by a pump, e.g., a light pulse, that is coupled into an optical resonator that, through some nonlinear process (e.g., spontaneous four wave mixing, second harmonic generation, and the like) may generate zero, one, or more photons. As used herein, the term “attempt” is used to refer to the act of driving a photon source with some sort of driving signal, e.g., a pump pulse, that may produce output photons non-deterministically (i.e., in response to the driving signal, the probability that the photon source will generate one or more photons may be less than 1). In some embodiments, a particular photon source may be most likely to, on any given attempt, produce zero photons (e.g., there may be a 90% probability of producing zero photons per attempt to produce a single-photon). The second most likely result for an attempt may be production of a single-photon (e.g., there may be a 9% probability of producing a single-photon per attempt to produce a single-photon). The third most likely result for an attempt may be production of two photons (e.g., there may be an approximately 1% probability of producing two photons per attempt to produce a single photon). In some circumstances, there may be less than a 1% probability of producing more than two photons.

In some embodiments, the apparent efficiency of the photon sources may be increased by using a plurality of single-photon sources and multiplexing the outputs of the plurality of photon sources. In some embodiments, the photon source can also produce a classical herald signal that announces (or heralds) the success of the generation. In some embodiments, this classical signal is obtained from the output of a detector, where the photon source system always produces photon states in pairs (such as in SPDC), and detection of one photon signal is used to herald the success of the process. This herald signal can be provided to a multiplexer and used to properly route a successful generation to a multiplexer output port, as described in more detail below.

The precise type of photon source used is not critical and any type of source can be used, employing any photon generating process, such as spontaneous four wave mixing (SPFW), spontaneous parametric down-conversion (SPDC), or any other process. Other classes of sources that do not necessarily require a nonlinear material can also be employed, such as those that employ atomic and/or artificial atomic systems, e.g., quantum dot sources, color centers in crystals, and the like. In some cases, sources may or may be coupled to photonic cavities, e.g., as can be the case for artificial atomic systems such as quantum dots coupled to cavities. Other types of photon sources also exist for SPWM and SPDC, such as optomechanical systems and the like. In some examples the photon sources can emit multiple photons already in an entangled state in which case the entangled state generator 1450 may not be necessary, or alternatively entangled state generator 1450 may take the entangled states as input and generate even larger entangled states.

In some embodiments, spatial multiplexing of several non-deterministic photon sources (also referred to as a MUX photon source) can be employed. Many different spatial MUX architectures are possible without departing from the scope of the present disclosure. Temporal MUXing can also be implemented instead of or in combination with spatial multiplexing. MUX schemes that employ log-tree, generalized Mach-Zehnder interferometers, multimode interferometers, chained sources, chained sources with dump-the-pump schemes, asymmetric multi-crystal single photon sources, or any other type of MUX architecture can be used. In some embodiments, the photon source can employ a MUX scheme with quantum feedback control and the like. One example of an n×m MUXed source is disclosed in U.S. Pat. No. 10,677,985.

While FIG. 14B depicts a particular architecture for a resource state generator, one of ordinary skill will appreciate that any resource state generator could be used without departing from the scope of the present disclosure. Additional examples of resource state generators can be found in US Pat. App. Pub. No. 2020/0287631, titled “Generation of entangled qubit states,” and U.S. Pat. No. 11,126,062, titled “GENERATION OF ENTANGLED PHOTONIC STATES.” For example, in some embodiments, rather than generating single photons, the photon sources may generate entangled resource states directly, or may even generate smaller entangled states that can undergo additional entangling operations at the entangled state generator 1450 to produce the final resource states to be used for FBQC. As such, as used herein the scope of the term “photon source” is intended to include at least sources of single photons, sources of multiple photons in entangled states, or more generally any source of photonic states.

FIG. 14C shows one example of qubit fusion system 1405 in accordance with some embodiments. In some embodiments, qubit fusion system 1405 can be employed within a larger quantum computing system, e.g., as shown in FIG. 14A.

Qubit fusion system 1405 includes a fusion controller 1419 that is coupled to fusion array 1421. Fusion array 1421 includes a collection of fusion sites 1461 that each receive two or more qubits from different resource states (which can be produced by resource state generator 1403 or other resource state generators) and perform one or more fusion operations on selected qubits from the two or more resource states and/or perform single-particle measurements on some or all of the received qubits. In some embodiments, the combination of measurements performed by fusion sites 1461 can be selected to implement fault-tolerant computations on logical qubits, e.g., as described above. The measurement operations performed on the qubits can be controlled by the fusion controller 1419 via classical signals that are sent from the fusion controller 1419 to each of the fusion sites via control channels 1463a, 1463b, etc. Based on the measurements performed at each fusion site 1461, measurement outcomes in the form of classical data are output and then provided to a decoder system, as shown and described above with reference to FIG. 14A. In some embodiments, the measurement outcome data from each fusion site can be provided to fusion controller 1419, which can perform decoding operations and/or provide the measurement outcome data to decoder 14333 as described above.

FIG. 14D shows an example of a fusion site 1461 (one of many that make up a fusion array 1421) as configured to operate with a fusion controller 1419 to provide measurement outcomes to a decoder system for fault tolerant quantum computation in accordance with some embodiments. In this example, fusion site 1461 can be an element of fusion array 1421 (shown in FIGS. 14A and 14C), and although only one instance is shown for purposes of illustration, fusion array 1421 can include any number of instances of fusion site 1461. In some embodiments, logic can be implemented by selectively performing different measurements on different qubits. For instance, as described above, boundaries or other topological features in the bulk of a fusion network (or lattice) can be implemented by changing the measurement basis of the fusion or by choosing a single qubit measurement instead of a fusion. To allow logic to be implemented, at least some (and possibly all) of the fusion sites can be reconfigurable fusion circuits as shown in FIG. 14D.

In the example shown in FIG. 14D, fusion site 1461 can receive two qubits (Qubit 1 and Qubit 2) that are to be measured according to the quantum application being run. Qubit 1 is one qubit that is entangled with one or more other qubits (not shown) as part of a first resource state, and Qubit 2 is another qubit that is entangled with one or more other qubits (not shown) as part of a second resource state. As described above, none of the qubits from the first resource state need be entangled with any of the qubits from the second (or any other) resource state in order to facilitate a fault-tolerant quantum computation. Also advantageously, at the inputs of a fusion site 1461, the collection of resource states from which Qubit 1 and Qubit 2 are provided are not mutually entangled to form a cluster state that takes the form of a quantum error correcting code and thus there is no need to store and or maintain a large cluster state with long-range entanglement across the entire cluster state. Also advantageously, in some embodiments, the fusion operations that take place at fusion sites 1461 can be fully destructive single-qubit or joint measurements on Qubit 1 and Qubit 2 such that all that is left after the measurement is classical information representing the measurement outcomes on the detectors, e.g., measurement outcomes 1483, 1485, 1487, 1489, etc. At this point, the classical information is all that is needed for the decoder 1433 to perform quantum error correction, and no further quantum information is propagated through the system. This can be contrasted with an MBQC system that might employ fusion sites to fuse resource states into a cluster state that itself serves as the topological code and only then generates the required classical information via single particle measurements on each qubit in the large cluster state. In such an MBQC system, not only does the large cluster state need to be stored and maintained in the system before the single particle measurements are made, but an extra single particle measurement system must be present (in addition to the fusion system used to generate the cluster state) to receive every qubit of the cluster state and perform the single requisite particle measurements in order to generate the classical information required to compute the syndrome graph data required for the decoder to perform quantum error correction.

FIG. 14D shows an illustrative example of a reconfigurable fusion circuit, which is one way to implement a fusion site 1461 as part of a fusion based quantum computer architecture. Qubit 1 and Qubit 2 can be coupled to switches 1465 and 1466, respectively. In some embodiments, the coupling can be waveguides and the switches 1465 and 1466 can be photonic switches that are controlled by fusion controller 1419. The various output paths of switches 1465, 1466 can be coupled to different qubit measuring devices 1471-1478 that implement different types of measurements. For example, single qubit measuring device 1473 (1476) can implement a measurement of the state of qubit 1 (qubit 2) in the X basis, single qubit measuring device 1474 (1477) can implement a measurement of the state of qubit 1 (qubit 2) the Y basis, and single qubit measuring device 1475 (1478) can implement a measurement of the state of qubit 1 (qubit 2) in the Z basis. Likewise, two-qubit measuring devices 1471 and 1472 can implement different types of two-qubit measurement, e.g., the projective Bell measurements. For instance, two-qubit measuring devices 1471 and 1472 can each be an instance of type II fusion circuit 900 described above, with appropriate phase rotations to implement the desired Bell basis. For example, measuring device 1471 can implement an XX fusion and measuring device 1472 can implement an XZ fusion. In some embodiments the state of the switches 1465 and 1466 can be hard-coded within the fusion network controller 1419, or in some embodiments the state of the switches 1465 and 1466 can be chosen based upon external inputs, e.g., instructions provided by the fusion pattern generator 1413 depending on the needs of the algorithm being run. The layout shown in FIG. 14D is illustrative and any number and combination of switches and single-qubit and/or multi-qubit measurement devices can be employed without departing from the scope of the present disclosure.

In some embodiments, e.g., linear optical implementation, fusion can be a probabilistic (or non-deterministic) operation, i.e., the Bell measurement sometimes succeeds and sometime fails. In some embodiments, the success probability of such operations can be increased by using extra quantum systems in addition to those onto which the operation is acting upon. Embodiments using extra quantum systems are usually referred to as “boosted” fusion. In the example shown in FIG. 14D, the fusion site implements an unboosted Type II fusion operation on the incoming qubits. One of ordinary skill will appreciate that any type of fusion operation can be applied (including boosted or unboosted fusion operations) without departing from the scope of the present disclosure. For instance, in examples described below using GKP qubits, the fusion operations can be deterministic.

In some embodiments the fusion network controller 1419 can also provide a control signal to the measurement devices 1473, 1474, 1475, 1471, 1472, 1476, 1477, 1478, etc. A control signal can be used, e.g., for gating the measurement hardware (e.g., photon detectors) or for otherwise controlling the operation of the hardware. Each of the measurement devices provides measurement outcome signals (1483, 1485, 1487, 1489, etc.). In some embodiments, the measurement outcome signals can be preprocessed at the fusion site 1461 to determine a measurement outcome (e.g., fusion success or not, which eigenvalue is measured, how many photons are detected, or the like) that can be passed to decoder 1433 for further processing. In addition or instead, the measurement outcomes can be passed directly to the decoder 1433 for further processing.

The quantum computing system shown in FIGS. 13 and 14A-14D is illustrative and can be modified. The resource states can be realized using a variety of physical quantum systems, including photonic qubits using various encodings. By way of example, an implementation of FBQC using photonic GKP qubits will now be described.

### 3. FBQC Using GKP-Encoded Qubits

In some examples described above, physical qubits are implemented using dual-rail-encoded photonic qubits, with the state of the (physical) qubit corresponding to which of a pair of waveguides is occupied by a photon at a given time. Other implementations of physical qubits are also possible. In some embodiments, the physical qubits can have Gottesman-Kitaev-Preskill (“GKP”) encoding, and the term “GKP qubit” (or “GKP-encoded qubit”) is used herein to refer to a physical qubit having GKP encoding. GKP qubits can be instantiated, for instance, using light-squeezing techniques to prepare light (e.g., a light pulse or wave packet) in an appropriate state, referred to as a GKP state. Photonic GKP qubits can be propagated through waveguides, interfered using beam splitters and phase shifters (which can be implemented using techniques described above) to create entangled multi-qubit quantum systems, and measured using homodyne measurements as described below. A suitable combination of circuits can be used to implement quantum-hardware components of an FBQC system. For instance, components such as resource state generators 1403 and fusion array 1421 of FIG. 14A can be implemented. Examples of GKP qubits will be described, followed by examples of circuits and techniques for making single-qubit Pauli measurements and performing fusion operations on GKP qubits. Examples of fusion networks and quantum computer systems for GKP qubits will then be described.

### 3.1.GKP Qubits and States

The theory of GKP encoding of qubits is well understood and will be briefly reviewed to establish certain terminology. GKP encoding can be realized in a physical system that exhibits oscillatory behavior, such as an electromagnetic mode. Photons propagating in waveguides provide one example of a physical system in which GKP encoding can be applied. The oscillator has conjugate observables q and p (such as position and momentum) defined such that [q, p]=i. The GKP encoding of a qubit has the following logical operators:

$$\overline{X} = exp ( - i \sqrt{π} p ) \overline{Z} = exp ( i \sqrt{π} q ) \qquad ( 17 )$$

These operators act on the full oscillator Hilbert space and are unitary but not Hermitian. They correspond to a specific co-set representative for the logical operator in the usual qubit stabilizer theory. Given that

$${e}^{A} {e}^{B} = {e}^{[ A , B ]} {e}^{B} {e}^{A} \qquad ( 18 )$$

it follows that:

$$\overline{X} \overline{Z} = \overline{Z} \overline{X} \qquad ( 19 )$$

as is expected for qubit logical operators. This identity amounts to saying that the Hilbert space breaks up into a tensor product where one factor of the tensor product is an encoded qubit. The other factor corresponds to gauge qubits in the usual stabilizer theory, and operations performed on such qubits are not of interest in the present context. Of greater interest is a set of unitary but not Hermitian stabilizers whose joint +1 eigenspace defines the codespace. The action of the logical operators on this codespace will be Hermitian as well as unitary because the codespace corresponds to a qubit. The stabilizer subspace corresponds to the simultaneous +1 eigenspace of the following two operators:

$${S}_{q} = exp ( i 2 \sqrt{π} q ) {S}_{p} = exp ( - i \sqrt{π} p ) \qquad ( 20 )$$

The operators of Eq. (20) do not have normalizable eigenstates, so every physical state has some leakage from this subspace. However, because the system is used as a type of gauge code, this leakage is of little concern.

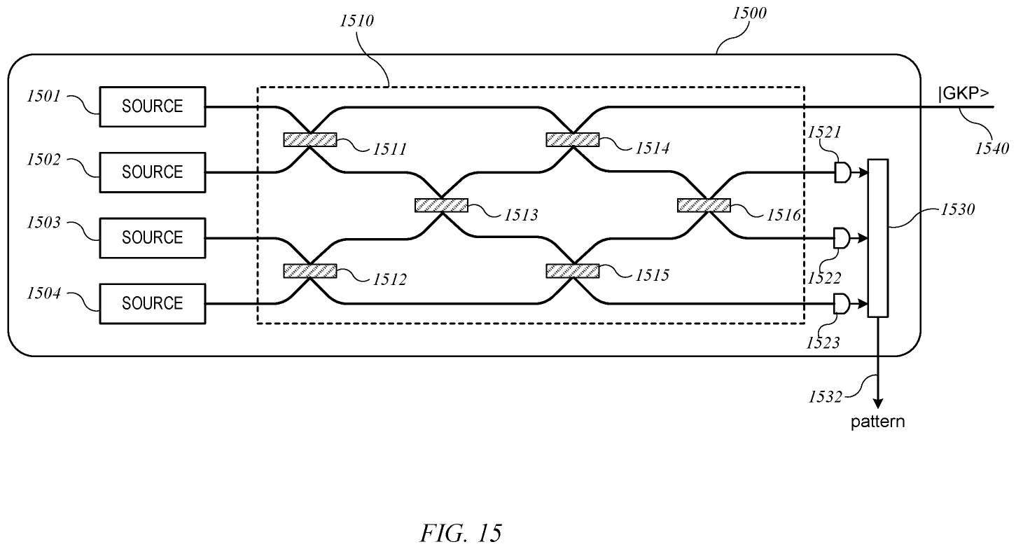

GKP qubits can be realized using a variety of physical systems. In some embodiments, a GKP qubit can be realized using a light pulse (e.g., a photon or wave packet) or other light wave propagating in a waveguide. FIG. 15 shows a simplified schematic diagram of an optical circuit 1500 for generating a GKP qubit that can be used in some embodiments. Optical circuit 1500 includes a set of light sources 1501-1504, a network 1510 of beam splitters 1511-1516, photon-number-resolving (PNR) detectors 1521-1523, and a classical logic circuit 1530. Each light source 1501-1504 can be a light source that produces squeezed light. (“Squeezed light” is a term of art in quantum optics, referring to a state in which the light has electric field strength, for at least some phases, with quantum uncertainty smaller than that of a coherent state.) For example, each light source 1501-1504 can include a pump laser and a nonlinear crystal with mirrors arranged to form an optical resonator that produces a displaced squeezed vacuum state through spontaneous parametric down-conversion. Other processes for producing squeezed light can also be used. Beam splitters 1511-1516, which can be 50/50 beam splitters implemented using techniques described above, can be arranged to provide an interferometer for the outputs of light sources 1501-1504 that results in a GKP state on output path 1540. Output path 1540 can be, e.g., an optical fiber or other waveguide. PNR detectors 1521-1523 can be any type of photodetector capable of counting the number of photons incident therein. Examples of suitable photodetectors include transition-edge sensors, photomultiplier tubes, single photon avalanche diodes (SPADs), superconducting nanowire-based PNR detectors, and so on.

In operation, sources 1501-1504 can be operated to produce squeezed light (e.g., single photons in a squeezed state), which can propagate along the waveguides through beam splitters 1511-1516. Each PNR photodetector 1521-1523 can be coupled to a different output path of beam splitter network 1510 and can produce an output signal indicating the number of photons detected. These output signals can be received by classical logic circuit 1530. Generation of a GKP state on output path 1540 is a non-deterministic process. Based on the combination (pattern) of detector-output signals received, classical logic circuit 1530 can determine whether the output on optical path 1540 corresponds to a GKP state or not. Classical logic circuit 1530 can output a classical logic signal on an output path 1532 (which can be, e.g., a digital electronic signal path) indicating whether circuit 1500 succeeded in producing a GKP state. Depending on implementation, the classical logic signal can include the pattern of photons detected (e.g., the number of photons counted by each of detectors 1521-1523) and/or a binary signal indicating whether production of a GKP state succeeded.

Circuit 1500 is just one example of a circuit that can be used to produce a photonic GKP qubit. Similar circuits can be constructed with any number of sources, beam splitters, and detectors; in general, if there are N sources, there would be N−1 detectors. Using a larger number of sources can improve the quality of the GKP state.

### 3.2.Operations on GKP Qubits

For use in quantum computing (e.g., FBQC) and other applications, certain operations on GKP qubits are desirable, including single-qubit Pauli measurements, generation of entangled states, and entangling projective measurements (fusion operations). Examples of circuits implementing specific operations will now be described.

### 3.2.1. Pauli Measurements

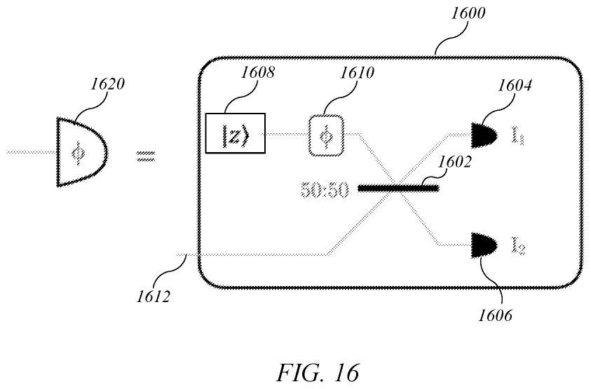

In some embodiments, homodyne measurements can be used to make Pauli measurements (or measurements in other rotated bases) on GKP qubits. FIG. 16 shows a simplified schematic diagram of an optical circuit 1600 for homodyne measurement of a GKP qubit that can be used in some embodiments. Optical circuit 1600 includes a 50/50 beam splitter 1602; a pair of intensity detectors 1604, 1606; a coherent state generator 1608; and a phase-shift circuit 1610. In subsequent schematic diagrams, circuit symbol 1620 is used to represent a homodyne measurement circuit such as optical circuit 1600.

In operation, light in a coherent state, denoted |z [symbol] , is produced in coherent state generator 1608. For a homodyne measurement, the coherent state |z [symbol] has the same central frequency as the GKP qubit being measured and can be (but need not be) produced using the same physical source that generates the GKP qubit. The GKP qubit to be measured is received as a signal on an input path 1612. Phase-shift circuit 1610 applies a phase-shift (ϕ) to the coherent state, with the particular value of ϕ determining the axis in phase space along which the measurement is made. Depending on implementation, ϕ can be fixed or selectable. The GKP qubit and the coherent state |z [symbol] interfere in 50/50 beam splitter 1602, producing two outputs. Each output is measured by one of intensity detectors 1604, 1606, which output respective intensity measurements I₁ and I₂. The measurement outcome (A) is given by:

$$A = \frac{{I}_{1} - {I}_{2}}{\vert z \vert} , \qquad ( 21 )$$

where |z| is the intensity of the coherent state |z [symbol] . Depending on implementation, measurement outcome A can be computed using classical analog or digital electronic circuitry, which can be implemented in the same photonic device in which circuit 1600 or in a separate device that receives electronic signals (which can be analog or digital signals representing I₁ and I₂) from detectors 1604 and 1606. In some embodiments, a single-qubit measurement in the Pauli X, Y, or Z basis can be implemented using a homodyne measurement circuit such as optical circuit 1600 with an appropriate choice of ϕ.

A measurement made by optical circuit 1600 can be modeled as an ideal measurement of one of the conjugate observables (e.g., observable q as defined above) with some additive Gaussian noise σ_{q}. In some embodiments, if ϕ=0, then the measurement outcome A corresponds to:

$$A = q + {σ}_{q} , \qquad ( 22 )$$

where, for each measurement, σ_{q} is randomly drawn from a Gaussian distribution with mean 0 and variance Δₕₒₘ. (The variance is due to imperfections in the system and goes to zero in the limit of ideal detectors.)

As a more specific example, Z̅ can be measured by measuring q and computing the operator Z̅ according to Eq. (17). In the code space, an outcome such that q=n\sqrt{π} for some integer n would be expected. However, due to imperfections in preparing the initial GKP state and in the detectors (represented as Δₕₒₘ), the result is typically not an exact integer multiple of \sqrt{π}. In some embodiments, a tolerance limit δ can be established, and measurement outcomes are accepted if they are within δ of an integer multiple of \sqrt{π}. Outcomes outside this range can be attributed to leakage and treated as invalid results (e.g., failure of measurement or qubit erasure). Fault-tolerant methods can, by design, account for erasures and failures of measurements.

In some applications, the measurement outcome A can be interpreted as a logical state |0 [symbol] _{L} or |1 [symbol] _{L} of the qubit. For example, the homodyne measurement can be interpreted as a projection of the GKP qubit onto a coherent state representing a particular logical state (e.g., |0 [symbol] _{L} or |1 [symbol] _{L}, depending on phase shift ϕ). If the measurement outcome is A=0, the result can be interpreted as the qubit being not in the measured logical state. It should be noted that such measurements are susceptible to error due to inherent limitations in the preparation of GKP states. GKP qubits can also be used in fault-tolerant quantum computing protocols, in which interpreting measurement results as logical states of individual physical qubits is not required.

### 3.2.2. Generating Entangled States

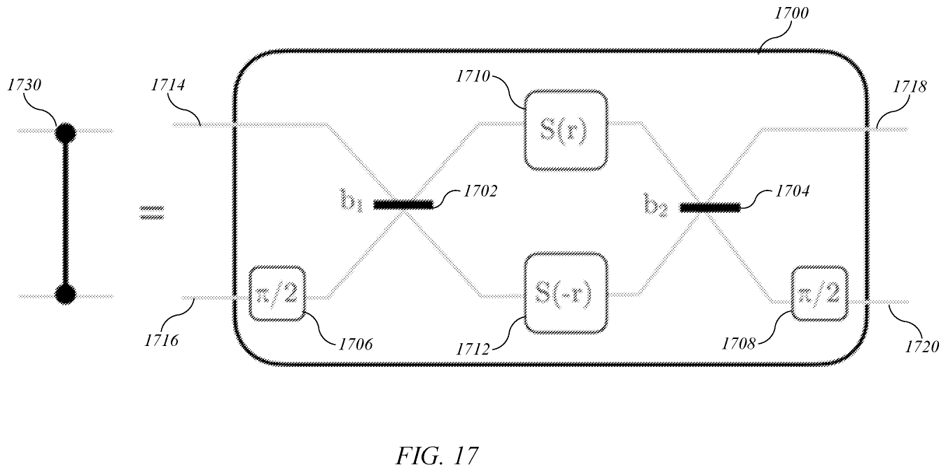

In some embodiments, an entangling CZ gate on two qubits can be performed. FIG. 17 shows a simplified schematic diagram of an optical circuit 1700 implementing a CZ gate for entangling two GKP qubits that can be used in some embodiments. Optical circuit 1700 can include two beam splitters 1702, 1704; phase shift circuits 1706, 1708; and squeezing circuits 1710, 1712. In some respects, optical circuit 1700 can be similar to interferometer circuits described above with reference to FIGS. 3A and 3B. Squeezing circuits 1710, 1712 can implement a variety of squeezing operations, including inline squeezing or squeezing by using interference with squeezed states and feedforward. In subsequent schematic diagrams, circuit symbol 1730 is used to represent a CZ gate such as optical circuit 1700.

In operation, two GKP qubits can be provided on input paths (e.g., waveguides) 1714, 1716. One qubit is phase shifted (e.g., by π/2) by phase shift circuit 1706. The qubits interfere in beam splitter 1702, outputs of which pass through respective squeezing circuits 1710, 1712. The outputs of squeezing circuits 1710, 1712 interfere in beam splitter 1704, and one output of beam splitter 1704 is phase shifted (e.g., by π/2). The output on paths (e.g., waveguides) 1718, 1720 is a pair of GKP qubits in an entangled state (e.g., a Bell state). Depending on the particular configuration of circuit 1700, different Bell states (or other entangled states) can be produced.

It should be noted that circuit 1700 includes squeezing circuits 1710, 1712. Squeezing is a lossy operation (in the sense that a squeezed state does not necessarily result); the particular loss depends on implementation. Depending on the implementation of squeezing, losses may or may not be heralded. For example, inline squeezing circuits generally do not provide signals that would allow losses to be detected (without destroying the qubit). Squeezing circuits that use ancillary photons and feedforward can provide heralding signals, allowing losses to be detected. The entanglement operation of circuit 1700 can be deterministic; that is, apart from photon loss and assuming the input qubits are in valid GKP states, the entangled state can be generated with probability 1. (This is unlike Bell state generator 700 for dual-rail-encoded qubits.)

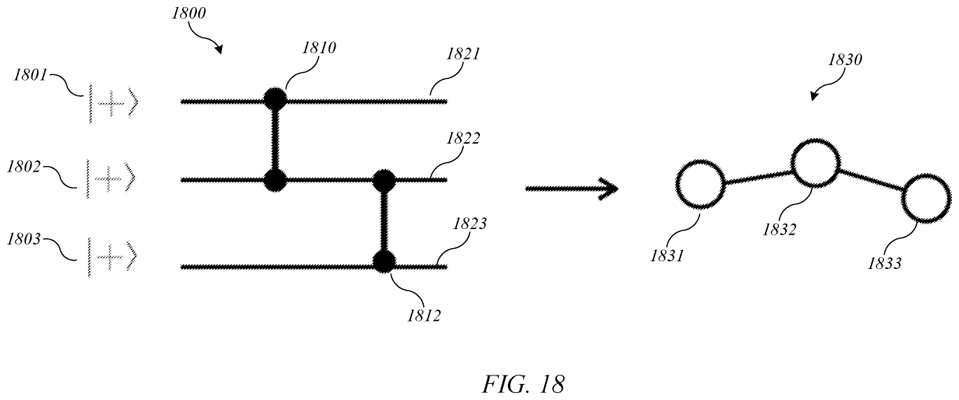

To prepare entangled states of more than two qubits, a network of CZ gates can be used. For example, FIG. 18 shows a simplified schematic diagram of an optical circuit 1800 that can produce a 3-qubit resource state 1820 of GKP qubits according to some embodiments. Optical circuit 1800 includes two CZ gates 1810, 1812, each of which can be an instance of optical circuit 1700. Inputs to circuit 1800 can be three GKP qubits 1801-1803, each prepared in a known state (e.g., the |+ [symbol] state as shown). The outputs on waveguides 1821-1823 can be an entangled state of three GKP qubits 1831-1833, as illustrated by the graph state representation 1830. As in other graph state representations herein, qubits 1831-1833 are represented as circles and entanglement is represented by lines (edges) connecting the qubits. The entangled state 1830 can be a 3-GHZ state as defined above. In some embodiments, 3-GHZ states can be used to construct resource states in a fusion-based quantum computing system.

### 3.3. Entangling Projective Measurements on GKP Qubits

As described in Section 2 above, FBQC uses entangling projective measurements (also referred to as fusion measurements) between separately-prepared quantum systems (referred to as resource states) to implement fault-tolerant quantum computation. In general, an entangling projective measurement can be any positive operator valued joint measurement (POVM) on two (or more) qubits from two (or more) independent (i.e., not mutually entangled) resource states. For purposes of achieving fault tolerance, measurements where all outcomes are projections onto stabilizer states are of particular interest, since this makes it straightforward to use existing stabilizer fault tolerance methods. This section describes examples of n-qubit measurements on GKP qubits that are projections onto stabilizer states and circuits for implementing such measurements. In various embodiments, such measurements can be implemented using optical circuits that incorporate a network of beam splitters and homodyne measurement circuits.

### 3.3.1. Bell Measurements

One example of an entangling projective measurement that can be applied to GKP qubits is “Bell fusion,” which projects onto a Bell state on two qubits. Using Pauli operator notation, a Bell fusion can be described as measuring the operators X₁X₂, Z₁Z₂ on the two input qubits, where Xᵢ (Zᵢ) is the single qubit Pauli-X (Z) operator on the qubit i. This measurement is rank 1, and the measurement operators form a stabilizer group. Bell fusion is also sometimes referred to as an [symbol] XᵢXⱼ, ZᵢZⱼ [symbol] fusion.

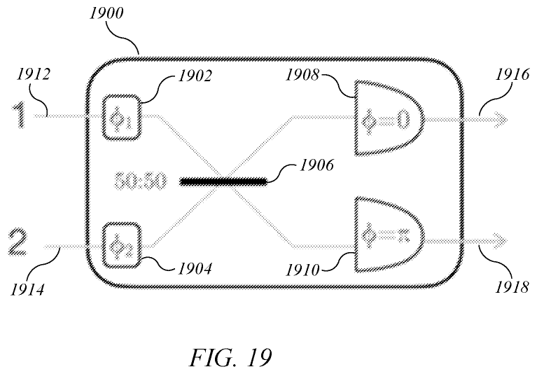

FIG. 19 shows a simplified schematic diagram of an optical circuit 1900 for performing Bell measurements on GKP qubits according to some embodiments. Optical circuit 1900 can include two phase shifters 1902, 1904; a 50/50 beam splitter 1906; and two homodyne measurement circuits 1908, 1910. Inputs to optical circuit 1900 can be two GKP qubits on input waveguides 1912, 1914. Outputs from optical circuit 1900 can be classical logic signals 1916, 1918 (which can be, e.g., digital or analog logic signals) representing the measurement outcomes of homodyne measurement circuits 1908, 1910.

In operation, a GKP qubit can be received on each of input waveguides 1912, 1914. Phase shifters 1902, 1904 can apply respective phase shifts (ϕ₁, ϕ₂) to the GKP qubits; choice of phase shifts is considered below. The two qubits interfere at 50/50 beam splitter 1906, outputs of which are directed to homodyne measurement circuits 1908, 1910. As described above, each measurement by a homodyne measurement circuit has a phase ϕ, which can be selected separately from phase shifts (ϕ₁, ϕ₂). In some embodiments, measurement with phase ϕ=0 corresponds to a measurement of observable p while measurement with phase ϕ=π corresponds to a measurement of observable q.

To further illustrate how optical circuit 1900 can achieve the desired Bell measurement, the following mathematical description is provided. The observables to be measured can be represented as:

$$\begin{matrix}{\overline{X}}_{1} {\overline{X}}_{2}^{†} = exp [ - i \sqrt{π} ( {p}_{1} - {p}_{2} ) ] \\ {\overline{Z}}_{1} {\overline{Z}}_{2} = exp [ i \sqrt{π} ( {q}_{1} + {q}_{2} ) ] .\end{matrix} \qquad ( 23 )$$

These observables commute, so they are simultaneously measurable. The Hermitian conjugate is applied to one operator in order to achieve this commutation, and it should be understood that there is a choice as to which operator has the Hermitian conjugate applied. This choice does not affect the qubit thus measured; however, different choices have different effects on the gauge subsystem, and different choices may result in better or worse performance depending on details of the noise.

Inputting two GKP qubits, with appropriate phase shifts, into 50/50 beam splitter 1906 performs the following canonical operation:

$${q}_{1} \to ( {q}_{3} + {q}_{4} ) / \sqrt{2} {p}_{1} \to ( {p}_{3} + {p}_{4} ) \sqrt{2} {q}_{2} \to ( {q}_{3} - {q}_{4} ) / \sqrt{2} {p}_{2} \to ( {p}_{3} - {p}_{4} ) \sqrt{2} \qquad ( 24 )$$

where the two input modes of beam splitter 1906 are labeled 1, 2 and the two output modes are labeled 3, 4. The phase shifts (ϕ₁, ϕ₂) applied by phase shifters 1902, 1904 can be selected to achieve the phases as written in Eq. (24).

After 50/50 beam splitter 1906, homodyne measurement circuits 1908, 1910 perform a homodyne measurement on each qubit. In some embodiments, the phases of the homodyne measurements can be configured to measure q₃ for the first system and p₄ for the second. For example, the measurement outcomes can be:

$$\begin{matrix}{q}_{3} = ( {q}_{1} + {q}_{2} ) / \sqrt{2} + {σ}_{q 1} \\ {p}_{4} = ( {p}_{1} - {p}_{2} ) / \sqrt{2} + {σ}_{p 2} .\end{matrix} \qquad ( 25 )$$

From Eq. (25), it is straightforward to obtain outcomes for the two observables needed to infer the outcome of the GKP qubit Bell measurement.

As with type II fusion operations described above, it should be understood that the two qubits input to circuit 1900 can be qubits from two different quantum systems, each of which can include multiple entangled qubits. Operation of circuit 1900 can destroy the input qubits and create entanglement between the quantum systems, thereby creating a larger entangled quantum system.

Another implementation of a Bell measurement on GKP qubits can rely on a GKP SUM operation, which uses a squeezing operation (requiring an active optical element) rather than a beam splitter as shown in circuit 1900. Using the GKP SUM operation can provide higher signal-to-noise; however, active optical elements typically have larger losses than passive elements such as beam splitters.

As with other circuits described above, leakage can occur in circuit 1900. In some embodiments, the procedure for treating leakage described with reference to circuit 1600 of FIG. 16 can be applied to the measurement outcomes in homodyne measurement circuits 1908, 1910. If one or the other measurement outcome (or both outcomes) indicates leakage, then both qubits can be treated as having leaked. In some implementations, the tolerance limit δ can be chosen to improve either threshold or footprint according to some optimization.

3.3.2. n-Qubit GHZ Fusion Measurements

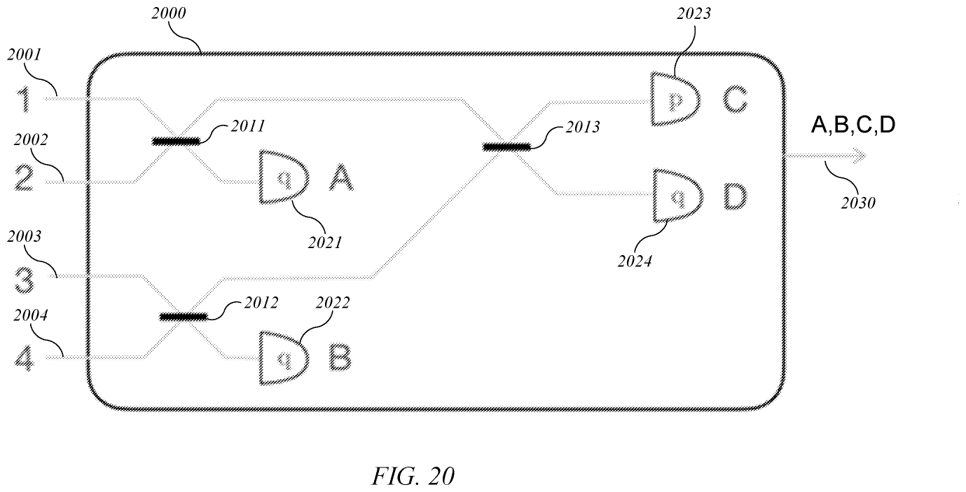

The Bell fusion (measurement) on two GKP qubits as described above can be generalized to other stabilizer fusion measurements on n qubits, such as n-qubit GHZ measurements. By way of example, FIG. 20 shows a simplified schematic diagram of an optical circuit 2000 that can perform a 4-qubit GHZ fusion measurement according to some embodiments. Optical circuit 2000 includes a network of 50/50 beam splitters 2011-2013 and homodyne measurement circuits 2021-2024. Four GKP qubits can be input on input paths 2001-2004. Input paths 2001 and 2002 are coupled to beam splitter 2011, one output of which is coupled to homodyne measurement circuit 2021 while the other output is coupled to beam splitter 2013. Similarly, input paths 2003 and 2004 are coupled to beam splitter 2012, one output of which is coupled to homodyne measurement circuit 2022 while the other output is coupled to beam splitter 2013. Each output of beam splitter 2013 is coupled to a homodyne measurement circuit 2023, 2024. Outputs 2030 of optical circuit 2000 include the four (classical) measurement outcomes (labeled as A, B, C, D) from homodyne measurement circuits 2021-2024. Although not shown in FIG. 20, some or all of input paths 2001-2004 can be coupled to phase shift circuits upstream (in the optical path) of beam splitters 2011, 2012. Such phase shift circuits can be similar to phase shift circuits 1902, 1904 shown in FIG. 19 and can apply fixed or selectable phase shifts. In some embodiments, phase shifts can be used to select a measurement basis for the joint measurement.

Similarly to fusion operations described above, it should be understood that the four qubits input to circuit 2000 can be qubits from four different quantum systems, each of which can include multiple entangled qubits. Operation of circuit 2000 can destroy the four input qubits and create entanglement between the four quantum systems, thereby creating a larger entangled quantum system.

To further illustrate how optical circuit 2000 can achieve the desired fusion measurement, the following mathematical description is provided. Applying the logic of Eqs. (23)-(25) above, it follows that, for circuit 2000, the measurement outcomes are:

$$\begin{matrix}A = \frac{1}{\sqrt{2}} ( {q}_{1} - {q}_{2} ) \\ B = \frac{1}{\sqrt{2}} ( {q}_{3} - {q}_{4} ) \\ C = \frac{1}{2} ( {p}_{1} + {p}_{2} + {p}_{3} + {p}_{4} ) \\ D = \frac{1}{2} ( {q}_{1} + {q}_{2} + {q}_{3} + {q}_{4} ) ,\end{matrix} \qquad ( 26 )$$

From Eq. (26), it follows that the stabilizers are:

$$\begin{matrix}a = exp [ i \sqrt{2 π} A ] = {\overline{Z}}_{1} {\overline{Z}}_{2}^{†} \\ b = exp [ i \sqrt{2 π} B ] = {\overline{Z}}_{3} {\overline{Z}}_{4}^{†} \\ c = exp [ 2 i \sqrt{π} C ] = {\overline{X}}_{1} {\overline{X}}_{2} {\overline{X}}_{3} {\overline{X}}_{4} \\ d = exp [ 2 i \sqrt{π} D ] = {\overline{Z}}_{1} {\overline{Z}}_{2} {\overline{Z}}_{3}^{†} {\overline{Z}}_{4}^{†} .\end{matrix} \qquad ( 27 )$$

This set of stabilizer measurements is a GHZ projection onto the 4 qubits of the state. While Eq. (27) is not the standard representation of the GHZ state stabilizers, the set of two-body Z operators can be recovered by observing that \sqrt{abd}=Z̅₁Z̅₄^{†}.

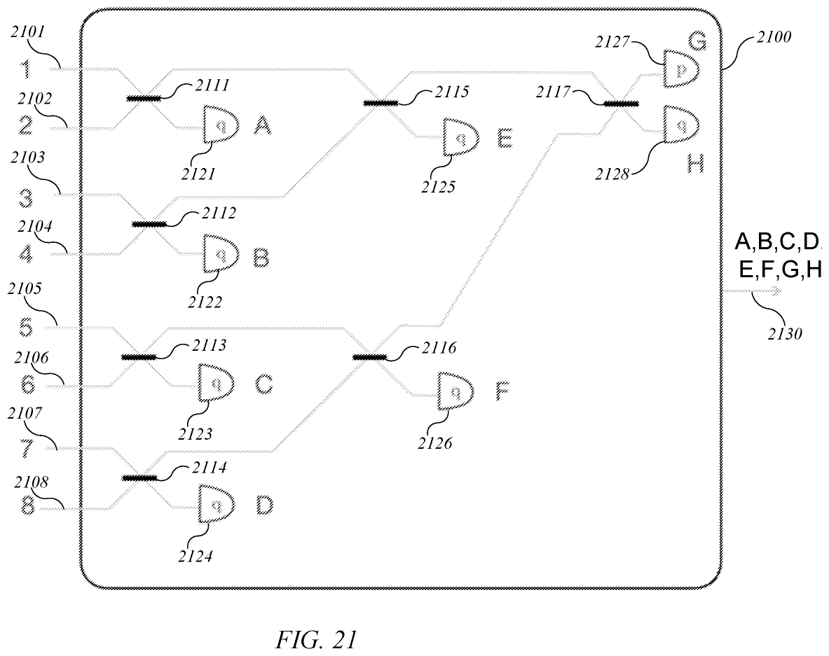

Circuits similar to circuit 2000 can be constructed to perform fusion measurements for any set of n=2^{m} qubits for integer m≥2. By way of example, FIG. 21 shows a simplified schematic diagram of an optical circuit 2100 that can perform an 8-qubit GHZ fusion measurement according to some embodiments. Optical circuit 2100 includes a network of 50/50 beam splitters 2111-2117 and homodyne measurement circuits 2121-2128. Eight GKP qubits can be input on input paths 2101-2108. Input paths 2101 and 2102 are coupled to beam splitter 2111, one output of which is coupled to homodyne measurement circuit 2121 while the other output is coupled to beam splitter 2115. Similarly, input paths 2103 and 2104 are coupled to beam splitter 2112, one output of which is coupled to homodyne measurement circuit 2122 while the other output is coupled to beam splitter 2115. Beam splitter 2115 has one output coupled to homodyne measurement circuit 2125 and the other output coupled to beam splitter 2117. Input paths 2105 and 2106 are coupled to beam splitter 2113, one output of which is coupled to homodyne measurement circuit 2123 while the other output is coupled to beam splitter 2116. Similarly, input paths 2107 and 2108 are coupled to beam splitter 2114, one output of which is coupled to homodyne measurement circuit 2124 while the other output is coupled to beam splitter 2116. Beam splitter 2116 has one output coupled to homodyne measurement circuit 2126 and the other output coupled to beam splitter 2117. Each output of beam splitter 2117 is coupled to a homodyne measurement circuit 2127, 2128. Outputs 2130 of optical circuit 2100 include the eight (classical) measurement outcomes (labeled as A, B, C, D, E, F, G, H) from homodyne measurement circuits 2121-2128. Although not shown in FIG. 21, some or all of input paths 2101-2108 can be coupled to phase shift circuits upstream (in the optical path) of beam splitters 2111-2114. Such phase shift circuits can be similar to phase shift circuits 1902, 1904 shown in FIG. 19 and can apply fixed or selectable phase shifts. In some embodiments, phase shifts can be used to select a measurement basis for the joint measurement.

Similarly to fusion operations described above, it should be understood that the eight qubits input to circuit 2100 can be qubits from eight different quantum systems, each of which can include multiple entangled qubits. Operation of circuit 2100 can destroy the eight input qubits and create entanglement between the eight quantum systems, thereby creating a larger entangled quantum system.

To further illustrate how optical circuit 2100 can achieve the desired fusion measurement, the following mathematical description is provided. Applying the logic of Eqs. (23)-(27) above, it follows that, for circuit 2100, the stabilizers are

$$\begin{matrix}a = exp [ i \sqrt{2 π} A ] = {\overline{Z}}_{1} {\overline{Z}}_{2}^{†} \\ b = exp [ i \sqrt{2 π} B ] = {\overline{Z}}_{3} {\overline{Z}}_{4}^{†} \\ c = exp [ i \sqrt{2 π} C ] = {\overline{Z}}_{5} {\overline{Z}}_{6}^{†} \\ d = exp [ i \sqrt{2 π} D ] = {\overline{Z}}_{7} {\overline{Z}}_{8}^{†} \\ e = exp [ 2 i \sqrt{π} E ] = {\overline{Z}}_{1} {\overline{Z}}_{2} {\overline{Z}}_{3}^{†} {\overline{Z}}_{4}^{†} \\ f = exp [ 2 i \sqrt{π} F ] = {\overline{Z}}_{5} {\overline{Z}}_{6} {\overline{Z}}_{7}^{†} {\overline{Z}}_{8}^{†} \\ g = exp [ - 2 i \sqrt{2 π} G ] = {\overline{X}}_{1} {\overline{X}}_{2} {\overline{X}}_{3} {\overline{X}}_{4} {\overline{X}}_{5} {\overline{X}}_{6} {\overline{X}}_{7} {\overline{X}}_{8} \\ h = exp [ 2 i \sqrt{2 π} H ] = {\overline{Z}}_{1} {\overline{Z}}_{2} {\overline{Z}}_{3} {\overline{Z}}_{4} {\overline{X}}_{5}^{†} {\overline{X}}_{6}^{†} {\overline{X}}_{7}^{†} {\overline{X}}_{8}^{†} .\end{matrix} \qquad ( 28 )$$

These measurements represent the 8-qubit GHZ projection. As with Eq. (27), the two-body Z operators can be recovered by taking appropriate products of the computed operators.

$$Namely , \sqrt{abe} = {\overline{Z}}_{1} {\overline{Z}}_{4}^{†} , \sqrt{cdf} = {\overline{Z}}_{5} {\overline{Z}}_{8}^{†} , and {( acefh )}^{\frac{1}{4}} = {\overline{Z}}_{1} {\overline{Z}}_{6}^{†} .$$

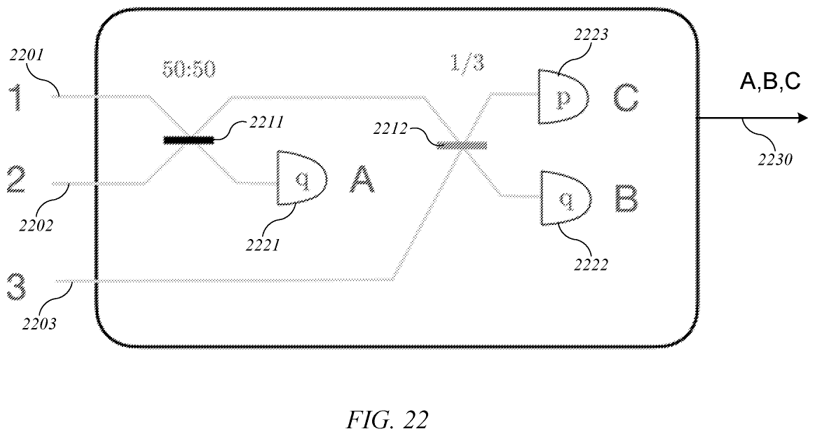

According to some embodiments, circuits similar to circuits 1900, 2000, and 2100 can be provided for GHZ fusion using a number of qubits n that is not a power of 2. By way of example, FIG. 22 shows a simplified schematic diagram of a circuit 2200 for performing GHZ fusion measurements on three GKP qubits according to some embodiments. Optical circuit 2200 can include a network of beam splitters (in this case a 50/50 beam splitter 2211 and a ⅓ beam splitter 2212); and three homodyne measurement circuits 2221-2223. Three GKP qubits can be input on input paths 2201-2203. Input paths 2201 and 2202 are coupled to 50/50 beam splitter 2211, one output of which is coupled to homodyne measurement circuit 2221 while the other output is coupled to ⅓ beam splitter 2212. Input path 2203 is coupled to ⅓ beam splitter 2212. Each output of ⅓ beam splitter 2212 is coupled to a homodyne measurement circuit 2222, 2223. Outputs 2230 of optical circuit 2200 include the three (classical) measurement outcomes (labeled as A, B, C) from homodyne measurement circuits 2221-2223. Although not shown in FIG. 22, some or all of input paths 2201-2203 can be coupled to phase shift circuits upstream (in the optical path) of beam splitters 2211, 2212. Such phase shift circuits can be similar to phase shift circuits 1902, 1904 shown in FIG. 19 and can apply fixed or selectable phase shifts. In some embodiments, phase shifts can be used to select a measurement basis for the joint measurement.

Similarly to fusion operations described above, it should be understood that the three qubits input to circuit 2200 can be qubits from three different quantum systems, each of which can include multiple entangled qubits. Operation of circuit 2100 can destroy the three input qubits and create entanglement between the three quantum systems, thereby creating a larger entangled quantum system.

To further illustrate how optical circuit 2200 can achieve the desired fusion measurement, the following mathematical description is provided. Applying the logic of Eqs. (23)-(27) above, it follows that, for circuit 2200, the stabilizers are

$$\begin{matrix}a = exp [ i \sqrt{2} A ] = {\overline{Z}}_{1} {\overline{Z}}_{2}^{†} \\ b = exp [ i \sqrt{6} C ] = {\overline{Z}}_{1} {{\overline{Z}}_{2} ( {\overline{Z}}_{3} † )}^{2} \\ c = exp [ - i \sqrt{3} C ] = {\overline{Z}}_{1} {\overline{Z}}_{2} {\overline{Z}}_{3}\end{matrix} \qquad ( 29 )$$

These measurements represent the 3-qubit GHZ projection. The two-body Z operators can be recovered by taking appropriate products of the computed operators, namely, \sqrt{ab}=Z̅₁Z̅₃^{†}.

Circuits 1900, 2000, 2100, and 2200 are illustrative of a class of circuits that can perform n-GHZ fusion measurements for any integer n≥2. Persons skilled in the art with the benefit of this disclosure will be able to construct appropriate n-GHZ fusion circuits using a network of beam splitters and homodyne measurement circuits.

An n-GHZ fusion measurement is a natural fusion measurement for GKP qubits. Such measurements can be implemented for photonic GKP qubits or microwave implementations of GKP qubits based on superconducting devices. The n-GHZ fusion measurements can be near-deterministic in the sense that, in the absence of leakage errors, they succeed with probability 1. As noted above, leakage can be identified based on the measurement outcomes, and results in instances where leakage occurred can be treated as invalid results.

### 3.4.FBQC Protocols Using GKP Qubits

In some embodiments, resource state generation and fusion operations for GKP qubits, which can be implemented using the circuits described above, can be used to construct fusion networks to implement topological fault tolerance in an FBQC model of the kind described in Section 2. In such models, operations on logical qubits can be implemented by performing a prescribed pattern of fusion operations and single-qubit measurements on qubits of resource states. As described above, the pattern can be based on a regular lattice structure; such patterns are also referred to herein as “fusion networks.”

According to some embodiments, a fusion array provides a set of reconfigurable fusion sites (e.g., as described above with reference to FIG. 14D), where each fusion site receives qubits from two (or more) different resource states and selectably performs one or more measurement operations on the received qubits. In some embodiments, set of measurement operations can include a two-qubit projective entangling measurement (or two-qubit fusion measurement such as a Bell measurement), a Pauli X measurement, and a Pauli Z measurement. Additional measurement operations can also be implemented, including Pauli Y measurement, other single-qubit measurements, and fusion measurements involving more than two qubits; the number and combination of supported operations can be chosen depending on the particular fusion network(s) that a given implementation is designed to support.

A variety of different resource states and fusion networks for FBQC can be implemented using GKP qubits. Two specific examples will now be described. It should be understood that other resource states and fusion networks can also be used.

### 3.4.1. Fusion Network Using 6-Ring Resource States

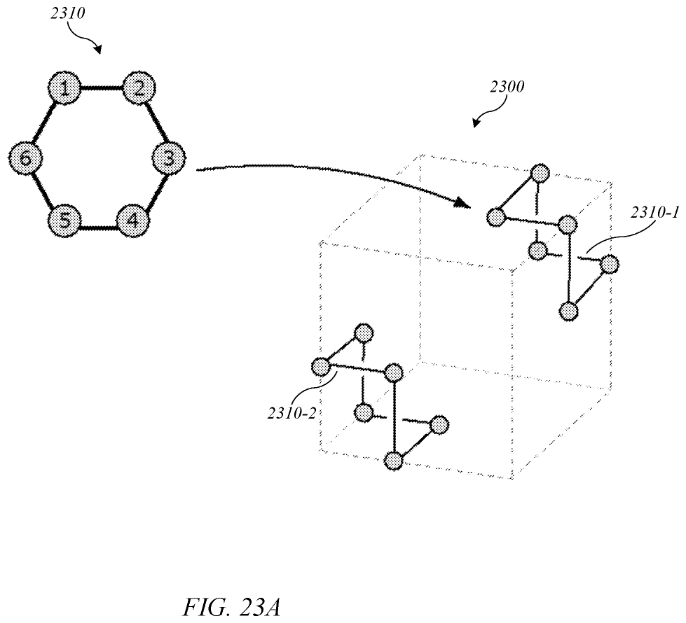

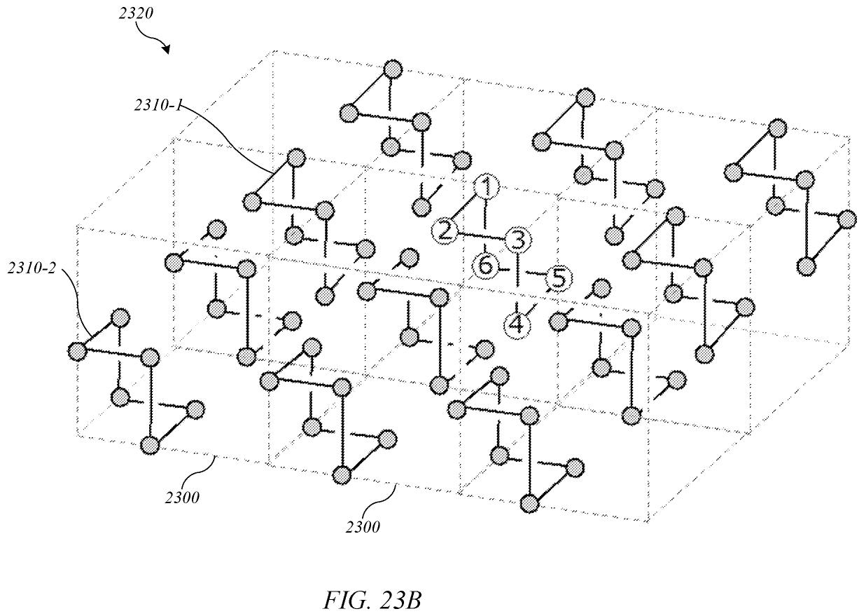

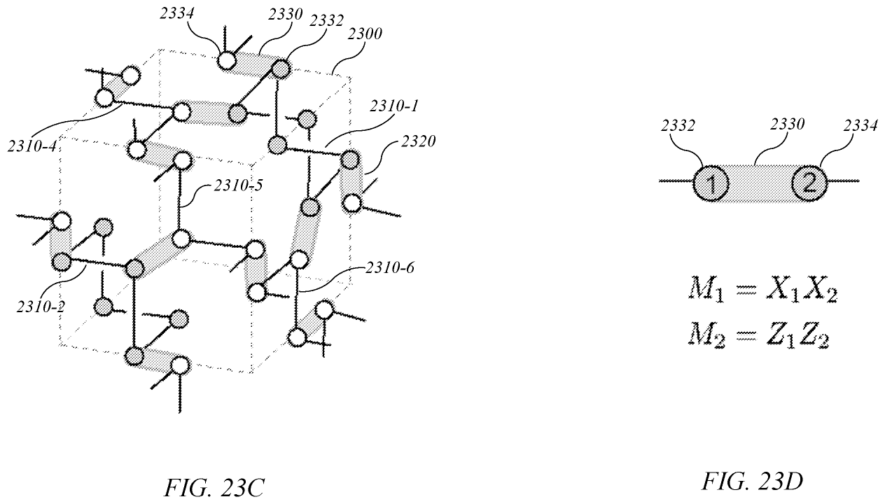

In some embodiments, a fusion network can be constructed using 6-ring resource states. Examples of 6-ring resource states are described above with reference to FIG. 10. FIGS. 23A-23E illustrate a fusion network based on 6-ring resource states according to some embodiments. FIG. 23A shows a graph state representation of a unit cell 2300 for a 6-ring fusion network according to some embodiments. Unit cell 2300 includes two instances of a 6-ring resource state 2310 (which can have the same entanglement structure as resource state 1000 of FIG. 10) placed at opposite corners of the unit cell; the instances are labeled as resource state 2310-1 and 2310-2. In some embodiments, the 6-ring resource state can have the following stabilizers:

$${S}_{1} = {Z}_{1} {X}_{2} {Z}_{3} {I}_{4} {I}_{5} {I}_{6} {S}_{2} = {I}_{1} {Z}_{2} {X}_{3} {Z}_{4} {I}_{5} {I}_{6} {S}_{3} = {I}_{1} {I}_{2} {Z}_{3} {X}_{4} {Z}_{5} {I}_{6} {S}_{4} = {I}_{1} {I}_{2} {I}_{3} {Z}_{4} {X}_{5} {Z}_{6} {S}_{5} = {Z}_{1} {I}_{2} {I}_{3} {I}_{4} {Z}_{5} {X}_{6} {S}_{6} = {X}_{1} {Z}_{2} {I}_{3} {I}_{4} {I}_{5} {Z}_{6} \qquad ( 30 )$$

Using GKP qubits, resource state 2310 can be prepared in a variety of ways. For example, six GKP qubits can be prepared in the |+ [symbol] state followed by CZ gates (e.g., as described above) between pairs of qubits connected in the graph. Alternatively, a number of small entangled “seed states” (e.g., two-qubit or three-qubit states) can be prepared, and homodyne fusions can be performed between the seed states to create a ring entanglement. For instance, using a circuit such as circuit 1800, six copies of a 3-GHZ seed state can be prepared (one for each qubit of 6-ring resource state 2300), and Bell fusion (e.g., as described above with reference to FIG. 19) can be used to create entanglement between the 3-GHZ seed states. In such embodiments, the Bell fusion can be modified to measure the operators XZ and ZX. Many other resource state preparation methods are possible, and the optimal approach depends on the specifics of the physical hardware and error model.

FIG. 23B shows a fusion network 2320 in which unit cell 2300 is repeated in a three-dimensional lattice. As shown in FIG. 23C, entangling projective measurements (e.g., Bell fusion measurements as described above) can be performed between qubits of different instances of resource state 2310 that are at neighboring positions in fusion network 2320. The fusion operations are represented by ovals 2330. For clarity of illustration, qubits of the resource states of one unit cell 2300 (e.g., resource states 2310-1 and 2310-2) are shown as shaded circles 2332 while qubits of other resource states associated with other unit cells (e.g., resource states 2310-3 through 2310-6) are shown as white circles 2334.

FIG. 23D shows an example of an entangling projective measurement 2330 on a pair of qubits 2332 and 2334, which can belong to different instances of resource state 2310, according to some embodiments. The entangling projective measurement in this example includes a pair of joint measurements:

$$\begin{matrix}{M}_{1} = {X}_{1} {X}_{2} \\ {M}_{2} = {Z}_{1} {Z}_{2}\end{matrix} \qquad ( 31 )$$

To perform logical operations, the entangling projective measurements 2330 at selected lattice locations in fusion network 2360 can be replaced with single-qubit measurements. (Examples of logical operations are described above with reference to FIGS. 11B-11E and FIGS. 12A-12C.) For example, a reconfigurable fusion circuit can be provided that implements fusion site 1461 described above.

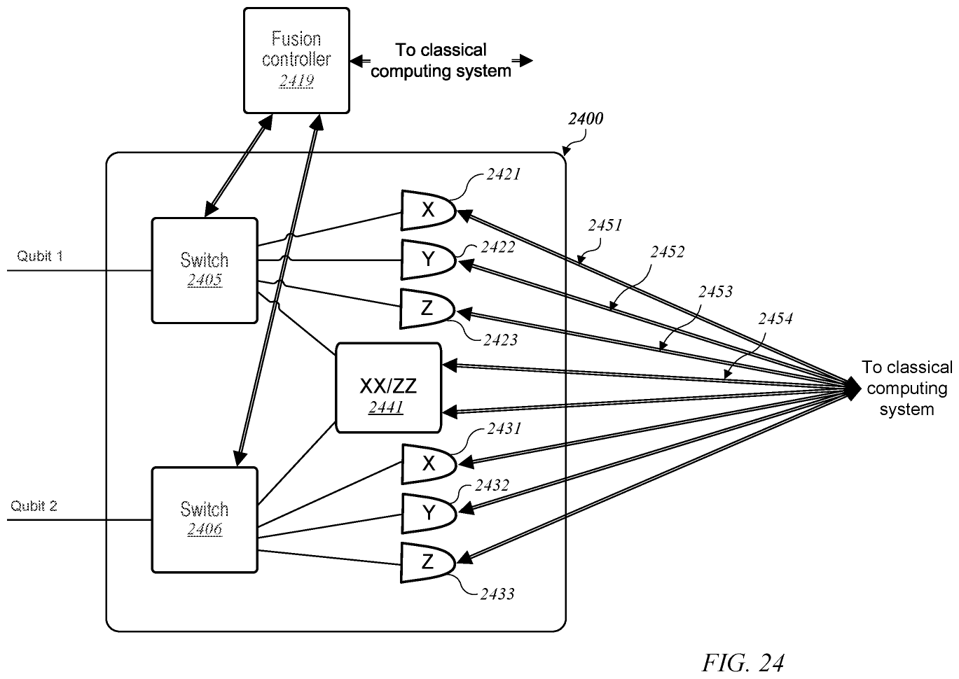

FIG. 24 shows a simplified schematic diagram of a reconfigurable fusion circuit 2400 for GKP qubits according to some embodiments. Circuit 2400 can be used, for example, to implement an instance of fusion site 1461 of FIG. 14C in a quantum computing system such as system 1401 of FIG. 14A. In some embodiments, circuit 2400 can support fault-tolerant quantum computation using a 6-ring fusion network such as fusion network 2320. Circuit 2400 includes a pair of optical switches 2405, 2406. Each switch 2405, 2406 can be an active optical switch that can be controlled by a fusion controller 2419 (which can be similar or identical to fusion controller 1419 described above). The various output paths of switches 2405, 2406 can be coupled to different qubit measuring devices that implement different types of measurements on GKP qubits. For example, single-qubit measuring device 2421 (2431) can implement a homodyne measurement of the state of qubit 1 (qubit 2) in the X basis, single-qubit measuring device 2422 (2432) can implement a measurement of qubit 1 (qubit 2) in the Y basis, and single-qubit measuring device 2423 (2433) can implement a measurement of qubit 1 (qubit 2) in the Z basis. Each single-qubit measuring device 2421-2423, 2431-2433 can be a separate instance of homodyne measurement circuit 1600 of FIG. 16 with an appropriate phase shift ϕ provided by the phase shift circuit 1600. In an alternative implementation, just one instance of homodyne measurement circuit 1600 can be provided for each qubit, and fusion controller 2419 can select the measurement basis for each received pair of qubits by dynamically controlling phase shift circuit 1610. A two-qubit joint measuring device 2441 can also be provided. In some embodiments, two-qubit joint measurement device 2441 can be a Bell measurement (or Bell fusion) circuit such as circuit 1900 of FIG. 19. As described above, circuit 1900 can produce both XX and ZZ measurements for a pair of input GKP qubits. Downstream classical processing logic can select the appropriate measurement result for a given measurement based on the corresponding location in the fusion graph. Circuit 2400 can output classical measurement outcome data on output paths (e.g., output paths 2451-2454). As described above, the outcomes can be used to generate a syndrome graph, an example of which is shown as syndrome graph 2500 in FIG. 25, and the syndrome graph can be used to determine a result of the logical operation.

### 3.4.2. Inverted 4-Star Fusion Network

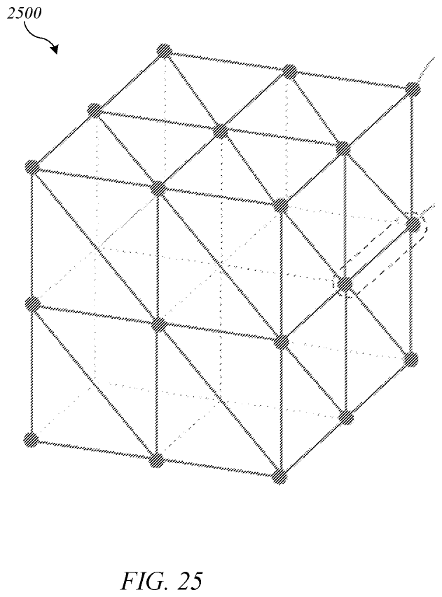

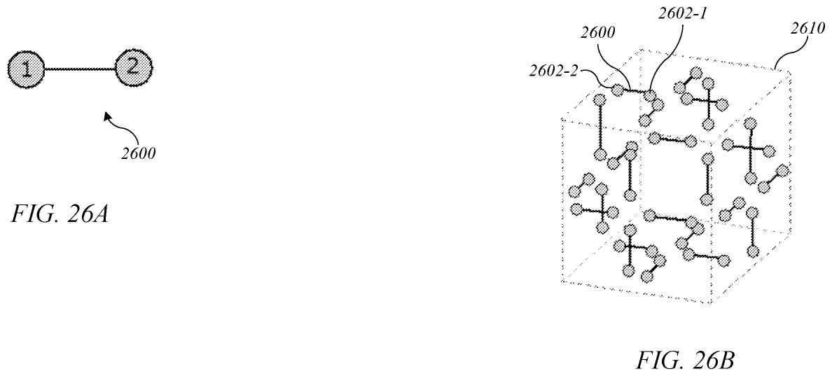

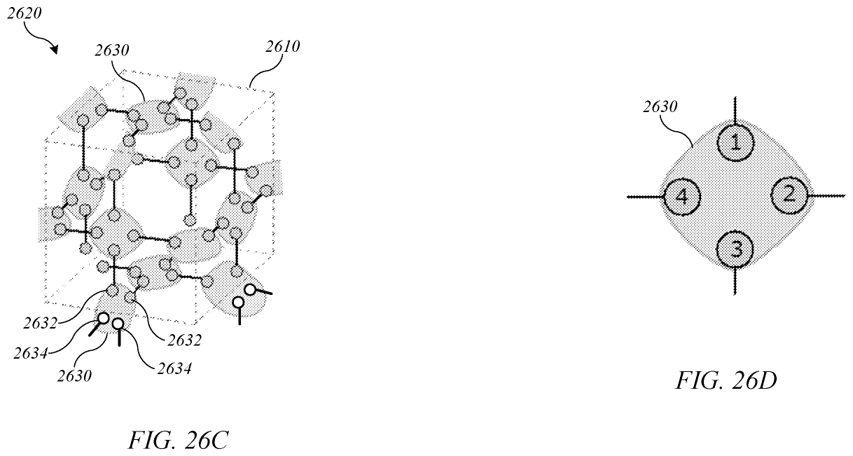

In some embodiments, an “inverted 4-star” fusion network can be constructed using two-qubit resource states. FIG. 26A illustrates a two-qubit resource state 2600 that can be used to construct an inverted 4-star fusion network according to some embodiments. Resource state 2600 can be, for example, a Bell pair of GKP qubits. In some embodiments, a Bell pair of GKP qubits can be produced by generating two initialized GKP qubits (e.g., as described above) and passing them through an entangling CZ gate, such as circuit 1700 described above. The stabilizers of resource state 2600 can be:

$${S}_{1} = {X}_{1} {Z}_{2} {S}_{2} = {Z}_{1} {X}_{2} \qquad ( 32 )$$

FIG. 26B shows a graph state representation of a unit cell 2610 for an inverted 4-star fusion network according to some embodiments. Unit cell 2610 includes twenty-four instances of resource state 2600 with each instance having one qubit (e.g., qubit 2602-1) toward the center of a face of unit cell 2600 and one qubit (e.g., qubit 2602-2) arranged toward an edge of the face. FIG. 26C shows a lattice entanglement pattern for unit cell 2610 in a fusion network 2620 according to some embodiments. The fusion operations are represented by blobs 2630. For clarity of illustration, qubits of the resource states of unit cell 2610 are shown as shaded circles 2632 while qubits of other resource states associated with other unit cells in fusion network 2620 are shown as white circles 2634.

In this example, the fusion measurements are 4-qubit projective entangling measurements, a representative example of which is shown in FIG. 26D. Such measurements can be implemented, e.g., using circuit 2000 of FIG. 20. In some embodiments, the measurements can be:

$${M}_{1} = {X}_{1} {X}_{2} {X}_{3} {X}_{4} {M}_{2} = {Z}_{1} {Z}_{2} {I}_{3} {I}_{4} {M}_{3} = {I}_{1} {Z}_{2} {Z}_{3} {I}_{4} {M}_{4} = {I}_{1} {I}_{2} {Z}_{3} {Z}_{4} \qquad ( 33 )$$

To perform logical operations, the entangling projective measurements 2630 at selected lattice locations in fusion network 2620 can be replaced with single-qubit measurements and/or two-qubit entangling projective measurements. For example, a reconfigurable fusion circuit can be provided that implements fusion site 1461 described above.

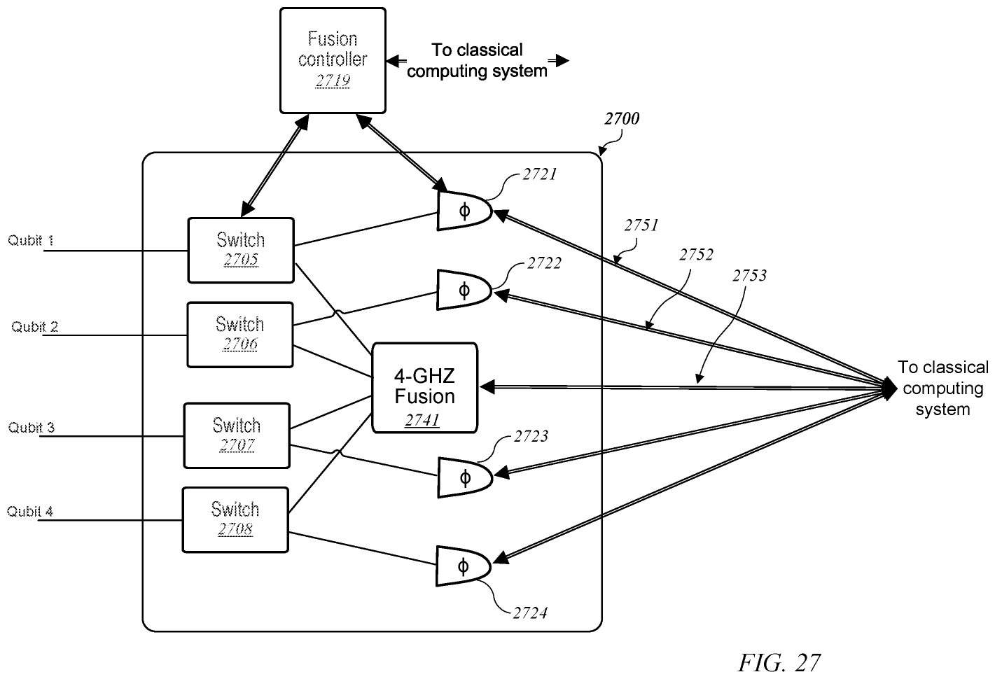

FIG. 27 shows a simplified schematic diagram of a reconfigurable fusion circuit 2700 for GKP qubits according to some embodiments. Circuit 2700 can be used, for example, to implement an instance of fusion site 1461 of FIG. 14C in a quantum computing system such as system 1401 of FIG. 14A. In some embodiments, circuit 2700 can support fault-tolerant quantum computation using an inverted 4-star fusion network such as fusion network 2620. Circuit 2700 includes four optical switches 2705-2708. Each switch 2705-2708 can be an active optical switch that can be controlled by a fusion controller 2719 (which can be similar or identical to fusion controller 1419 described above). The various output paths of switches 2705-2708 can be coupled to different qubit measuring devices that implement different types of measurements on GKP qubits. For example, single-qubit measuring device 2721 can implement a homodyne measurement of the state of qubit 1, single-qubit measuring device 2722 can implement a homodyne measurement of the state of qubit 2, single-qubit measuring device 2723 can implement a homodyne measurement of the state of qubit 3, and single-qubit measuring device 2724 can implement a homodyne measurement of the state of qubit 4. Each single-qubit measuring device 2721-2724 can be a separate instance of homodyne measurement circuit 1600 of FIG. 16 with a dynamically controlled phase shift ø. Fusion controller circuit 2419 can select the measurement basis for a particular qubit by dynamically controlling phase shift circuit 1610. In an alternative implementation, a separate instance of homodyne measurement circuit 1600 can be provided for each qubit and each measurement basis (e.g., similarly to circuit 2400 of FIG. 24). A four-qubit joint measuring device 2741 can also be provided. In some embodiments, four-qubit joint measurement device 2741 can be a 4-GHZ measurement (or 4-GHZ fusion) circuit such as circuit 2000 of FIG. 20. As described above, circuit 2000 can produce a set of four measurement outcomes. Downstream classical processing logic can select the appropriate measurement result(s) for a given measurement based on the corresponding location in the fusion graph. Circuit 2700 can output classical measurement outcome data on output paths such as output paths 2751-2753. As described above, the outcomes can be used to generate a syndrome graph, and the syndrome graph can be used to determine a result of the logical operation. In some embodiments, circuit 2700 can also perform other combinations of measurements. For example, to support two-qubit fusion measurements, one or more Bell fusion circuits can be provided, and switches 2705-2708 can be configured with additional outputs to allow a pair of qubits to be directed to a Bell fusion circuit. In various embodiments, different combinations of four-qubit, three-qubit, two-qubit, and single-qubit measurement circuits can be provided, with switches 2705-2708 being operable to provide qubits to the desired measurement circuits.

The foregoing examples of fusion networks and reconfigurable fusion circuits are illustrative, and variations and modifications are possible. Other resource states and fusion networks (or lattice entanglement patterns) can be implemented. Reconfigurable fusion circuits can include any number of inputs and any combination of measurement circuits (including single-qubit measurements and multi-qubit joint measurement circuits) appropriate to a particular fusion network.

### 4. Quantum Computer Architecture for Photonic GKP Qubits

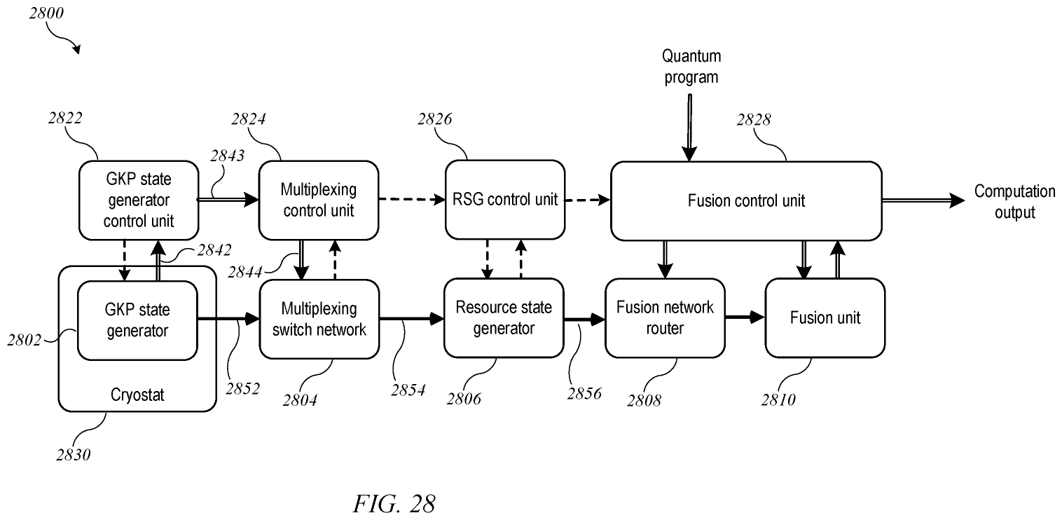

FIG. 28 is a simplified block diagram further illustrating an architecture for a quantum computing system 2800 using photonic GKP qubits according to some embodiments. Quantum computing system 2800 can include quantum hardware such as a GKP state generator 2802, a multiplexing switching network 2804, resource state generator(s) (RSG) 2806, fusion network router 2808, and fusion unit 2810. Quantum computing system 2800 can also include classical control hardware such as GKP state generator control unit 2822, multiplexing control unit 2824, resource state generator (RSG) control unit 2826, and fusion control unit 2828. The architecture can be similar to that described above with reference to FIGS. 13 and 14A-14D. As in FIGS. 14A-14D, solid lines represent quantum information channels and double-solid lines represent classical information channels.

Qubit generation can be implemented in GKP state generator 2802, e.g., using circuits such as circuit 1500 described above. In some embodiments, GKP state generator 2802 includes PNR detectors (e.g., as described above) that may operate at cryogenic temperatures (e.g., millikelvin to a few kelvin). Accordingly, GKP state generator 2802 can be housed within a cryostat 2830 as shown. Other system components that do not require cryogenic temperatures (e.g., intensity detectors, beam splitters, squeezing circuits) can be housed inside or outside cryostat 2830 as desired. In some embodiments, GKP state generator 2802 can produce one or more GKP qubits at regular intervals (e.g., according to a clock cycle). As described above, GKP state generation can be a non-deterministic process; accordingly, GKP state generator 2802 may produce GKP qubits with a probability less than 1. Classical heralding signals 2842 can be provided to indicate whether a particular attempt succeeded.

In some embodiments, GKP state generator 2802 can provide quantum outputs 2852 (e.g., GKP qubits propagating in waveguides) to multiplexing switch network 2804, which can implement any combination of temporal and/or spatial multiplexing. In some embodiments, multiplexing control unit 2824 generates classical control signals 2844 for multiplexing switch network 2804 in response to heralding information 2843 provided by GKP state generator control unit 2822. In this manner, multiplexing switch network 2804 can provide GKP qubits on path 2854 (e.g., waveguides) to resource state generator 2806.

Resource state generator 2806 can incorporate CZ gates (e.g., instances of circuit 1700 described above), 3-GHZ state generators (e.g., circuit 1800), and/or fusion circuits (e.g., any of circuits 1900, 2000, 2100, 2200) to create resource states, which in this example are quantum systems of entangled GKP qubits. The particular entanglement structure of the resource states can be selected based on a desired fusion network structure. In some embodiments, resource state generation is a deterministic or near-deterministic operation; it should be understood that photonic loss (which may be unheralded) can occur. In some embodiments, operation of resource state generator 2806 may be non-deterministic (e.g., depending on how squeezing circuits 1710, 1712 are implemented), and losses may or may not be heralded. In some embodiments, resource state generator can be reconfigurable to provide resources states having different entanglement structures and/or numbers of qubits, and operation of resource state generator 2806 can be controlled by RSG control unit 2826. In embodiments where heralding signals are available from resource state generator 2806, RSG control unit 2826 can receive the heralding signals and adapt operations accordingly. Resource states can be provided on path 2856 (e.g., waveguides) to fusion network router 2808. Fusion network router 2808 can include a set of switches, delay lines, and/or other components that direct qubits of particular resource states to fusion sites within fusion unit 2810 with appropriate timing to implement a particular fusion network. For instance, fusion network router 2808 can include delay lines (which can be lengths of optical fiber or other waveguides) to delay selected qubits from resource states generated during one operating cycle of resource state generator 2806 until a later operating cycle, thereby supporting timelike fusion. For instance, resource states associated with different layers in a fusion graph (e.g., as shown in FIGS. 12A-12C) can be generated during different operating cycles. In some embodiments, routing by fusion network router 2808 can follow a regular lattice structure as described above, or lattice deformations such as twists and dislocations (e.g., as described above with reference to FIGS. 11B-11E) can be introduced by changing the routing of qubits to fusion sites.

Fusion unit 2810 can be similar to fusion array 1421 described above. For example, fusion unit 2810 can include an array of fusion sites, each of which can be implemented using a reconfigurable fusion circuit such as circuit 2400 or circuit 2700 described above. Fusion control unit 2828 (which can be similar or identical to fusion controller 1419 described above) can receive a quantum program (e.g., a sequence of fusion patterns as described above) and control the individual fusion sites in fusion unit 2810 to perform appropriate measurements. In some embodiments, fusion control unit 2828 can also dynamically control switches in fusion network router 2808 according to the quantum program. Measurement outcomes (classical data, which can be obtained from homodyne measurement circuits as described above) can be provided from fusion unit 2810 to fusion control unit 2828. Depending on implementation, fusion control unit 2828 can perform pre-processing on the measurement outcomes, e.g., to generate syndrome values, perform additional processing (e.g., to decode a syndrome graph), and/or provide the measurement outcomes to another classical computer component (e.g., classical computing system 1407 of FIG. 14A), which can perform syndrome value computation, decoding of a syndrome graph, and/or other operations.

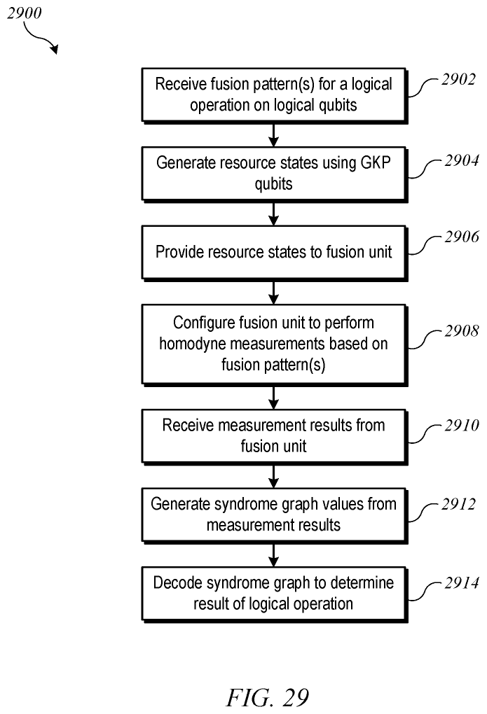

FIG. 29 shows a flow diagram of a process for performing a quantum computation that can be implemented using quantum computing system 2800 according to some embodiments. At block 2902, quantum computing system 2800 can receive one or more fusion patterns for a logical operation on logical qubits. Fusion patterns can be generated, e.g., using techniques described above with reference to FIGS. 11B-11E. The fusion pattern can define a specific measurement operation to be performed for each qubit in each of a plurality of resource states forming a fusion network. As described above, in embodiments where surface codes are used to define the logical qubits and operations, the bulk operations may be projective entangling measurements, which can be joint measurements on two or more physical qubits. For instance, for GKP qubits, the projective entangling measurements can be Bell measurements or n-GHZ measurements using circuits as described above. Boundary qubits can be subject to single-qubit measurements in a specified basis. It should be understood that for GKP qubits, all measurements can be implemented using homodyne measurement circuits, and the measurement outputs can be in the form of analog or digital signals. (For instance, intensity detectors may output analog signals; analog signals can be converted to digital signals at any point during processing.)

At block 2904, quantum computing system 2800 can generate resource states by producing and entangling GKP qubits, e.g., using GKP state generator 2802, multiplexing switch network 2804, and resource state generator 2806. In some embodiments, the entanglement structure of the resource states can depend on the particular fusion network being used to perform the fusion pattern. At block 2906, the resource states can be provided to fusion unit 2808.

At block 2908, quantum computing system 2800 can configure fusion unit 2808 to perform the homodyne measurements specified by the fusion pattern. Depending on the particular fusion pattern, the measurements can include joint measurements on certain sets of two (or more) qubits and single-qubit measurements on other qubits. As described above, fusion controller unit 2828 can set the state of switches and other active components (e.g., phase shifters) in reconfigurable fusion circuits within fusion unit 2808 to perform the measurements specified by the fusion pattern. In some embodiments, operations at blocks 2906 and 2908 can be coordinated (e.g., using clock signals) such that the reconfigurable fusion circuit is in the desired state when particular qubits arrive.

At block 2910, quantum computing system 2800 (e.g., fusion controller unit 2828) can receive measurement results from fusion unit 2808. In some embodiments, each reconfigurable fusion circuit reports its measurements. At block 2912, quantum computing system 2800 (e.g., fusion controller unit 2828) can compute syndrome graph values from the measurement results. In some embodiments, the syndrome graph value can be computed using techniques described in above-referenced International Patent Application Publication WO 2021/155289. At block 2914, the syndrome graph can be decoded to determine a result of the (logical) quantum operation. Examples of decoder processes are known in the art and can be applied. It should be noted that the mathematics of decoding a set of measurement outcomes obtained from physical qubits can be decoupled from the particular physical system used to obtain the measurement outcomes. Thus, for example, decoding techniques developed for dual-rail-encoded photonic qubits are equally applicable to GKP-encoded qubits. Accordingly, a detailed description of such techniques is omitted.

In some embodiments, fusion controller unit 2828 can also receive other information, such as heralding signals or other status signals from other classical controller units. Such information can indicate where qubits may have been lost or were in an invalid state. In some embodiments, such information can be used during decoding. For example, any lost qubits or qubits known to be in an invalid state can be treated as erasures, which can result in omitting corresponding measurements from the syndrome graph. In some embodiments, information related to loss or invalid qubit states can be used to modify subsequent fusion patterns during the computation.

In some embodiments, process 2900 can be executed in an iterative fashion, with successive fusion patterns being received and applied as new resource states are generated over a succession of operating cycles (e.g., clock cycles). As noted above, some qubits associated with resource states generated during one operating cycle can be stored (e.g., using optical fiber) and joint measurements can be performed between qubits generated during different operating cycles. Measurement results can be accumulated across operating cycles, and decoding can take place during iterative operation or at the end of some number of operating cycles. In some embodiments, decoder outputs can be used in determining later-generated fusion patterns as the iterative execution of process 2900 proceeds.

It should be understood that the architecture shown in FIG. 28 and the process shown in FIG. 29 are illustrative and can be modified. In some embodiments, only the GKP state generator requires cryogenic temperatures, and all other components can operate at room temperature. This may allow use of a smaller cryostat, which can reduce construction and operating costs. Architectures and processes of the kind described herein can be used to implement FBQC using GKP qubits with a variety of resource states and fusion networks, including the specific examples described above. In some embodiments, the resource state generators and fusion units can be reconfigurable to implement different resource states and different fusion networks.

Using GKP qubits in an FBQC architecture may have certain benefits as compared to MBQC. For instance, as described above, FBQC generally has advantages over MBQC in reducing the size of entangled states and the length of time a particular entangled state needs to be maintained; such advantages are largely independent of the particular qubit encoding used. In the case of GKP qubits, FBQC can reduce the optical depth (e.g., the number of CZ gates) through which a given qubit passes as compared to MBQC. In some implementations of MBQC, each qubit may pass through four or more CZ gates during its lifetime. In contrast, in embodiments described above, the number of CZ gates through which each qubit passes can be reduced to just one. This reduction can be significant in terms of reducing losses because CZ gates generally include squeezing, and squeezing (regardless of particular implementation) is typically a lossy operation. Other operations on the qubits can be implemented using passive optical components (e.g., beam splitters, phase shifters, homodyne measurement) that have relatively low loss. Photonic GKP qubits may also have advantages in that entangling operations can be deterministic or near-deterministic; apart from leakage or losses, the probability of obtaining the desired state can be close to 1. In FBQC applications, this may allow for a reduced code distance (relative to other physical qubit architectures) for a given degree of fault tolerance.

### 5. Additional Embodiments

The foregoing examples of circuits and processes for quantum computing using GKP qubits are illustrative and can be modified as desired. The use of directional labels (e.g., N, E, W, S, U, D) is for convenience of description and should be understood as referring to entanglement space, not as requiring or implying a particular physical arrangement of components or physical qubits. All numerical examples are for purposes of illustration and can be modified. A fusion network of any size can be constructed. It should be understood that the reconfigurable fusion circuits can perform different operations on different qubits at different times during the course of a quantum computation. For example, where a fusion network has a lattice structure, one direction of the lattice can be associated with a timelike dimension, thereby defining layers. Resource states associated with different layers (or with different portions of the same layer) can be generated in different clock cycles, and appropriate qubits can be delayed (e.g., using appropriate lengths of optical fiber) until qubits of resource states generated during a later clock cycle are available for joint measurement operations. Further, while examples described above assume that all instances of a resource state within a fusion network have the same entanglement pattern, such uniformity is not required. For instance, in some embodiments, a resource state generator can be dynamically reconfigurable to generate resource states having different entanglement patterns in different clock cycles. In addition, resource state generators (or qubit generators) may operate in a non-deterministic manner, and this may introduce stochastic variation among resource states.

The particular size (number of qubits) and entanglement pattern of the resource states can be varied as appropriate for a particular use case. In addition or instead, the size and entanglement geometry of a fusion network can also be varied according to the particular use-case. For instance, while the foregoing description uses examples of fusion networks having three-dimensional entanglement geometry, fusion networks having more or fewer dimensions can be created by providing an appropriate resource state generator and an appropriate set of reconfigurable fusion circuits.

Embodiments described above provide examples of circuits, systems, and methods for generating entangled multi-qubit quantum systems from GKP qubits. As described above, such circuits systems, and methods can be used to construct fusion networks in the context of FBQC. However, embodiments are not limited to FBQC and may be used in a variety of contexts. For example, multi-qubit projective entangling measurements using circuits and methods of the kind described herein can be used to construct quantum systems having an arbitrary number of mutually entangled qubits. Such quantum systems can include cluster states for MBQC, as well as multi-qubit entangled systems for use in other quantum computing systems, quantum communication systems, and any other context where it is desirable to perform measurements on a quantum system involving an entangled ensemble of physical qubits.

Further, embodiments described above include references to specific materials and structures (e.g., optical fibers), but other materials and structures capable of producing, propagating, and operating on photons can be substituted. As noted above, resource states can be generated using photonic circuits, or a resource state can be created using matter-based qubits, after which an appropriate transducer technology can be applied to swap the state of the matter-based qubits onto a photonic state. Further, in some embodiments, FBQC or other operations described herein can be implemented using GKP qubits instantiated in non-photonic systems, such as microwave implementations of GKP qubits based on superconducting devices or other oscillatory physical systems.

It should be understood that the resource states and fusion networks shown herein are illustrative and that variations and modifications are possible. In some embodiments, resource states having different sizes and/or entanglement patterns can be used at different vertex positions within a fusion network, and position-dependent selection of resource state configurations can be used to implement logical operations. Further, while FBQC is an example use-case for the techniques and components described herein, it should be understood that these techniques and components can be applied in other contexts and are not limited to quantum computing.

Classical control logic can be implemented on-chip with the waveguides, beam splitters, detectors and/or and other photonic circuit components or off-chip as desired.

It should be understood that all numerical values used herein are for purposes of illustration and may be varied. In some instances ranges are specified to provide a sense of scale, but numerical values outside a disclosed range are not precluded.

It should also be understood that all diagrams herein are intended as schematic. Unless specifically indicated otherwise, the drawings are not intended to imply any particular physical arrangement of the elements shown therein, or that all elements shown are necessary. Those skilled in the art with access to this disclosure will understand that elements shown in drawings or otherwise described in this disclosure can be modified or omitted and that other elements not shown or described can be added.

This disclosure provides a description of the claimed invention with reference to specific embodiments. Those skilled in the art with access to this disclosure will appreciate that the embodiments are not exhaustive of the scope of the claimed invention, which extends to all variations, modifications, and equivalents.

What is claimed is:

1. A circuit comprising:
a number (n) of input paths to receive a plurality of Gottesman-Kitaev-Preskill (GKP) qubits, wherein n is at least 3;
a plurality of homodyne measurement circuits, each homodyne measurement circuit outputting a respective measurement value;
a network of beam splitters, the network including at least one intermediate beam splitter and one final beam splitter, each beam splitter in the network having two inputs and two outputs,
wherein one output of each of intermediate beam splitter in the network is coupled to a different one of the homodyne measurement circuits and the other output of each intermediate beam splitter in the network is coupled to another beam splitter in the network, wherein each of the two outputs of the final beam splitter is coupled to a different one of the homodyne measurement circuits; and
an output signal path to output the respective homodyne measurement values output by the homodyne measurement circuits.

2. The circuit of claim 1 wherein the homodyne measurement values represent outcomes of one or more entangling projective measurements on the plurality of GKP qubits.

3. The circuit of claim 2 wherein the entangling projective measurements are n-GHZ measurements.

4. The circuit of any one of claims 1 to 3 further comprising:
one or more phase shift circuits, each phase shift circuit coupled to a different one of the input paths.

5. The circuit of claim 4 wherein the one or more phase shift circuits include at least one variable phase shift circuit configured to receive a control signal and apply a particular phase shift responsive to the control signal.

6. The circuit of claim 4 or claim 5 wherein respective phase shifts applied by the one or more phase shift circuits are selected such that the homodyne measurement values represent n-GHZ measurements in different bases.

7. The circuit of any one of claims 1 to 6 wherein each of the GKP qubits is in a respective one of a plurality of quantum systems, each quantum system including two or more entangled qubits, wherein operation of the circuit results in the plurality of quantum systems becoming mutually entangled.

8. The circuit of any one of claims 1 to 7 wherein the number n of input paths is 2^{m} for integer m≥2.

9. The circuit of claim 8 wherein the intermediate beam splitters include a first group of n/2 beam splitters with inputs coupled to the input paths and a second group of n/4 beam splitters with inputs coupled to different beam splitters of the first group.

10. The circuit of claim 8 or claim 9 wherein each beam splitter in the network of beam splitters is a 50/50 beam splitter.

11. The circuit of any one of claims 1 to 7 wherein the number n of input paths is 3.

12. The circuit of claim 11 wherein the network of beam splitters includes one intermediate beam splitter and one final beam splitter, wherein two of the three input paths are coupled to the inputs of the intermediate beam splitter and the third of the three input paths is coupled to one of the inputs of the final beam splitter.

13. The circuit of claim 12 wherein the intermediate beam splitter is a 50/50 beam splitter and the final beam splitter is a ⅓ beam splitter.

14. A circuit comprising:
a first input path to receive a first Gottesman-Kitaev-Preskill (GKP) qubit and a second input path to receive a second GKP qubit;
a beam splitter having a first input coupled to the first input path, a second input coupled to the second input path, a first output, and a second output;
a first homodyne measurement circuit coupled to the first output of the beam splitter, the first homodyne measurement circuit outputting a first measurement value; and
a second homodyne measurement circuit coupled to the second output of the beam splitter, the second homodyne measurement circuit outputting a second measurement value.

15. The circuit of claim 14 wherein the first measurement value and the second measurement value represent outcomes of one or more entangling projective measurements on the first GKP qubit and the second GKP qubit.

16. The circuit of claim 15 wherein the entangling projective measurements are Bell measurements.

17. The circuit of any one of claims 14 to 16 further comprising:
a first phase shift circuit coupled to the first input path; and
a second phase shift circuit coupled to the second input path.

18. The circuit of claim 17 wherein at least one of the first phase shift circuit and the second phase shift circuit is a variable phase shift circuit configured to receive a control signal and apply a particular phase shift responsive to the control signal.

19. The circuit of claim 17 wherein respective phase shifts applied by the first and second phase shift circuits are selected such that the first measurement value and the second measurement value represent a joint XX measurement and a joint ZZ measurement on the first and second GKP qubits.

20. The circuit of any one of claims 14 to 19 wherein the first GKP qubit is in a first quantum system that includes two or more entangled qubits and the second GKP qubit is in a second quantum system that includes wo or more entangled qubits, and wherein operation of the circuit results in the first and second quantum systems becoming mutually entangled.

21. The circuit of any one of claims 14 to 20 wherein the first and second input paths are optical waveguides.

22. A method comprising:
receiving, at a plurality of fusion sites, a first plurality of quantum systems, wherein each quantum system of the first plurality of quantum systems includes a plurality of Gottesman-Kitaev-Preskill (GKP) qubits in an entangled state, and wherein respective quantum systems of the first plurality of quantum systems are independent quantum systems that are not entangled with one another;
selecting, for each of the plurality of fusion sites, a homodyne measurement operation to be performed by a reconfigurable fusion circuit on respective GKP qubits from two or more of the quantum systems of the first plurality of quantum systems, thereby generating measurement outcome data, wherein the homodyne measurement operation for each reconfigurable fusion circuit is selected from a group of homodyne measurement operations that includes:
a first measurement operation in which a single-qubit homodyne measurement is performed on each of the GKP qubits and the measurement outcome data includes a result of each single-qubit homodyne measurement; and
a second measurement operation in which a multi-qubit homodyne projective entangling measurement is performed jointly on the respective GKP qubits and the measurement outcome data includes a result of the multi-qubit homodyne projective entangling measurement; and
operating a reconfigurable fusion circuit for each fusion site to perform the selected homodyne measurement operation and produce measurement outcome data.

23. The method of claim 22 further comprising:
determining, by a decoder, a plurality of syndrome values based on the measurement outcome data.

24. The method of claim 22 or claim 23 wherein the multi-qubit homodyne projective entangling measurement is a fusion operation.

25. The method of claim 24 wherein the multi-qubit homodyne projective entangling measurement is a destructive joint measurement.

26. The method of any one of claims 22 to 25 wherein the second measurement operation is a Bell fusion between two GKP qubits.

27. The method of any one of claims 22 to 25 wherein the second measurement operation is an n-GHZ fusion measurement performed on a number (n) of GKP qubits, where n is greater than or equal to 4.

28. The method of any one of claims 22 to 25 wherein the second measurement operation is a 4-GHZ fusion measurement performed on four GKP qubits.

29. The method of any one of claims 22 to 25 wherein the second measurement operation is an 8-GHZ fusion measurement performed on eight GKP qubits.

30. The method of any one of claims 22 to 29 further comprising:
storing, using an optical fiber, one or more GKP qubits from the first plurality of quantum systems, wherein the stored GKP qubits are GKP qubits other than the GKP qubits that were subject to the homodyne measurement operations;
receiving, at the plurality of fusion sites, a second plurality of quantum systems, wherein each quantum system of the second plurality of quantum system includes a second plurality of GKP qubits in an entangled state, and wherein respective quantum systems of the second plurality of quantum systems are independent quantum systems that are not entangled with one another or with any of the first plurality of quantum systems; and
selecting, for each of the plurality of fusion sites, one of the homodyne measurement operations to be performed by the reconfigurable fusion circuit at that fusion site on a set of GKP qubits that includes at least one of the stored GKP qubits and at least one GKP qubit from at least one of the quantum systems of the second plurality of quantum systems.

31. A system comprising:
a plurality of fusion sites configured to receive a plurality of quantum systems, wherein each quantum system of the plurality of quantum system includes a plurality of Gottesman-Kitaev-Preskill (GKP) qubits in an entangled state, and wherein respective quantum systems of the plurality of quantum systems are independent quantum systems that are not entangled with one another;
wherein each fusion site includes a reconfigurable fusion circuit configured to selectably perform one of a plurality of homodyne measurement operations on respective GKP qubits from two or more of the quantum systems, thereby generating measurement outcome data, wherein the plurality of homodyne measurement operations includes:
a first measurement operation in which a single-qubit homodyne measurement is performed on each of the GKP qubits and the measurement outcome data includes a result of each single-qubit homodyne measurement; and
a second measurement operation in which a multi-qubit homodyne projective entangling measurement is performed jointly on the respective GKP qubits and the measurement outcome data includes a result of the homodyne projective entangling measurement; and
a fusion controller circuit coupled to the plurality of fusion sites and configured to select, for each of the fusion sites, a particular homodyne measurement operation to perform.

32. The system of claim 31 further comprising:
a decoder communicatively coupled to the plurality of fusion sites and configured to receive the measurement outcome data and to determine a plurality of syndrome values based on the measurement outcome data.

33. The system of claim 31 or claim 32 wherein the reconfigurable fusion circuits are photonic circuits.

34. The system of any one of claims 31 to 33 wherein the homodyne projective entangling measurement comprises a two-particle projective measurement onto a Bell basis.

35. The system of any one of claims 31 to 34 further comprising a qubit entangling system that is configured to generate the plurality of quantum systems.

36. The system of claim 35 wherein the qubit entangling system includes a photon source system that produces photonic GKP qubits.

37. The system of claim 36 wherein the qubit entangling system further includes a resource state generator that is configured to receive photonic GKP qubits from the photon source system and convert the photonic GKP qubits to an entangled photonic state.

38. The system of claim 37 wherein the qubit entangling system includes a plurality of output waveguides that are optically coupled to the plurality of fusion sites and are configured to provide the entangled photonic state to inputs of the reconfigurable fusion circuit.

39. The system according to any one of claims 31 to 38 wherein the second measurement operation is a Bell fusion between two GKP qubits.

40. The system according to any one of claims 31 to 38 wherein the second measurement operation is an n-GHZ fusion measurement performed on a number (n) of GKP qubits, where n is greater than or equal to 4.

41. The system according to any one of claims 31 to 38 wherein the second measurement operation is a 4-GHZ fusion measurement performed on four GKP qubits.

42. The system according to any one of claims 31 to 38 wherein the second measurement operation is an 8-GHZ fusion measurement performed on eight GKP qubits.

43. The system according to any one of claims 31 to 38 wherein the second measurement operation comprises a multi-qubit homodyne measurement.

44. The system according to any one of claims 31 to 38 wherein the second measurement operation is a multi-qubit fusion measurement that projects onto a GHZ state.
